(19) United States
(12) Patent Application Publication
(10) Pub. No.: US 2026/0279919 A1
(43) Pub. Date: Sep. 17, 2026

(54) SECONDARY BATTERY AND BATTERY PACK

(71) Applicant: MURATA MANUFACTURING CO., LTD., Kyoto (JP)

(72) Inventors: Akira SHINKAWA, Kyoto (JP); Takuya NAKASHIMA, Kyoto (JP); Tomohiro UCHIYA, Kyoto (JP); Miyuki YOSHIHARA, Kyoto (JP); Tomoya SASAKI, Kyoto (JP); Yuichiro HASHIZUME, Kyoto (JP); Kuniaki HAMAGUCHI, Kyoto (JP); Yohei SHIMADA, Kyoto (JP); Yoshimasa YAMAMOTO, Kyoto (JP); Futoshi SATO, Kyoto (JP); Keitaro KITADA, Kyoto (JP); Yuta HANEDA, Kyoto (JP); Mao ICHISHIMA, Kyoto (JP); Hirotaka FUKUDOME, Kyoto (JP); Yukihiro OKAMOTO, Kyoto (JP); Hiromitsu HANGAI, Kyoto (JP); Rie TAKEMIYA, Kyoto (JP); Toshihiro HIRATSUKA, Kyoto (JP); Atsushi NAKAYABU, Kyoto (JP); Ryoji YAMATO, Kyoto (JP); Toshikazu NAKAMURA, Kyoto (JP); Yuichiro SUGAUCHI, Kyoto (JP); Kenta TAKANO, Kyoto (JP)

(21) Appl. No.: 19/666,584

(22) Filed: May 4, 2026

Related U.S. Application Data
(63) Continuation of application No. PCT/JP2024/040852, filed on Nov. 18, 2024.
(60) Provisional application No. 63/601,982, filed on Nov. 22, 2023.

(51) Int. Cl. H01M 10/0587; H01M 4/36; H01M 4/70; H01M 10/0525; H01M 50/533

(52) U.S. Cl. CPC H01M 10/0587; H01M 4/366; H01M 4/70; H01M 10/0525; H01M 50/533

(57) ABSTRACT

A secondary battery includes an electrode wound body, a first electrode current collector plate, and a second electrode current collector plate. The electrode wound body includes a stacked body and has a through hole. The stacked body includes a first electrode, a second electrode, and a separator and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed therebetween in the width direction. The first electrode current collector plate has an opening positioned to overlap the through hole in the width direction. A diameter of the opening is smaller than a diameter of the through hole.

### CROSS REFERENCE TO RELATED APPLICATIONS

The present application is a continuation of International Application No. PCT/JP2024/040852, filed on Nov. 18, 2024, which claims priority to U.S. Provisional Patent Application No. 63/601,982, filed on Nov. 22, 2023, the entire contents of which are incorporated herein by reference.

### BACKGROUND

The present disclosure relates to a secondary battery, and to a battery pack including the secondary battery.

Various kinds of electronic equipment, including mobile phones, have been widely used. Such widespread use has promoted development of a secondary battery as a power source that is smaller in size and lighter in weight and allows for a higher energy density. The secondary battery includes a battery device contained inside an outer package member. A configuration of the secondary battery has been considered in various ways.

A secondary battery is proposed in which what is called a tabless structure is employed to reduce an internal resistance and to allow for charging and discharging with a relatively large current.

### SUMMARY

The present disclosure relates to a secondary battery, and to a battery pack including the secondary battery.

Consideration has been given in various ways to improve performance of a secondary battery. However, there is still room for improvement in reliability of the secondary battery.

Under the circumstances, a secondary battery that is superior in reliability is desired.

A secondary battery according to an embodiment of the present disclosure includes an electrode wound body, a first electrode current collector plate, and a second electrode current collector plate. The electrode wound body includes a stacked body and has a through hole. The stacked body includes a first electrode, a second electrode, and a separator, and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed between the first electrode current collector plate and the second electrode current collector plate in the width direction. The first electrode current collector plate has an opening positioned to overlap the through hole in the width direction. A diameter of the opening is smaller than a diameter of the through hole.

A secondary battery according to an embodiment of the present disclosure includes an electrode wound body, a first electrode current collector plate, and a second electrode current collector plate. The electrode wound body includes a stacked body and has a through hole. The stacked body includes a first electrode, a second electrode, and a separator, and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed between the first electrode current collector plate and the second electrode current collector plate in the width direction. A second bent part is provided at an outer peripheral edge part of the first electrode current collector plate. The second bent part is bent toward the second electrode current collector plate.

A secondary battery according to an embodiment of the present disclosure includes an electrode wound body, a first electrode current collector plate, and a second electrode current collector plate. The electrode wound body includes a stacked body and has a through hole. The stacked body includes a first electrode, a second electrode, and a separator, and is wound along a longitudinal direction of the stacked body. The through hole extends through the electrode wound body in a width direction orthogonal to the longitudinal direction. The first electrode current collector plate and the second electrode current collector plate are opposed to each other with the electrode wound body interposed between the first electrode current collector plate and the second electrode current collector plate in the width direction. The first electrode includes a first electrode current collector, an undercoat layer, and a first electrode active material layer. The undercoat layer covers the first electrode current collector. The first electrode active material layer covers a part of the undercoat layer. The second electrode includes a second electrode current collector and a second electrode active material layer. The second electrode active material layer covers the second electrode current collector. In the width direction, an edge of the first electrode active material layer is at a position retracted relative to a position of an edge of the undercoat layer, and an edge of the second electrode active material layer is at a position between the position of the edge of the undercoat layer and the position of the edge of the first electrode active material layer.

The secondary battery according to an embodiment of the present disclosure makes it possible to achieve high reliability.

### BRIEF DESCRIPTION OF THE FIGURES

FIG. 1 is a sectional diagram illustrating a configuration example of a vertical sectional structure of a secondary battery according to an embodiment of the present disclosure along a height direction.

FIG. 2 is a schematic diagram illustrating a configuration example of a stacked body including a positive electrode, a negative electrode, and a separator illustrated in FIG. 1.

FIG. 3 is a sectional diagram illustrating a configuration example of a horizontal sectional structure of an electrode wound body illustrated in FIG. 1.

FIG. 4A is a developed view of the positive electrode illustrated in FIG. 1.

FIG. 4B is a sectional view of the positive electrode illustrated in FIG. 1.

FIG. 5A is a developed view of the negative electrode illustrated in FIG. 1.

FIG. 5B is a sectional view of the negative electrode illustrated in FIG. 1.

FIG. 6A is a plan view of a positive electrode current collector plate illustrated in FIG. 1.

FIG. 6B is a plan view of a negative electrode current collector plate illustrated in FIG. 1.

FIG. 7 is a perspective diagram describing a process of manufacturing the secondary battery illustrated in FIG. 1.

FIG. 8 is a block diagram illustrating a circuit configuration of a battery pack to which the secondary battery according to an embodiment of the present disclosure is applied.

FIG. 9A is a schematic sectional diagram illustrating a configuration of a part of a positive electrode of Example 1-2.

FIG. 9B is a schematic sectional diagram illustrating a configuration of a part of a positive electrode of Example 1-3.

FIG. 9C is a schematic sectional diagram illustrating, in an enlarged manner, positive electrode active material particles of Example 1-4.

FIG. 10A is a schematic sectional diagram illustrating a configuration of a part of a positive electrode of Example 2-1-1.

FIG. 10B is a schematic sectional diagram illustrating a configuration of a part of a positive electrode of Example 2-1-2.

FIG. 10C is a schematic sectional diagram illustrating a configuration of a part of a positive electrode of Example 2-1-3.

FIG. 10D is a schematic sectional diagram illustrating a configuration of a part of a positive electrode of Example 2-1-4.

FIG. 11A is a schematic sectional diagram illustrating a configuration of a part of a positive electrode of Example 2-2-1.

FIG. 11B is a schematic sectional diagram illustrating a configuration of a part of a positive electrode of Example 2-2-2.

FIG. 12A is a schematic sectional diagram illustrating a configuration of a part of a positive electrode of Example 2-3-1.

FIG. 12B is a schematic sectional diagram illustrating a configuration of a part of a positive electrode of Example 2-3-2.

FIG. 13 is a schematic sectional diagram illustrating a configuration of a part of a positive electrode active material layer of Example 2-4.

FIG. 14 is a schematic sectional diagram illustrating a configuration of a positive electrode current collector of Example 2-6.

FIG. 15 is an enlarged sectional diagram illustrating a configuration of a part of a positive electrode of Example 3-1.

FIG. 16A is an enlarged sectional diagram illustrating a configuration of a part of a positive electrode of Example 4-1.

FIG. 16B is an enlarged sectional diagram illustrating a configuration of a part of a positive electrode of Example 4-2.

FIG. 16C is an enlarged sectional diagram illustrating a configuration of a part of a positive electrode of Example 4-3.

FIG. 17 is an enlarged sectional diagram illustrating a configuration of a part of a positive electrode of Example 4-4-1.

FIG. 18A is an enlarged sectional diagram illustrating a configuration of a part of a positive electrode of Example 4-4-2A.

FIG. 18B is an enlarged sectional diagram illustrating a configuration of a part of a positive electrode of Example 4-4-2B.

FIG. 19A is an enlarged sectional diagram illustrating a configuration of a part of a positive electrode of Example 4-4-3A.

FIG. 19B is an enlarged sectional diagram illustrating a configuration of a part of a positive electrode of Example 4-4-3B.

FIG. 20 is an enlarged sectional diagram illustrating a configuration of a part of a positive electrode of Example 4-5.

FIG. 21A is an enlarged sectional diagram illustrating a configuration of a part of a positive electrode of Example 4-6A.

FIG. 21B is an enlarged sectional diagram illustrating a configuration of a part of a positive electrode of Example 4-6B.

FIG. 21C is an enlarged sectional diagram illustrating a configuration of a part of a positive electrode of Example 4-6C.

FIG. 22A is a schematic plan diagram illustrating a configuration of a part of a positive electrode of Example 4-7A.

FIG. 22B is a schematic plan diagram illustrating a configuration of a part of a positive electrode of Example 4-7B.

FIG. 23A is a schematic sectional diagram illustrating a configuration of a part of an electrode wound body of Example 4-8A.

FIG. 23B is a schematic sectional diagram illustrating a configuration of a part of an electrode wound body of Example 4-8B.

FIG. 23C is a schematic sectional diagram illustrating a configuration of a part of an electrode wound body of Example 4-8C.

FIG. 24 is an enlarged sectional diagram illustrating a configuration of a part of a positive electrode of Example 4-9.

FIG. 25 is an enlarged sectional diagram illustrating a configuration of a part of a positive electrode of Example 4-10.

FIG. 26 is an enlarged sectional diagram illustrating a configuration of a part of a positive electrode of Example 4-11.

FIG. 27 is an enlarged sectional diagram illustrating a configuration of a part of a positive electrode of Example 4-13.

FIG. 28A is an enlarged sectional diagram illustrating a configuration of a part of a positive electrode of Example 4-14.

FIG. 28B is a characteristic diagram illustrating a relation between the presence or absence of a carbon coat layer and an interface resistance between the positive electrode current collector and the positive electrode active material layer.

FIG. 29A is an enlarged sectional diagram illustrating a configuration of a part of an electrode wound body of Example 4-15-1.

FIG. 29B is an enlarged sectional diagram illustrating a configuration of a part of an electrode wound body of Example 4-15-2.

FIG. 29C is an enlarged sectional diagram illustrating a configuration of a part of an electrode wound body of Example 4-15-3.

FIG. 30 is an enlarged sectional diagram and a schematic plan diagram illustrating a configuration of a positive electrode of Example 4-16.

FIG. 31 is a schematic diagram illustrating positive electrode active material particles and polyvinylidene difluoride included in a positive electrode active material layer of Example 5-1.

FIG. 32 is a schematic diagram illustrating a positive electrode of Example 5-2, and illustrating positive electrode active material particles and polyvinylidene difluoride included in a positive electrode active material layer of Example 5-2.

FIG. 33 is a schematic sectional diagram illustrating a positive electrode of Example 5-3.

FIG. 34 is a schematic sectional diagram illustrating a positive electrode of Example 5-4.

FIG. 35 is a schematic sectional diagram illustrating an electrode wound body of Example 5-5.

FIG. 36 is a schematic sectional diagram illustrating an electrode wound body of Example 5-6.

FIG. 37A is a schematic sectional diagram illustrating a positive electrode of Example 5-7-1.

FIG. 37B is a schematic sectional diagram illustrating a positive electrode of Example 5-7-2.

FIG. 38A is a schematic sectional diagram illustrating an electrode wound body of Example 5-8.

FIG. 38B is a plan view of a positive electrode of the electrode wound body of Example 5-8 in an unwound state.

FIG. 39 is a schematic sectional diagram illustrating an electrode wound body of Example 5-9.

FIG. 40A is a schematic diagram illustrating negative electrode active material particles and porous CMC included in a negative electrode active material layer of Example 6-1.

FIG. 40B is a photomicrograph providing an enlarged view of a negative electrode active material particle and porous CMC included in a negative electrode active material layer of Example 6-2.

FIG. 40C is a schematic sectional diagram illustrating a negative electrode of Example 6-3.

FIG. 41 is a schematic sectional diagram illustrating an electrode wound body of Example 7-1.

FIG. 42 is a schematic sectional diagram illustrating an electrode wound body of Example 7-4.

FIG. 43A is an enlarged sectional view of an upper end part, in a height direction, of an electrode wound body of Example 7-6.

FIG. 43B is an enlarged sectional view of a lower end part, in the height direction, of the electrode wound body of Example 7-6.

FIG. 44 is a schematic sectional diagram illustrating a part, of a secondary battery of Example 8-2, positioned in a region including an upper end face of an electrode wound body and a vicinity of the upper end face.

FIG. 45A is a schematic sectional diagram illustrating a part, of a secondary battery of Example 8-3-1, positioned in a region including an upper end face of an electrode wound body and the vicinity of the upper end face.

FIG. 45B is a schematic sectional diagram illustrating a part, of a secondary battery of Example 8-3-2, positioned in a region including an upper end face of an electrode wound body and the vicinity of the upper end face.

FIG. 45C is a schematic sectional diagram illustrating a part, of a secondary battery of Example 8-3-3, positioned in a region including an upper end face of an electrode wound body and the vicinity of the upper end face.

FIG. 45D is a schematic sectional diagram illustrating a part, of a secondary battery of Example 8-3-4, positioned in a region including an upper end face of an electrode wound body and the vicinity of the upper end face.

FIG. 46A is a schematic sectional diagram illustrating a part, of a secondary battery of Example 8-4-1, positioned in a region including an upper end face of an electrode wound body and the vicinity of the upper end face.

FIG. 46B is a schematic sectional diagram illustrating a part, of a secondary battery of Example 8-4-2, positioned in a region including an upper end face of an electrode wound body and the vicinity of the upper end face.

FIG. 46C is a schematic sectional diagram illustrating a part, of a secondary battery of Example 8-4-3, positioned in a region including an upper end face of an electrode wound body and the vicinity of the upper end face.

FIG. 47A is a schematic sectional diagram illustrating a part, of a secondary battery of Example 8-5-1, positioned in a region including an upper end face of an electrode wound body and the vicinity of the upper end face.

FIG. 47B is a schematic sectional diagram illustrating a part, of a secondary battery of Example 8-5-2, positioned in a region including an upper end face of an electrode wound body and the vicinity of the upper end face.

FIG. 48 is a schematic plan diagram illustrating an electrode wound body and a positive electrode current collector plate in a secondary battery of Example 8-6.

FIG. 49A is a schematic plan diagram illustrating an unwound state of an electrode wound body of Example 10-3-1.

FIG. 49B is a schematic plan diagram illustrating the unwound state of an electrode wound body of Example 10-3-2.

FIG. 50A is a schematic plan diagram illustrating the unwound state of an electrode wound body of Example 10-4-1.

FIG. 50B is a schematic plan diagram illustrating the unwound state of an electrode wound body of Example 10-4-2.

FIG. 51 is a perspective diagram illustrating an outer appearance of an electrode wound body of Example 10-5.

FIG. 52 is a schematic sectional diagram illustrating an electrode wound body and a center pin of Example 10-6.

FIG. 53 is a schematic sectional diagram illustrating a center pin of Example 10-7.

FIG. 54A is a perspective diagram schematically illustrating an outer appearance of an outer package can of Example 13-2.

FIG. 54B is a perspective diagram schematically illustrating an outer appearance of an outer package can of Example 13-3.

FIG. 54C is a perspective diagram schematically illustrating an outer appearance of an outer package can of Example 13-4.

### DETAILED DESCRIPTION

The present disclosure will be described in further detail below including with reference to the drawings according to an embodiment.

A description will be given of a secondary battery according to an embodiment of the present disclosure.

In the present embodiment, a cylindrical lithium-ion secondary battery having an outer appearance of a cylindrical shape will be described as an example. However, a secondary battery of the present disclosure is not limited to the cylindrical lithium-ion secondary battery, and may be a lithium-ion secondary battery having an outer appearance of a shape other than the cylindrical shape, or may be a secondary battery in which an electrode reactant other than lithium is used.

Although a charge and discharge principle of the secondary battery is not particularly limited, the following description deals with a case where a battery capacity is obtained through insertion and extraction of the electrode reactant. The secondary battery includes a positive electrode, a negative electrode, and an electrolyte. In the secondary battery, to prevent precipitation of the electrode reactant on a surface of the negative electrode during charging, a charge capacity of the negative electrode is greater than a discharge capacity of the positive electrode. In other words, an electrochemical capacity per unit area of the negative electrode is set to be greater than an electrochemical capacity per unit area of the positive electrode.

Although not particularly limited in kind as described above, the electrode reactant is specifically a light metal such as an alkali metal or an alkaline earth metal. Examples of the alkali metal include lithium, sodium, and potassium. Examples of the alkaline earth metal include beryllium, magnesium, and calcium.

In the following, described as an example is a case where the electrode reactant is lithium. A secondary battery in which the battery capacity is obtained through insertion and extraction of lithium is what is called a lithium-ion secondary battery. In the lithium-ion secondary battery, lithium is inserted and extracted in an ionic state.

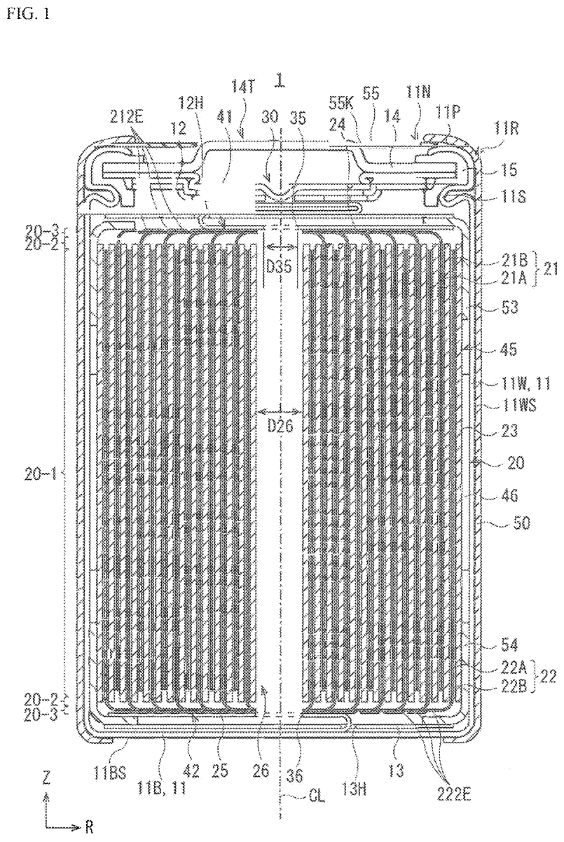

FIG. 1 illustrates a vertical sectional configuration of a lithium-ion secondary battery 1 (hereinafter simply referred to as a secondary battery 1) according to the present embodiment along a height direction. The secondary battery 1 illustrated in FIG. 1 includes an outer package can 11 having a substantially cylindrical shape, and an electrode wound body 20 as a battery device contained in the outer package can 11. The secondary battery 1 further includes an outer package tube 50 covering an outer peripheral surface of the outer package can 11. In the present specification, the height direction of the secondary battery 1 corresponds to a Z-axis direction.

As illustrated in FIG. 1, the secondary battery 1 includes, inside the outer package can 11, for example, a pair of insulating plates 12 and 13, the electrode wound body 20, a positive electrode current collector plate 24 as a first electrode current collector plate, and a negative electrode current collector plate 25 as a second electrode current collector plate. The electrode wound body 20 is a structure in which, for example, a positive electrode 21 and a negative electrode 22 are stacked with a separator 23 interposed therebetween and are wound. The electrode wound body 20 is impregnated with an electrolytic solution, which is a liquid electrolyte. The secondary battery 1 may further include a thermosensitive resistive device, a reinforcing member, or both inside the outer package can 11. The thermosensitive resistive device is also referred to as a PTC device.

The outer package can 11 is a container to contain components including, without limitation, the positive electrode current collector plate 24, the negative electrode current collector plate 25, and the electrode wound body 20. The outer package can 11 includes a bottom part 11B and a sidewall part 11W. The bottom part 11B also serves as a negative electrode terminal coupled to the negative electrode 22 via the negative electrode current collector plate 25. The outer package can 11 has, for example, a hollow cylindrical structure with a lower end part and an upper end part in the Z-axis direction. The lower end part is closed, and the upper end part is open. Accordingly, the upper end part of the outer package can 11 is an open end part 11N, and the lower end part of the outer package can 11 is closed by the bottom part 11B having a substantially circular plate shaped. The sidewall part 11W is provided between the open end part 11N and the bottom part 11B and surrounds the electrode wound body 20. The sidewall part 11W so stands in the height direction and along an outer edge of the bottom part 11B as to surround the electrode wound body 20. The sidewall part 11W includes the open end part 11N on an opposite side to the bottom part 11B. The open end part 11N is open to allow the electrode wound body 20 to be passed therethrough. The outer package can 11 includes, for example, a metal material such as iron as a constituent material. A surface of the outer package can 11 may be plated with, for example, a metal material such as nickel. The insulating plate 12 and the insulating plate 13 are so opposed to each other as to allow the electrode wound body 20 to be interposed therebetween in the Z-axis direction, for example. In the present specification, the open end part 11N and the vicinity thereof in the Z-axis direction may be referred to as an upper part of the secondary battery 1, and a region where the outer package can 11 is closed and the vicinity thereof in the Z-axis direction may be referred to as a lower part of the secondary battery 1.

The outer package tube 50 surrounds a side surface 11WS that is an outer surface of the sidewall part 11W of the outer package can 11. As illustrated in FIG. 1, the outer package tube 50 may cover a bent part 11P (described later) positioned at the upper end part of the outer package can 11. Further, the outer package tube 50 may cover a part of a bottom surface 11BS that is an outer surface of the bottom part 11B of the outer package can 11. The outer package tube 50 may include, for example, a thermally contractible insulating film that includes a material such as a polyester-based resin, a polyamide-based resin, or a thermoplastic elastomer resin.

A washer 55 is provided in a gap between the outer package tube 50 and the bent part 11P of the outer package can 11. The washer 55 is an insulating ring member that has an opening 55K in a middle region in a plane orthogonal to the height direction. Disposed in the opening 55K is a protruding part 14T provided in a middle region of a battery cover 14. The washer 55 may include, for example, black modified polyphenylene ether as a constituent material.

Each of the insulating plates 12 and 13 is, for example, a dish-shaped plate having a surface perpendicular to a central axis CL of the electrode wound body 20, that is, a surface perpendicular to a Z-axis in FIG. 1. The insulating plates 12 and 13 are so disposed as to allow the electrode wound body 20 to be interposed therebetween.

For example, a structure in which the battery cover 14 and a safety valve mechanism 30 are crimped with a gasket 15 interposed therebetween, that is, a crimped structure 11R, is provided at the open end part 11N of the outer package can 11. The outer package can 11 is sealed by the battery cover 14, with the electrode wound body 20 and other components being contained inside the outer package can 11. The crimped structure 11R includes the bent part 11P serving as what is called a crimped part. Further, a narrow part 11S is provided between the bent part 11P and the insulating plate 12. The narrow part 11S is a part, of the outer package can 11, that protrudes inward.

The battery cover 14 is a closing member that mainly closes the open end part 11N in a state where the electrode wound body 20 and other components are contained inside the outer package can 11. The battery cover 14 is, for example, an electrical conductor that includes a material similar to the material included in the outer package can 11. The battery cover 14 closes the open end part 11N of the outer package can 11 and is coupled to the positive electrode current collector plate 24. The battery cover 14 thus also serves as a positive electrode terminal coupled to the positive electrode 21 via the positive electrode current collector plate 24. The protruding part 14T provided in the middle region of the battery cover 14 protrudes upward (a +Z direction), for example. As a result, a peripheral region, i.e., a region other than the middle region, of the battery cover 14 is in contact with the safety valve mechanism 30, for example.

The gasket 15 is a sealing member interposed mainly between the bent part 11P of the outer package can 11 and the battery cover 14. The gasket 15 seals a gap between the bent part 11P and the battery cover 14. A surface of the gasket 15 may be coated with a material such as asphalt. The gasket 15 includes any one or more of insulating materials, for example. The insulating material is not particularly limited in kind, and examples thereof include a polymer material such as polybutylene terephthalate (PBT) or polypropylene (PP). In particular, the insulating material is preferably polybutylene terephthalate. One reason for this is that this allows for sufficient sealing of the gap between the bent part 11P and the battery cover 14, with the outer package can 11 and the battery cover 14 being electrically separated from each other.

The safety valve mechanism 30 cancels the sealed state of the outer package can 11 to thereby release a pressure inside the outer package can 11, i.e., an internal pressure of the outer package can 11, on an as-needed basis, mainly upon an increase in the internal pressure. Examples of a cause of the increase in the internal pressure of the outer package can 11 include a gas generated due to a decomposition reaction of the electrolytic solution upon charging and discharging. The internal pressure of the outer package can 11 can also increase due to heating from outside.

The electrode wound body 20 is disposed between the positive electrode current collector plate 24 and the negative electrode current collector plate 25. The electrode wound body 20 has an upper end face 41 facing the positive electrode current collector plate 24 in the height direction, and a lower end face 42 facing the negative electrode current collector plate 25 in the height direction. The electrode wound body 20 is a power generation device that causes charging and discharging reactions to proceed, and is contained inside the outer package can 11. The electrode wound body 20 includes the positive electrode 21, the negative electrode 22, the separator 23, and the electrolytic solution, i.e., a liquid electrolyte.

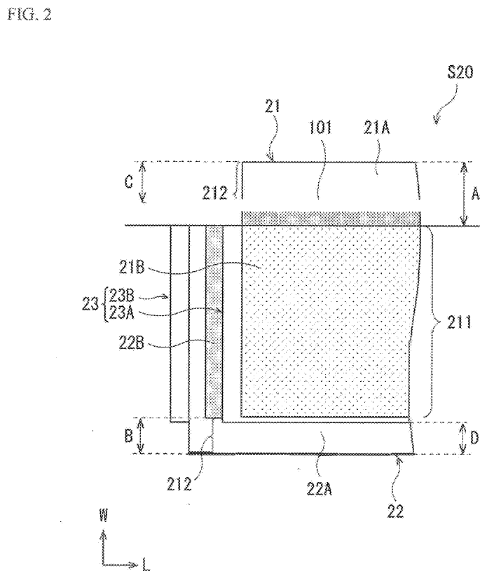

FIG. 2 is a developed view of the electrode wound body 20, and schematically illustrates a part of a stacked body S20 including the positive electrode 21 as a first electrode, the negative electrode 22 as a second electrode, and the separator 23. In the stacked body S20 corresponding to the electrode wound body 20 in an unwound state, the positive electrode 21 and the negative electrode 22 are stacked on each other with the separator 23 interposed therebetween. The separator 23 includes, for example, two bases, that is, a first separator member 23A and a second separator member 23B. The electrode wound body 20 thus includes the four-layered stacked body S20 in which the positive electrode 21, the first separator member 23A, the negative electrode 22, and the second separator member 23B are stacked in order. Each of the positive electrode 21, the first separator member 23A, the negative electrode 22, and the second separator member 23B is a substantially band-shaped member in which a W direction corresponds to a transverse direction and an L direction corresponds to a longitudinal direction.

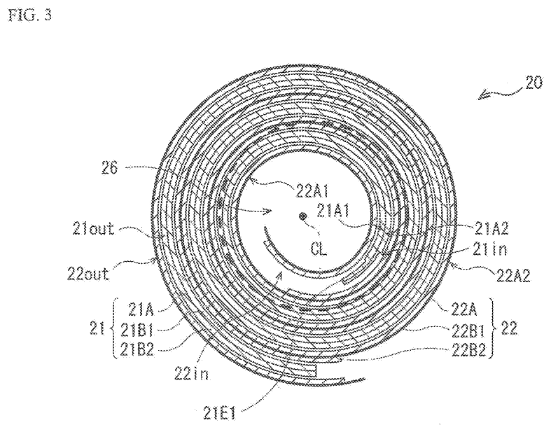

As illustrated in FIG. 3, the electrode wound body 20 corresponds to the stacked body S20 that is so wound around a through hole 26 as to form a spiral shape in a horizontal section orthogonal to the Z-axis direction. The through hole 26 extends along the central axis CL extending in the Z-axis direction. The stacked body S20 is wound in an orientation in which the W direction substantially coincides with the Z-axis direction. Note that FIG. 3 illustrates a configuration example of the electrode wound body 20 along the horizontal section orthogonal to the Z-axis direction. Note that, for higher visibility, FIG. 3 omits illustration of the separator 23. The electrode wound body 20 has an outer appearance of a substantially circular columnar shape as a whole. The positive electrode 21 and the negative electrode 22 are wound, remaining in a state of being opposed to each other with the separator 23 interposed therebetween. The electrode wound body 20 has the through hole 26 as an internal space at a center thereof. The through hole 26 is a hole into which a winding core for assembling the electrode wound body 20 and an electrode rod for welding are each to be put. The through hole 26 extends in the Z-axis direction along the central axis CL, and is provided through the electrode wound body 20. The stacked body S20 is thus wound around the through hole 26.

The positive electrode 21, the negative electrode 22, and the separator 23 are so wound that the separator 23 is positioned in each of an outermost wind of the electrode wound body 20 and an innermost wind of the electrode wound body 20. Further, in the outermost wind of the electrode wound body 20, the negative electrode 22 is positioned on an outer side relative to the positive electrode 21. In other words, as illustrated in FIG. 3, an outermost positive electrode wind part 21out that is positioned in an outermost wind of the positive electrode 21 included in the electrode wound body 20 is positioned on an inner side relative to an outermost negative electrode wind part 22out that is positioned in an outermost wind of the negative electrode 22 included in the electrode wound body 20. Here, the outermost positive electrode wind part 21out is a part corresponding to the outermost one wind of the positive electrode 21 in the electrode wound body 20. The outermost negative electrode wind part 22out is a part corresponding to the outermost one wind of the negative electrode 22 in the electrode wound body 20. In contrast, in the innermost wind of the electrode wound body 20, the negative electrode 22 is positioned on the inner side relative to the positive electrode 21. In other words, as illustrated in FIG. 3, an innermost negative electrode wind part 22 in that is positioned in an innermost wind of the negative electrode 22 included in the electrode wound body 20 is positioned on the inner side relative to an innermost positive electrode wind part 21 in that is positioned in an innermost wind of the positive electrode 21 included in the electrode wound body 20. Here, the innermost positive electrode wind part 21 in is a part corresponding to the innermost one wind of the positive electrode 21 in the electrode wound body 20. The innermost negative electrode wind part 22 in is a part corresponding to the innermost one wind of the negative electrode 22 in the electrode wound body 20. The number of winds of each of the positive electrode 21, the negative electrode 22, and the separator 23 is not particularly limited, and may be chosen as desired.

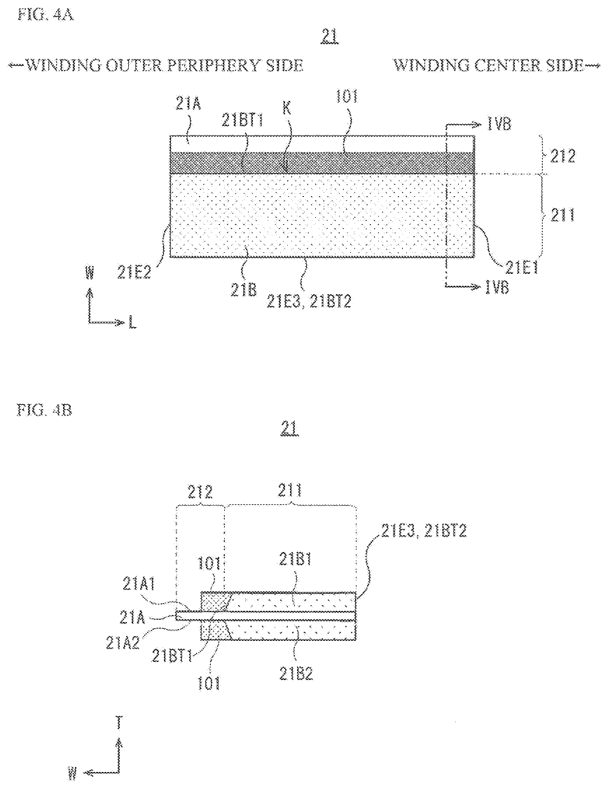

FIG. 4A is a developed view of the positive electrode 21, and schematically illustrates a state before being wound. FIG. 4B illustrates a sectional configuration of the positive electrode 21. Note that FIG. 4B illustrates a section of the positive electrode 21 as viewed in an arrowed direction along line IVB-IVB illustrated in FIG. 4A. The positive electrode 21 includes a positive electrode current collector 21A, a positive electrode active material layer 21B, and an insulating layer 101. The positive electrode active material layer 21B may be provided only on one of two opposite surfaces of the positive electrode current collector 21A, or may be provided on each of the two opposite surfaces of the positive electrode current collector 21A, for example. FIG. 4B illustrates a case where the positive electrode active material layer 21B is provided on each of the two opposite surfaces of the positive electrode current collector 21A. More specifically, the positive electrode current collector 21A includes an inward positive electrode current collector surface 21A1 facing toward the central axis CL, and an outward positive electrode current collector surface 21A2 positioned on an opposite side to the inward positive electrode current collector surface 21A1. The positive electrode 21 includes, as the positive electrode active material layers 21B, an inner winding side positive electrode active material layer 21B1 covering all or a part of the inward positive electrode current collector surface 21A1, and an outer winding side positive electrode active material layer 21B2 covering all or a part of the outward positive electrode current collector surface 21A2. In the present specification, the inner winding side positive electrode active material layer 21B1 and the outer winding side positive electrode active material layer 21B2 may each be generically referred to as the positive electrode active material layer 21B, without being distinguished from each other. The positive electrode active material layer 21B extends in both the L direction and the W direction orthogonal to the L direction. The L direction corresponds to a winding direction of the stacked body S20. The W direction substantially coincides with the central axis CL.

The positive electrode current collector 21A includes a positive electrode covered region 211 covered with the positive electrode active material layer 21B, and a positive electrode exposed region 212 extending in the W direction without being covered with the positive electrode active material layer 21B. The insulating layer 101 extends in the L direction and along a first edge 21BT1 of the positive electrode active material layer 21B. The first edge 21BT1 is positioned at a border K between the positive electrode covered region 211 and the positive electrode exposed region 212. Note that in the positive electrode 21 of the present embodiment, as illustrated in FIG. 4B, the first edge 21BT1 of the positive electrode active material layer 21B constitutes an inclined surface, and the insulating layer 101 is in contact with the first edge 21BT1. That is, the insulating layer 101 is so provided as to cover the first edge 21BT1 of the positive electrode active material layer 21B and the vicinity of the first edge 21BT1.

As illustrated in FIG. 4A, the positive electrode covered region 211 and the positive electrode exposed region 212 each extend along the L direction from a winding center side edge 21E1 of the positive electrode 21 to a winding outer periphery side edge 21E2 of the positive electrode 21. In other words, in the positive electrode 21, the positive electrode current collector 21A is covered with the positive electrode active material layer 21B from the winding center side edge 21E1 of the positive electrode 21 to the winding outer periphery side edge 21E2 of the positive electrode 21 in the winding direction of the electrode wound body 20. The positive electrode covered region 211 and the positive electrode exposed region 212 are adjacent to each other in the W direction, i.e., the transverse direction of the positive electrode 21. FIGS. 4A and 4B each schematically illustrate the positive electrode current collector 21A in a state of being straightened along the W direction. As illustrated in FIG. 1, however, a positive electrode edge part 212E of the positive electrode exposed region 212 is bent toward the central axis CL and coupled to the positive electrode current collector plate 24. In other words, an end part of the positive electrode exposed region 212 in the W direction forms the upper end face 41 and is coupled to the positive electrode current collector plate 24 (see FIG. 1). The upper end face 41 is formed by the positive electrode edge part 212E of the positive electrode exposed region 212 being bent toward the through hole 26 in a wound state.

The insulating layer 101 is preferably provided in a region including the border between the positive electrode covered region 211 and the positive electrode exposed region 212 and the vicinity of the border. As with the positive electrode covered region 211 and the positive electrode exposed region 212, the insulating layer 101 also preferably extends from the winding center side edge 21E1 to the winding outer periphery side edge 21E2 in the electrode wound body 20. Further, the insulating layer 101 is preferably adhered to the first separator member 23A, the second separator member 23B, or both. One reason for this is that this makes it possible to prevent the positive electrode 21 and the separator 23 from becoming misaligned with each other. Further, the insulating layer 101 preferably includes a resin including polyvinylidene difluoride (PVDF). One reason for this is that when the insulating layer 101 includes PVDF, the insulating layer 101 is swollen by, for example, a solvent included in the electrolytic solution, which allows the insulating layer 101 to be favorably adhered to the separator 23.

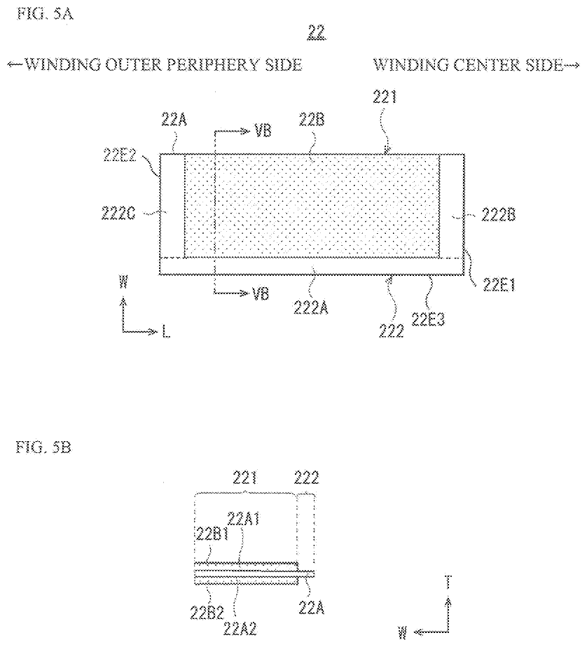

FIG. 5A is a developed view of the negative electrode 22, and schematically illustrates a state before being wound. FIG. 5B illustrates a sectional configuration of the negative electrode 22. Note that FIG. 5B illustrates a section as viewed in an arrowed direction along line VB-VB illustrated in FIG. 5A. The negative electrode 22 includes, for example, a negative electrode current collector 22A as a second electrode current collector, and a negative electrode active material layer 22B covering a part of the negative electrode current collector 22A. For example, the negative electrode active material layer 22B may be provided only on one of two opposite surfaces of the negative electrode current collector 22A, or may be provided on each of the two opposite surfaces of the negative electrode current collector 22A. FIG. 5B illustrates a case where the negative electrode active material layer 22B is provided on each of the two opposite surfaces of the negative electrode current collector 22A. More specifically, the negative electrode current collector 22A includes an inward negative electrode current collector surface 22A1 facing toward a winding center side of the electrode wound body 20, that is, facing toward the central axis CL, and an outward negative electrode current collector surface 22A2 facing toward an opposite side to the winding center side of the electrode wound body 20, that is, positioned on the opposite side to the inward negative electrode current collector surface 22A1. The negative electrode 22 includes, as the negative electrode active material layers 22B, an inner winding side negative electrode active material layer 22B1 covering all or a part of the inward negative electrode current collector surface 22A1, and an outer winding side negative electrode active material layer 22B2 covering all or a part of the outward negative electrode current collector surface 22A2. Note that in the present specification, the inner winding side negative electrode active material layer 22B1 and the outer winding side negative electrode active material layer 22B2 may each be generically referred to as the negative electrode active material layer 22B, without being distinguished from each other.

The negative electrode 22 includes a negative electrode covered region 221 in which the negative electrode current collector 22A is covered with the negative electrode active material layer 22B, and a negative electrode exposed region 222 in which the negative electrode current collector 22A is exposed without being covered with the negative electrode active material layer 22B. As illustrated in FIG. 5A, the negative electrode covered region 221 and the negative electrode exposed region 222 each extend along the L direction, i.e., the longitudinal direction of the negative electrode 22. The negative electrode exposed region 222 extends from a central axis side edge 22E1 of the negative electrode 22 to an outer winding side edge 22E2 of the negative electrode 22 in the winding direction of the electrode wound body 20. In contrast, the negative electrode covered region 221 is provided at neither the central axis side edge 22E1 of the negative electrode 22 nor the outer winding side edge 22E2 of the negative electrode 22. As illustrated in FIG. 5A, parts of the negative electrode exposed region 222 are so provided as to allow the negative electrode covered region 221 to be interposed therebetween in the L direction, i.e., the longitudinal direction of the negative electrode 22. As illustrated in FIG. 5A, the negative electrode exposed region 222 includes a first part 222A, a second part 222B, and a third part 222C. The negative electrode 22 further has a lower edge 22E3 positioned on a lower side of the electrode wound body 20 and extending in the L direction. The first part 222A is provided to be adjacent to the negative electrode covered region 221 in the W direction, and extends from the central axis side edge 22E1 of the negative electrode 22 to the outer winding side edge 22E2 of the negative electrode 22 in the L direction. In other words, the first part 222A is a region extending from the negative electrode active material layer 22B in the W direction. The second part 222B and the third part 222C are so provided as to allow the negative electrode covered region 221 to be interposed therebetween in the L direction. The first part 222A is positioned in a region including the lower edge 22E3 of the negative electrode 22 and the vicinity of the lower edge 22E3. The second part 222B is positioned in a region including the central axis side edge 22E1 of the negative electrode 22 and the vicinity of the central axis side edge 22E1, for example. The third part 222C is positioned in a region including the outer winding side edge 22E2 of the negative electrode 22 and the vicinity of the outer winding side edge 22E2. Note that FIGS. 5A and 5B each schematically illustrate the negative electrode current collector 22A in a state of being straightened along the W direction. In actuality, however, as illustrated in FIG. 1, a negative electrode edge part 222E of the negative electrode exposed region 222 is bent toward the central axis CL and coupled to the negative electrode current collector plate 25. In other words, an end part of the negative electrode exposed region 222 in the W direction forms the lower end face 42 and is coupled to the negative electrode current collector plate 25 (see FIG. 1). The lower end face 42 is formed by the negative electrode edge part 222E of the negative electrode exposed region 222 being bent toward the through hole 26 in a wound state.

In the stacked body S20 of the electrode wound body 20, the positive electrode 21 and the negative electrode 22 are so stacked with the separator 23 interposed therebetween that the positive electrode exposed region 212 and the first part 222A of the negative electrode exposed region 222 face toward mutually opposite directions along the W direction, i.e., a width direction. In the electrode wound body 20, an end part of the separator 23 is fixed by attaching a fixing tape 46 to a side surface part 45 of the electrode wound body 20 to thereby prevent loosening of winding.

In the secondary battery 1, as illustrated in FIG. 2, A >B is preferably satisfied, where A is a width of the positive electrode exposed region 212, and B is a width of the first part 222A of the negative electrode exposed region 222. For example, when the width A is 7 (mm), the width B is 4 (mm). Further, C>D is preferably satisfied, where C is a width of a part of the positive electrode exposed region 212 protruding from an outer edge in the width direction of the separator 23, and D is a width of a portion, of the first part 222A of the negative electrode exposed region 222, protruding from an opposite outer edge in the width direction of the separator 23. For example, when the width C is 4.5 (mm), the width D is 3 (mm).

As illustrated in FIG. 1, in the upper part of the secondary battery 1, multiple portions of the positive electrode edge part 212E, of the positive electrode exposed region 212 wound around the central axis CL, that are adjacent to each other in a radial direction (an R direction) of the electrode wound body 20 are so bent toward the central axis CL as to overlap each other, thus forming the upper end face 41 of the electrode wound body 20. Similarly, in the lower part of the secondary battery 1, multiple portions of the negative electrode edge part 222E, of the negative electrode exposed region 222 wound around the central axis CL, that are adjacent to each other in the radial direction (the R direction) are so bent toward the central axis CL as to overlap each other, thus forming the lower end face 42 of the electrode wound body 20. Accordingly, the multiple portions of the positive electrode edge part 212E of the positive electrode exposed region 212 gather at the upper end face 41 of the electrode wound body 20, and the multiple portions of the negative electrode edge part 222E of the negative electrode exposed region 222 gather at the lower end face 42 of the electrode wound body 20. To achieve better contact between the positive electrode current collector plate 24 for extracting a current and the positive electrode edge part 212E, the multiple portions of the positive electrode edge part 212E that are bent toward the central axis CL form a flat surface. Similarly, to achieve better contact between the negative electrode current collector plate 25 for extracting a current and the negative electrode edge part 222E, the multiple portions of the negative electrode edge part 222E that are bent toward the central axis CL form a flat surface. Note that as used herein, the term “flat surface” encompasses not only a completely flat surface but also a surface having some asperities or surface roughness to the extent that joining of the positive electrode exposed region 212 to the positive electrode current collector plate 24 and joining of the negative electrode exposed region 222 to the negative electrode current collector plate 25 are possible.

The positive electrode current collector 21A includes, for example, an aluminum foil, and will be further described later. The negative electrode current collector 22A includes, for example, a copper foil, and will be further described later. In this case, the positive electrode current collector 21A is softer than the negative electrode current collector 22A. In other words, the positive electrode exposed region 212 has a Young's modulus lower than a Young's modulus of the negative electrode exposed region 222. Accordingly, in an embodiment, it is more preferable that the widths A to D satisfy a relationship of A>B and C>D. In such a case, when the positive electrode exposed region 212 and the negative electrode exposed region 222 are simultaneously bent with equal pressures from respective electrode sides, the bent part in the positive electrode 21 and the bent part in the negative electrode 22 may sometimes have substantially equal heights measured from respective ends of the separator 23. In this case, the multiple portions of the positive electrode edge part 212E of the positive electrode exposed region 212 illustrated in FIG. 1 appropriately overlap each other by being bent. This allows for easy joining of the positive electrode exposed region 212 and the positive electrode current collector plate 24 to each other. Similarly, the multiple portions of the negative electrode edge part 222E of the negative electrode exposed region 222 illustrated in FIG. 1 appropriately overlap each other by being bent. This allows for easy joining of the negative electrode exposed region 222 and the negative electrode current collector plate 25 to each other. As used herein, the term “joining” refers to coupling by, for example, laser welding; however, a method of joining is not limited to laser welding and any suitable method of joining is applicable.

As illustrated in FIG. 2, a part, of the positive electrode exposed region 212 of the positive electrode 21, that is opposed to the negative electrode 22 with the separator 23 interposed therebetween is covered with the insulating layer 101. The insulating layer 101 has a width of 3 mm in the W direction, for example. The insulating layer 101 entirely covers a part, of the positive electrode exposed region 212 of the positive electrode 21, that is opposed to the negative electrode covered region 221 of the negative electrode 22 with the separator 23 interposed therebetween. The insulating layer 101 makes it possible to effectively prevent an internal short circuit of the secondary battery 1 when foreign matter enters between the negative electrode covered region 221 and the positive electrode exposed region 212, for example. Further, when the secondary battery 1 undergoes an impact, the insulating layer 101 absorbs the impact and thereby makes it possible to effectively prevent bending of the positive electrode exposed region 212 and a short circuit between the positive electrode exposed region 212 and the negative electrode 22.

The secondary battery 1 may further include insulating tapes 53 and 54 in a gap between the outer package can 11 and the electrode wound body 20. The positive electrode exposed region 212 having parts gathering at the upper end face 41 and the negative electrode exposed region 222 having parts gathering at the lower end face 42 are electrical conductors, such as metal foils, that are exposed. Accordingly, if the positive electrode exposed region 212 and the negative electrode exposed region 222 are in proximity to the outer package can 11, a short circuit between the positive electrode 21 and the negative electrode 22 can occur via the outer package can 11. A short circuit can also occur when the positive electrode current collector plate 24 on the upper end face 41 and the outer package can 11 come into proximity to each other. To address this, the insulating tapes 53 and 54 are preferably provided as insulating members. Each of the insulating tapes 53 and 54 is an adhesive tape including a base layer, and an adhesive layer provided on one of two opposite surfaces of the base layer. The base layer includes, for example, any one of polypropylene, polyethylene terephthalate, or polyimide. To prevent the provision of the insulating tapes 53 and 54 from resulting in a decreased capacity of the electrode wound body 20, the insulating tapes 53 and 54 are disposed not to overlap the fixing tape 46 attached to the side surface part 45, and each have a thickness set to be less than or equal to a thickness of the fixing tape 46.

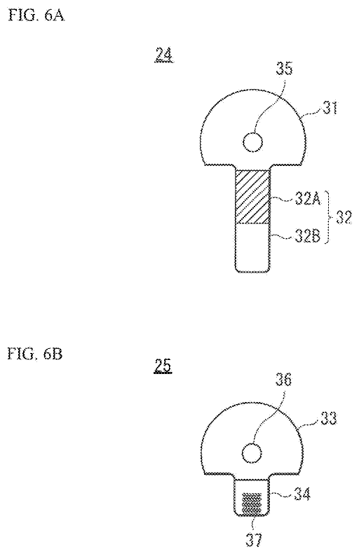

In a typical lithium-ion secondary battery, one lead for current extraction is welded to each of the positive electrode and the negative electrode, for example. However, such a structure increases an internal resistance of the lithium-ion secondary battery, causing the lithium-ion secondary battery to generate heat and become hot upon discharging; therefore, the structure is unsuitable for high-rate discharging. To address this, in the secondary battery 1 according to the present embodiment, the positive electrode current collector plate 24 is disposed to face the upper end face 41, and the negative electrode current collector plate 25 is disposed to face the lower end face 42. In addition, the positive electrode covered region 211 forming the upper end face 41 and the positive electrode current collector plate 24 are welded to each other at multiple points; and the negative electrode covered region 221 forming the lower end face 42 and the negative electrode current collector plate 25 are welded to each other at multiple points. This allows for a reduced internal resistance of the secondary battery 1. Each of the upper end face 41 and the lower end face 42 being a flat surface as described above also contributes to the reduced resistance. The positive electrode current collector plate 24 is disposed between the battery cover 14 and the upper end face 41. The positive electrode current collector plate 24 is electrically coupled to the battery cover 14 via the safety valve mechanism 30, for example. The negative electrode current collector plate 25 is disposed between the bottom part 11B of the outer package can 11 and the lower end face 42. The negative electrode current collector plate 25 is electrically coupled to an inner surface of the bottom part 11B of the outer package can 11, for example. FIG. 6A is a developed diagram illustrating a configuration example of the positive electrode current collector plate 24. FIG. 6B is a developed diagram illustrating a configuration example of the negative electrode current collector plate 25. The positive electrode current collector plate 24 is a metal plate including, for example, aluminum or an aluminum alloy as a single component, or a composite material of aluminum and the aluminum alloy. The negative electrode current collector plate 25 is a metal plate including, for example, nickel, a nickel alloy, copper, or a copper alloy as a single component, or a composite material of two or more thereof.

As illustrated in FIG. 6A, the positive electrode current collector plate 24 includes a fan-shaped part 31 having a substantially fan shape, and a band-shaped part 32 having a substantially rectangular shape. However, a shape of the positive electrode current collector plate 24 is not limited to the shape illustrated in FIG. 6A, and may be chosen as desired. Note that in the secondary battery 1, the positive electrode current collector plate 24 is contained inside the outer package can 11, as illustrated in FIG. 1, in a state where the band-shaped part 32 is bent with respect to the fan-shaped part 31. FIG. 6A illustrates the positive electrode current collector plate 24 in an unbent state. The fan-shaped part 31 is a facing part facing and coupled to the upper end face 41. The fan-shaped part 31 has an outer edge including a linear part and a curved part, for example. An opening 35 is provided in the vicinity of a middle of the fan-shaped part 31. FIG. 6A illustrates an example case where the opening 35 has a circular plan shape in a horizontal plane orthogonal to the Z-axis direction. The band-shaped part 32 is coupled to the linear part of the outer edge of the fan-shaped part 31, for example. The band-shaped part 32 extends in a direction intersecting a linear part 31S of the fan-shaped part 31. As illustrated in FIG. 1, in the secondary battery 1, the positive electrode current collector plate 24 is so provided as to allow the opening 35 to overlap the through hole 26 in the Z-axis direction. In other words, the opening 35 is positioned to overlap, in the Z-axis direction, a part of the upper end face 41 on the winding center side. Here, a diameter D35 of the opening 35 is preferably smaller than a diameter D26 of the through hole 26.

A hatched part in FIG. 6A represents an insulating part 32A of the band-shaped part 32. The insulating part 32A is a portion of the band-shaped part 32 and has an insulating tape attached thereto or an insulating material applied thereto. Of the band-shaped part 32, a portion below the insulating part 32A is a coupling part 32B to be coupled to a sealing plate that also serves as an external terminal. The sealing plate is electrically continuous with the battery cover 14. The secondary battery 1 has a battery structure without a metallic center pin in the through hole 26 as illustrated in FIG. 1, and thus there is a low possibility that the band-shaped part 32 will come into contact with a region of a negative electrode potential. In such a case, the positive electrode current collector plate 24 does not have to include the insulating part 32A. When the positive electrode current collector plate 24 does not include the insulating part 32A, it is possible to increase a charge and discharge capacity by increasing a width of each of the positive electrode 21 and the negative electrode 22 by an amount corresponding to a thickness of the insulating part 32A.

The negative electrode current collector plate 25 illustrated in FIG. 6B has a shape similar to the shape of the positive electrode current collector plate 24 illustrated in FIG. 6A. The negative electrode current collector plate 25 includes a fan-shaped part 33 having a substantially fan shape, and a band-shaped part 34 having a substantially rectangular shape. However, the shape of the negative electrode current collector plate 25 is not limited to the shape illustrated in FIG. 6B, and may be chosen as desired. In the secondary battery 1, the negative electrode current collector plate 25 is contained inside the outer package can 11, as illustrated in FIG. 1, in a state where the band-shaped part 34 is bent with respect to the fan-shaped part 33. FIG. 6B illustrates the negative electrode current collector plate 25 in an unbent state. The fan-shaped part 33 is a facing part facing and coupled to the lower end face 42. The fan-shaped part 33 has an outer edge including a linear part and a curved part, for example. The band-shaped part 34 is coupled to a linear part 33S of the outer edge of the fan-shaped part 33, for example. The band-shaped part 34 extends in a direction intersecting the linear part of the fan-shaped part 33. The band-shaped part 34 of the negative electrode current collector plate 25 is shorter than the band-shaped part 32 of the positive electrode current collector plate 24, and includes no portion corresponding to the insulating part 32A of the positive electrode current collector plate 24. The band-shaped part 34 is provided with projections 37 that each have a round shape and that are depicted as circles. All or a part of the projections 37 are welded to the bottom part 11B of the outer package can 11. Upon resistance welding, a current concentrates on the projections 37, causing the projections 37 to melt to cause the band-shaped part 34 to be welded to the bottom part 11B of the outer package can 11. As in the positive electrode current collector plate 24, an opening 36 is provided in the vicinity of a middle of the fan-shaped part 33 of the negative electrode current collector plate 25. In the secondary battery 1, the negative electrode current collector plate 25 is so provided as to allow the opening 36 to overlap the through hole 26 in the Z-axis direction. FIG. 6B illustrates an example case where the opening 36 has a circular plan shape in a horizontal plane orthogonal to the Z-axis direction.

The fan-shaped part 31 of the positive electrode current collector plate 24 covers the upper end face 41 only partly, owing to a plan shape of the fan-shaped part 31. Similarly, the fan-shaped part 33 of the negative electrode current collector plate 25 covers the lower end face 42 only partly, owing to a plan shape of the fan-shaped part 33. Reasons why the fan-shaped part 31 does not entirely cover the upper end face 41 and why the fan-shaped part 33 does not entirely cover the lower end face 42 include the following two reasons, for example. A first reason is to allow the electrolytic solution to smoothly permeate the electrode wound body 20 in assembling the secondary battery 1, for example. In the secondary battery 1 according to the present embodiment, in particular, the positive electrode current collector plate 24 is so provided as to allow the opening 35 to overlap the part of the upper end face 41 on the winding center side in the Z-axis direction. Accordingly, some of the parts of the positive electrode edge part 212E forming the upper end face 41 are not covered with the fan-shaped part 31 of the positive electrode current collector plate 24, and are thus exposed from the opening 35. The secondary battery 1 thus has a structure that allows for swifter permeation of the electrolytic solution into the electrode wound body 20. A second reason is to allow a gas generated when the lithium-ion secondary battery comes into an abnormally hot state or an overcharged state to be easily released to the outside.

The positive electrode current collector 21A includes an electrically conductive material such as aluminum, for example. The positive electrode current collector 21A is a metal foil including aluminum or an aluminum alloy, for example.

The positive electrode active material layer 21B includes, as a positive electrode active material, any one or more of positive electrode materials into which lithium is insertable and from which lithium is extractable. The positive electrode active material layer 21B may further include any one or more of other materials. Examples of the other materials include a positive electrode binder and a positive electrode conductor. It is preferable that the positive electrode material be a lithium-containing compound, and more specifically, a lithium-containing composite oxide or a lithium-containing phosphoric acid compound, for example. The lithium-containing composite oxide is an oxide including lithium and one or more of other elements, that is, one or more of elements other than lithium, as constituent elements. The lithium-containing composite oxide has any of crystal structures including, without limitation, a layered rock-salt crystal structure and a spinel crystal structure, for example. The lithium-containing phosphoric acid compound is a phosphoric acid compound including lithium and one or more of other elements as constituent elements, and has a crystal structure such as an olivine crystal structure, for example. The positive electrode active material layer 21B preferably includes, as the positive electrode active material, at least one of lithium cobalt oxide, lithium nickel cobalt manganese oxide, or lithium nickel cobalt aluminum oxide, in particular. The positive electrode binder includes, for example, any one or more of materials including, without limitation, a synthetic rubber and a polymer compound. Examples of the synthetic rubber include a styrene-butadiene-based rubber, a fluorine-based rubber, and ethylene propylene diene. Examples of the polymer compound include polyvinylidene difluoride and polyimide. The positive electrode conductor includes, for example, any one or more of materials including, without limitation, a carbon material. Examples of the carbon material include graphite, carbon black, acetylene black, and Ketjen black. The positive electrode conductor may be any of electrically conductive materials, and may be, for example, a metal material or an electrically conductive polymer.

The negative electrode current collector 22A includes, for example, an electrically conductive material such as copper. The negative electrode current collector 22A is a metal foil including a material such as nickel, a nickel alloy, copper, or a copper alloy. A surface of the negative electrode current collector 22A is preferably roughened. A reason for this is that this improves adherence of the negative electrode active material layer 22B to the negative electrode current collector 22A owing to what is called an anchor effect. In this case, the surface of the negative electrode current collector 22A is to be roughened at least in a region facing the negative electrode active material layer 22B. Examples of a roughening method include a method in which microparticles are formed through an electrolytic treatment. In the electrolytic treatment, the microparticles are formed on the surface of the negative electrode current collector 22A by an electrolytic method in an electrolyzer. This provides the surface of the negative electrode current collector 22A with asperities. A copper foil produced by the electrolytic method is generally called an electrolytic copper foil.

The negative electrode active material layer 22B includes, as a negative electrode active material, any one or more of negative electrode materials into which lithium is insertable and from which lithium is extractable. The negative electrode active material layer 22B may further include any one or more of other materials. Examples of the other materials include a negative electrode binder and a negative electrode conductor. For example, the negative electrode material is a carbon material. A reason for this is that the carbon material exhibits very little change in crystal structure at the time of insertion and extraction of lithium, and a high energy density is thus obtainable stably. Another reason is that the carbon material also serves as a negative electrode conductor, which allows the negative electrode active material layer 22B to be improved in electrical conductive property. Examples of the carbon material include graphitizable carbon, non-graphitizable carbon, and graphite. Spacing of a (002) plane of the non-graphitizable carbon is preferably 0.37 nm or greater. Spacing of a (002) plane of the graphite is preferably 0.34 nm or less. More specific examples of the carbon material include pyrolytic carbons, cokes, glassy carbon fibers, an organic polymer compound fired body, activated carbon, and carbon blacks. Examples of the cokes include pitch coke, needle coke, and petroleum coke. The organic polymer compound fired body is a resultant of firing or carbonizing a polymer compound such as a phenol resin or a furan resin at a suitable temperature. Other than the above, the carbon material may be low-crystalline carbon heat-treated at a temperature of about 1000° C. or lower, or may be amorphous carbon. The carbon material may have any of a fibrous shape, a spherical shape, a granular shape, or a flaky shape. In the secondary battery 1, when an open-circuit voltage in a fully charged state, that is, a battery voltage, is 4.25 V or higher, the amount of extracted lithium per unit mass increases as compared with when the open-circuit voltage in the fully charged state is 4.20 V, even with the same positive electrode active material. The amount of the positive electrode active material and the amount of the negative electrode active material are therefore adjusted accordingly. This makes it possible to obtain a high energy density.

The negative electrode active material layer 22B may include, as the negative electrode active material, a silicon-containing material including at least one of silicon, silicon oxide, a carbon-silicon compound, or a silicon alloy. The term “silicon-containing material” is a generic term for a material that includes silicon as a constituent element. The silicon-containing material may include only silicon as the constituent element. One silicon-containing material may be used, or two or more silicon-containing materials may be used. The silicon-containing material is able to form an alloy with lithium, and may be a simple substance of silicon, a silicon alloy, a silicon compound, a mixture of two or more thereof, or a material including one or more phases thereof. Further, the silicon-containing material may be crystalline or amorphous, or may include both a crystalline part and an amorphous part. Note that the simple substance described here refers to a simple substance merely in a general sense. The simple substance may thus include a small amount of impurity. In other words, purity of the simple substance is not limited to 100%. The silicon alloy includes, as one or more constituent elements other than silicon, any one or more of elements including, without limitation, tin, nickel, copper, iron, cobalt, manganese, zinc, indium, silver, titanium, germanium, bismuth, antimony, and chromium, for example. The silicon compound includes, as one or more constituent elements other than silicon, any one or more of elements including, without limitation, carbon and oxygen, for example. Note that the silicon compound may include, as one or more constituent elements other than silicon, any one or more of the series of constituent elements described above in relation to the silicon alloy, for example. Examples of the silicon alloy and the silicon compound include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, and SiOᵥ (where 0<v≤2). v may be set within any desired range, and may, for example, fall within the following range: 0.2<v<1.4.

The separator 23 is interposed between the positive electrode 21 and the negative electrode 22. The separator 23 allows lithium ions to pass through and prevents a short circuit of a current caused by contact between the positive electrode 21 and the negative electrode 22. The separator 23 includes, for example, any one or more kinds of porous films each including, for example, a synthetic resin or a ceramic, and may include a stacked film of two or more kinds of porous films. Examples of the synthetic resin include polytetrafluoroethylene, polypropylene, and polyethylene. The separator 23 preferably includes the bases that each include a single-layer polyolefin porous film including polyethylene. One reason for this is that a favorable high output characteristic is obtainable as compared with a stacked film. When the first separator member 23A and the second separator member included in the separator 23 each include a single-layer porous film including polyolefin, the porous film preferably has a thickness of greater than or equal to 10 μm and less than or equal to 15 μm, for example. An internal short circuit is sufficiently avoidable if the single-layer porous film including polyolefin has a thickness of greater than or equal to 10 μm. A more favorable discharge capacity characteristic is achievable if the thickness of the single-layer porous film including polyolefin is less than or equal to 15 μm. Further, the porous film preferably has a surface density of greater than or equal to 6.3 g/m² and less than or equal to 8.3 g/m², for example. An internal short circuit is sufficiently avoidable if the surface density of the single-layer porous film including polyolefin is greater than or equal to 6.3 g/m². A more favorable discharge capacity characteristic is achievable if the surface density of the single-layer porous film including polyolefin is less than or equal to 8.3 g/m².

In particular, the separator 23 may include, for example, the porous film as each of the above-described bases, and a polymer compound layer provided on one of or each of two opposite surfaces of each of the porous film. One reason for this is that adherence of the separator 23 to each of the positive electrode 21 and the negative electrode 22 improves, which suppresses distortion of the electrode wound body 20. As a result, a decomposition reaction of the electrolytic solution is suppressed, and leakage of the electrolytic solution with which the bases are impregnated is also suppressed. This prevents an easy increase in resistance even upon repeated charging and discharging, and also suppresses swelling of the battery. The polymer compound layer includes a polymer compound such as polyvinylidene difluoride. A reason for this is that the polymer compound such as polyvinylidene difluoride has superior physical strength and is electrochemically stable. The polymer compound may be other than polyvinylidene difluoride. To form the polymer compound layer, for example, a solution in which the polymer compound is dissolved in a solvent such as an organic solvent is applied on the base, following which the base is dried. Alternatively, the base may be immersed in the solution and thereafter dried. The polymer compound layer may include any one or more kinds of insulating particles such as inorganic particles, for example. Examples of the kind of the inorganic particles include aluminum oxide and aluminum nitride.

The electrolytic solution includes a solvent and an electrolyte salt. The electrolytic solution may further include any one or more of other materials. Examples of the other materials include an additive. The solvent includes any one or more of nonaqueous solvents including, without limitation, an organic solvent. An electrolytic solution including a nonaqueous solvent is what is called a nonaqueous electrolytic solution. The nonaqueous solvent includes a fluorine compound and a dinitrile compound, for example. The fluorine compound includes, for example, at least one of fluorinated ethylene carbonate, trifluorocarbonate, trifluoroethyl methyl carbonate, a fluorinated carboxylic acid ester, or a fluorine ether. The nonaqueous solvent may further include at least one of nitrile compounds other than the dinitrile compound. Examples of the nitrile compounds other than the dinitrile compound include a mononitrile compound and a trinitrile compound. For example, succinonitrile (SN) is preferable as the dinitrile compound. However, the dinitrile compound is not limited to succinonitrile, and may be another dinitrile compound such as adiponitrile.

The electrolyte salt includes, for example, any one or more of salts including, without limitation, a lithium salt. The electrolyte salt may include a salt other than the lithium salt, for example. Examples of the salt other than lithium salt include a salt of a light metal other than lithium. Examples of the lithium salt include lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), dilithium hexafluorosilicate (Li₂SiF₆), lithium chloride (LiCl), and lithium bromide (LiBr). In particular, the lithium salt is preferably any one or more of lithium hexafluorophosphate, lithium tetrafluoroborate, lithium perchlorate, or lithium hexafluoroarsenate, and more preferably, lithium hexafluorophosphate. Although not particularly limited, a content of the electrolyte salt is preferably within a range from 0.3 mol/kg to 3 mol/kg both inclusive with respect to the solvent, in particular. When the electrolytic solution includes LiPF₆ as the electrolyte salt, a concentration of LiPF₆ in the electrolytic solution is preferably higher than or equal to 1.25 mol/kg and lower than or equal to 1.45 mol/kg. One reason for this is that this makes it possible to prevent cycle deterioration caused by consumption, or decomposition, of the salt at the time of high load rate charging, and thus allows for improvement in high-load cyclability characteristic. When the electrolytic solution further includes LiBF₄ in addition to LiPF₆ as the electrolyte salt, a concentration of LiBF₄ in the electrolytic solution is preferably higher than or equal to 0.001 (wt %) and lower than or equal to 0.1 (wt %). A reason for this is that this makes it possible to more effectively prevent the cycle deterioration caused by consumption, or decomposition, of the salt at the time of high load rate charging, and thus allows for further improvement in high-load cyclability characteristic.

In the secondary battery 1 according to the present embodiment, for example, upon charging, lithium ions are extracted from the positive electrode 21, and the extracted lithium ions are inserted into the negative electrode 22 via the electrolytic solution. In the secondary battery 1, for example, upon discharging, lithium ions are extracted from the negative electrode 22, and the extracted lithium ions are inserted into the positive electrode 21 via the electrolytic solution.

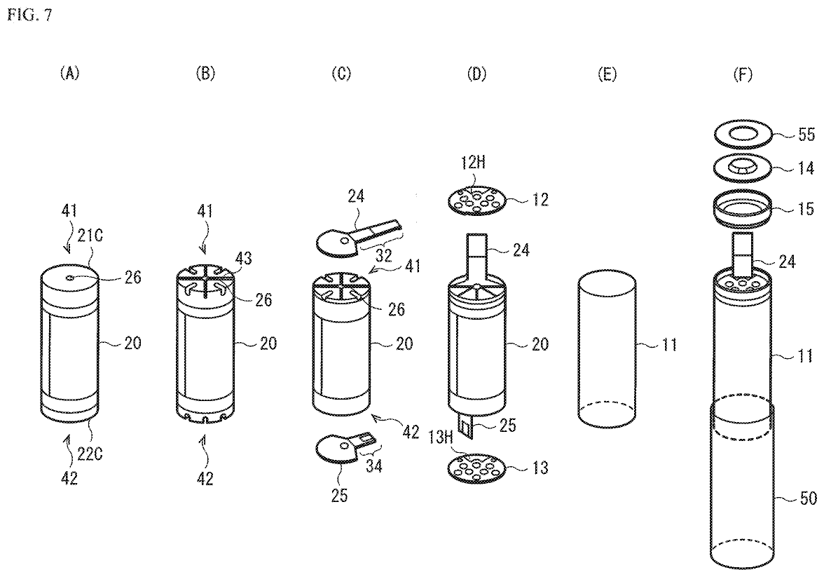

A method of manufacturing the secondary battery 1 will be described with reference to FIG. 7 as well as FIGS. 1 to 6B. FIG. 7 is a perspective diagram describing a process of manufacturing the secondary battery illustrated in FIG. 1.

First, the positive electrode current collector 21A is prepared, and the positive electrode active material layer 21B is selectively formed on the surface of the positive electrode current collector 21A. Thereafter, the insulating layer 101 is formed on the surface of the positive electrode current collector 21A, along the first edge 21BT1 of the positive electrode active material layer 21B. Thereafter, a predetermined region of the positive electrode active material layer 21B is partially removed by a method such as laser ablation to thereby form a thin part 61. The positive electrode 21 is obtained by the above-described operation. Thereafter, the negative electrode current collector 22A is prepared, and the negative electrode active material layer 22B is selectively formed on the surface of the negative electrode current collector 22A to thereby form the negative electrode 22 including the negative electrode covered region 221 and the negative electrode exposed region 222. The positive electrode 21 and the negative electrode 22 may be subjected to a drying process. Thereafter, the positive electrode 21 and the negative electrode 22 are stacked, with the first separator member 23A and the second separator member 23B on the positive electrode 21 and the negative electrode 22, respectively, to cause the positive electrode exposed region 212 and the first part 222A of the negative electrode exposed region 222 to be on opposite sides to each other in the W direction. The stacked body S20 is thereby fabricated. Thereafter, the stacked body S20 is so wound in a spiral shape as to form the through hole 26. At this time, for example, a circular columnar winding core is used as a jig, and the stacked body S20 is wound around the columnar winding core. In addition, the fixing tape 46 is attached to an outermost wind of the stacked body S20 wound in the spiral shape, following which the winding core is removed. The electrode wound body 20 is thus obtained, as illustrated in part (A) of FIG. 7.

Thereafter, as illustrated in part (B) of FIG. 7, a part of the upper end face 41 and a part of the lower end face 42 of the electrode wound body 20 are each locally bent by pressing an end of, for example, a 0.5-millimeter-thick flat plate against each of the upper end face 41 and the lower end face 42 perpendicularly, that is, in the Z-axis direction. As a result, grooves 43 are formed to extend radiately in radial directions (R directions) from the through hole 26. The number and arrangement of the grooves 43 illustrated in part (B) of FIG. 7 are merely an example, and the present disclosure is not limited thereto.

As illustrated in part (C) of FIG. 7, substantially equal pressures are applied to the upper end face 41 and the lower end face 42 in substantially perpendicular directions from above and below the electrode wound body 20 at substantially the same time. At this time, for example, a rod-shaped jig is placed in the through hole 26 in advance. By this operation, the positive electrode exposed region 212 and the first part 222A of the negative electrode exposed region 222 are bent to thereby respectively make the upper end face 41 and the lower end face 42 into flat surfaces. At this time, the multiple portions, of the positive electrode edge part 212E of the positive electrode exposed region 212 at the upper end face 41, that are adjacent to each other in the radial direction of the electrode wound body 20 are preferably so bent toward the through hole 26 as to overlap each other. Similarly, the multiple portions, of the negative electrode edge part 222E of the negative electrode exposed region 222 at the lower end face 42, that are adjacent to each other in the radial direction of the electrode wound body 20 are preferably so bent toward the through hole 26 as to overlap each other. The fan-shaped part 31 of the positive electrode current collector plate 24 is joined to the upper end face 41 by a method such as laser welding, and the fan-shaped part 33 of the negative electrode current collector plate 25 is joined to the lower end face 42 by a method such as laser welding.

The insulating tapes 53 and 54 are attached to predetermined locations on the electrode wound body 20. As illustrated in part (D) of FIG. 7, the band-shaped part 32 of the positive electrode current collector plate 24 is bent and passed through a hole 12H of the insulating plate 12. Further, the band-shaped part 34 of the negative electrode current collector plate 25 is bent and passed through a hole 13H of the insulating plate 13.

The electrode wound body 20 having been assembled in the above-described manner is placed into the outer package can 11 illustrated in part (E) of FIG. 7, following which the bottom part 11B of the outer package can 11 and the negative electrode current collector plate 25 are welded to each other. A narrow part 11S is formed in the vicinity of the open end part 11N of the outer package can 11. Further, the electrolytic solution is injected into the outer package can 11, following which the band-shaped part 32 of the positive electrode current collector plate 24 and the safety valve mechanism 30 are welded to each other.

As illustrated in (F) of FIG. 7, the outer package can 11 is sealed with the gasket 15, the safety valve mechanism 30, and the battery cover 14, through the use of the narrow part 11S. Lastly, the outer package can 11 with the washer 55 attached on the battery cover 14 is covered with the outer package tube 50, following which the outer package tube 50 is heated by, for example, applying hot air to the outer package tube 50. The outer package tube 50 is thus contracted and closely attached to the outer surface of the outer package can 11.

The secondary battery 1 according to the present embodiment is thus completed.

Examples of applications of the secondary battery 1 of the present disclosure are described below according to an embodiment.

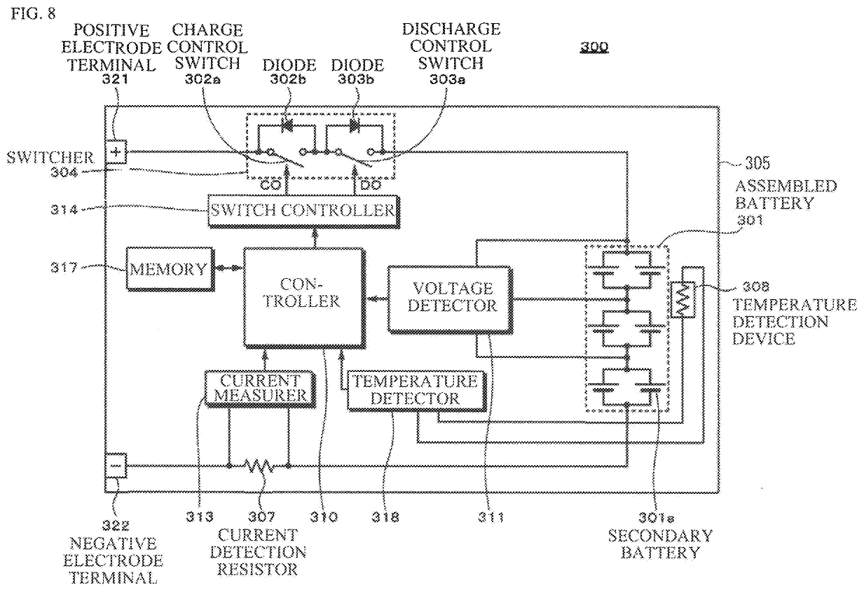

FIG. 8 is a block diagram illustrating a circuit configuration example in which a battery according to an embodiment of the present disclosure, which will hereinafter be referred to as a secondary battery as appropriate, is applied to a battery pack 300. The battery pack 300 includes an assembled battery 301, an outer package body 305, a switcher 304, a current detection resistor 307, a temperature detection device 308, and a controller 310. The switcher 304 includes a charge control switch 302a and a discharge control switch 303a.

The battery pack 300 includes a positive electrode terminal 321 and a negative electrode terminal 322. Upon charging, the positive electrode terminal 321 and the negative electrode terminal 322 are respectively coupled to a positive electrode terminal and a negative electrode terminal of a charger to thereby perform charging. Upon use of electronic equipment, the positive electrode terminal 321 and the negative electrode terminal 322 are respectively coupled to a positive electrode terminal and a negative electrode terminal of the electronic equipment to thereby perform discharging.

The assembled battery 301 includes multiple secondary batteries 301a coupled in series or in parallel. The secondary battery 1 described above is applicable to each of the secondary batteries 301a. FIG. 8 illustrates an example case in which six secondary batteries 301a are coupled in a two parallel coupling and three series coupling (2P3S) configuration; however, the secondary batteries 301a may be coupled in any other manner such as in any n parallel coupling and m series coupling configuration (where n and m are each an integer).

The switcher 304 includes the charge control switch 302a, a diode 302b, the discharge control switch 303a, and a diode 303b, and is controlled by the controller 310. The diode 302b has a polarity that is in a reverse direction with respect to a charge current flowing in a direction from the positive electrode terminal 321 to the assembled battery 301, and that is in a forward direction with respect to a discharge current flowing in a direction from the negative electrode terminal 322 to the assembled battery 301. The diode 303b has a polarity that is in the forward direction with respect to the charge current and in the reverse direction with respect to the discharge current. Note that although the switcher 304 is provided on a positive side in FIG. 8, the switcher 304 may be provided on a negative side.

The charge control switch 302a is so controlled by a charge and discharge controller that when the battery voltage reaches an overcharge detection voltage, the charge control switch 302a is turned off to thereby prevent the charge current from flowing through a current path of the assembled battery 301. After the charge control switch 302a is turned off, only discharging is enabled through the diode 302b. Further, the charge control switch 302a is so controlled by the controller 310 that when a large current flows upon charging, the charge control switch 302a is turned off to thereby block the charge current flowing through the current path of the assembled battery 301. The discharge control switch 303a is so controlled by the controller 310 that when the battery voltage reaches an overdischarge detection voltage, the discharge control switch 303a is turned off to thereby prevent the discharge current from flowing through the current path of the assembled battery 301. After the discharge control switch 303a is turned off, only charging is enabled through the diode 303b. Further, the discharge control switch 303a is so controlled by the controller 310 that when a large current flows upon discharging, the discharge control switch 303a is turned off to thereby block the discharge current flowing through the current path of the assembled battery 301.

The temperature detection device 308 is, for example, a thermistor. The temperature detection device 308 is provided in the vicinity of the assembled battery 301, measures a temperature of the assembled battery 301, and supplies data regarding the measured temperature to the controller 310. A voltage detector 311 measures a voltage of the assembled battery 301 and a voltage of each of the secondary batteries 301a included in the assembled battery 301, performs A/D conversion on the measured voltages, and supplies data regarding the converted voltages to the controller 310. A current measurer 313 measures a current by means of the current detection resistor 307, and supplies data regarding the measured current to the controller 310. A switch controller 314 controls the charge control switch 302a and the discharge control switch 303a of the switcher 304, based on the data regarding the voltages received from the voltage detector 311 and the data regarding the current received from the current measurer 313.

When a voltage of any of the multiple secondary batteries 301a reaches the overcharge detection voltage or below, or reaches the overdischarge detection voltage or below, or when a large current flows suddenly, the switch controller 314 transmits a control signal to the switcher 304 to thereby prevent overcharging and overdischarging, and overcurrent charging and discharging. For example, when the secondary battery is a lithium-ion secondary battery, the overcharge detection voltage is determined to be, for example, 4.20 V±0.05 V, and the overdischarge detection voltage is determined to be, for example, 2.4 V±0.1 V.

As the charge and discharge control switches, for example, semiconductor switches such as MOSFETs are usable. In this case, parasitic diodes of the MOSFETs serve as the diodes 302b and 303b. When P-channel FETs are used as the charge and discharge control switches, the switch controller 314 supplies control signals DO and CO to a gate of the charge control switch 302a and a gate of the discharge control switch 303a, respectively. When the charge control switch 302a and the discharge control switch 303a are of P-channel type, the charge control switch 302a and the discharge control switch 303a are turned on by a gate potential that is lower than a source potential by a predetermined value or more. That is, in normal charging and discharging operations, the control signals CO and DO are set to a low level to turn on the charge control switch 302a and the discharge control switch 303a.

For example, upon overcharging or overdischarging, the control signals CO and DO are set to a high level to turn off the charge control switch 302a and the discharge control switch 303a.

A memory 317 includes a RAM and a ROM. For example, the memory 317 includes an erasable programmable read only memory (EPROM) as a nonvolatile memory. In the memory 317, values including, without limitation, numerical values calculated by the controller 310 and a battery's internal resistance value of each of the secondary batteries 301a in an initial state measured in the manufacturing process stage, are stored in advance and are rewritable on an as-needed basis. Further, by storing data regarding a full charge capacity of the secondary battery 301a in the memory 317, it is possible to calculate, for example, a remaining capacity with the controller 310.

A temperature detector 318 measures a temperature with use of the temperature detection device 308, performs charge and discharge control upon abnormal heat generation, and performs correction in calculating the remaining capacity.

The secondary battery of the present disclosure, in an embodiment, is mountable on, or usable to supply electric power to, for example, any of equipment including, without limitation, electronic equipment, an electric vehicle, an electric aircraft, and an electric power storage apparatus.

Examples of the electronic equipment include laptop personal computers, smartphones, tablet terminals, PDAs (personal digital assistants) as mobile information terminals, mobile phones, wearable terminals, cordless phone handsets, hand-held video recording and playback devices, digital still cameras, electronic books, electronic dictionaries, music players, radios, headphones, game machines, navigation systems, memory cards, pacemakers, hearing aids, electric tools, electric shavers, refrigerators, air conditioners, televisions, stereos, water heaters, microwave ovens, dishwashers, washing machines, dryers, lighting equipment, toys, medical equipment, robots, road conditioners, and traffic lights.

Examples of the electric vehicle include railway vehicles, golf carts, electric carts, and electric automobiles including hybrid electric automobiles. The secondary battery is usable as a driving power source or an auxiliary power source for any of these electric vehicles. Examples of the electric power storage apparatuses include an electric power storage power source for architectural structures including residential houses, or for power generation facilities.

A positive electrode active material layer of a positive electrode of Example 1-1 applicable to a battery such as a lithium-ion secondary battery includes a positive electrode active material that includes a positive electrode active material particle with zirconium (Zr) or titanium (Ti) adhering onto a surface of the positive electrode active material particle. The positive electrode active material particle includes lithium nickel cobalt aluminum oxide (NCA) in which a proportion of Ni is 85% or more, or nickel cobalt manganese oxide (NCM) in which the proportion of Ni is 85% or more. In this positive electrode active material, a concentration of Zr or a concentration of Ti is relatively high at and in the vicinity of the surface of the positive electrode active material particle, and is relatively low at an inner part of the positive electrode active material particle.

Alternatively, a positive electrode active material of the positive electrode of Example 1-1 applicable to a battery such as a lithium-ion secondary battery is, for example, a lithium-nickel composite oxide such as LiNiO₂, LiNi_{0.9}Co_{0.1}O₂, LiNi_{0.85}Co_{0.1}Al_{0.05}O₂, LiNi_{0.90}Co_{0.05}Al_{0.05}O₂, LiNi_{0.82}Co_{0.14}Al_{0.04}O₂, LiNi_{0.78}Co_{0.18}Al_{0.04}O₂ and LiNi_{0.90}Co_{0.06}Al_{0.04}O₂, LiNi_{0.5}Co_{0.2}Mn_{0.3}O₂, LiNi_{0.8}Co_{0.1}Mn_{0.1}O₂, LiNi_{0.9}Co_{0.05}Mn_{0.05}O₂, LiNi_{0.3}Co_{0.3}Mn_{0.3}O₂ and LiNi_{0.84}Co_{0.08}Mn_{0.08}O₂, or LiNi_{0.80}Co_{0.10}Mn_{0.05}Al_{0.05}O₂. A surface of the positive electrode active material is covered with a boron compound. In other words, the positive electrode active material (the positive electrode material) includes, together with the lithium-nickel composite oxide, the boron compound covering the surface of the lithium-nickel composite oxide. The term “boron compound” is a generic term for a compound that includes boron (B) as a constituent element. One reason for the inclusion of the boron compound is to electrochemically stabilize the surface of the lithium-nickel composite oxide, and to thereby suppress a decomposition reaction of the electrolytic solution at the surface of the lithium-nickel composite oxide. The boron compound is not particularly limited in kind, and examples thereof include boric acid (H₃BO₃), lithium tetraborate (Li₂B₄O₇), ammonium pentaborate (NH₄B₅O₈), lithium metaborate (LiBO₂), and boron oxide (B₂O₃).

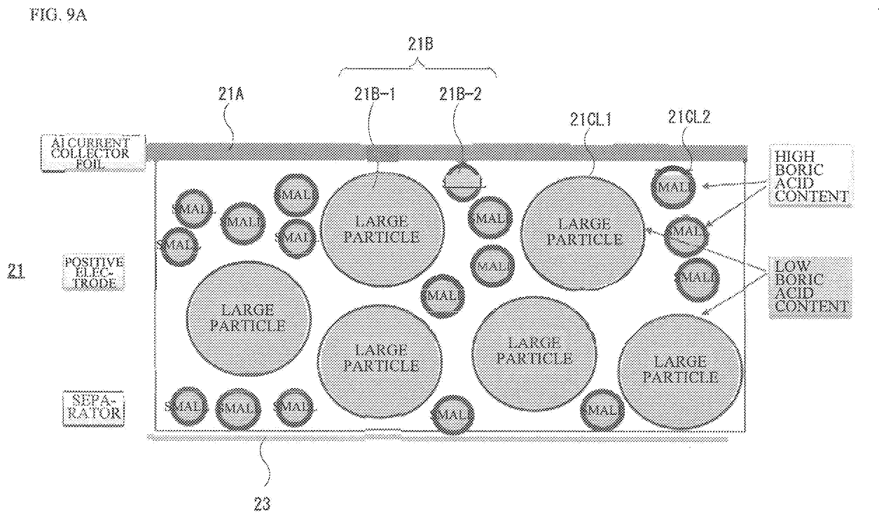

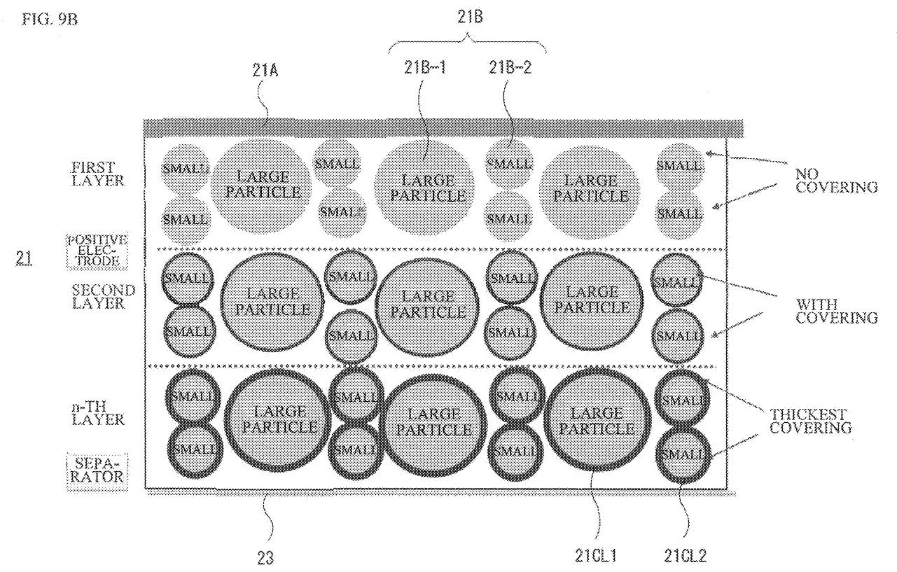

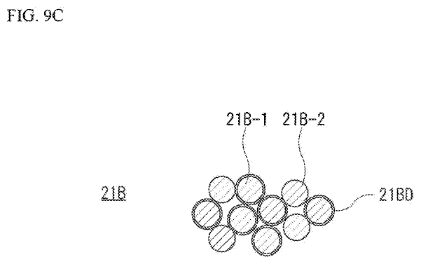

FIG. 9A is a schematic sectional diagram illustrating a configuration of a part of the positive electrode 21 of Example 1-2 applicable to, for example, a battery such as a lithium-ion secondary battery. As illustrated in FIG. 9A, in the positive electrode 21 of Example 1-2, the positive electrode active material layer 21B includes multiple particles 21B-1 each having a relatively large diameter and multiple particles 21B-2 each having a relatively small diameter. Covering films 21CL1 are provided on respective surfaces of the particles 21B-1, and covering films 21CL2 are provided on respective surfaces of the particles 21B-2. The covering films 21CL1 and 21CL2 each include boric acid. Each of the covering films 21CL1 is to cover all or a part of the surface of corresponding one of the particles 21B-1, and each of the covering films 21CL2 is to cover all or a part of the surface of corresponding one of the particles 21B-2. Here, an adhesion amount (a weight) per unit surface area of each of the covering films 21CL2 covering the surface of corresponding one of the particles 21B-2 is preferably greater than an adhesion amount (a weight) per unit surface area of each of the covering films 21CL1 covering the surface of corresponding one of the particles 21B-1.

In the positive electrode 21 of Example 1-2, the small-diameter particles 21B-2 whose degradation tends to proceed relatively fast are selectively covered with a large amount of boric acid. This makes it possible to suppress degradation of the positive electrode active material, and to achieve a reduction in reaction resistance.

FIG. 9B is a schematic sectional diagram illustrating a configuration of a part of the positive electrode 21 of Example 1-3 applicable to, for example, a battery such as a lithium-ion secondary battery. As illustrated in FIG. 9B, in the positive electrode 21 of Example 1-3, the positive electrode active material layer 21B includes the multiple particles 21B-1 each having a relatively large diameter and the multiple particles 21B-2 each having a relatively small diameter. The covering films 21CL1 are provided on the respective surfaces of the particles 21B-1, and the covering films 21CL2 are provided on the respective surfaces of the particles 21B-2. The covering films 21CL1 and 21CL2 each include boric acid. Each of the covering films 21CL1 is to cover all or a part of the surface of corresponding one of the particles 21B-1, and each of the covering films 21CL2 is to cover all or a part of the surface of corresponding one of the particles 21B-2. However, neither of the covering films 21CL1 and 21CL2 is present in a region of a first layer, of the positive electrode active material layer 21B, that is positioned closest to the positive electrode current collector 21A. Further, the covering films 21CL1 and 21CL2 in a region of an n-th layer, of the positive electrode active material layer 21B, that is positioned farthest from the positive electrode current collector 21A, i.e., closest to the separator 23, are respectively greater in adhesion amount than the covering films 21CL1 and 21CL2 in a region between the first layer and the n-th layer. As used herein, the adhesion amount refers to a weight per unit surface area of each of the covering films 21CL1 covering the surface of corresponding one of the particles 21B-1, or a weight per unit surface area of each of the covering films 21CL2 covering the surface of corresponding one of the particles 21B-2.

In the n-th layer, of the positive electrode active material layer 21B, that is positioned closest to the separator 23, Li ions diffuse fast, and degradation of the positive electrode active material tends to proceed fast. In the positive electrode 21 of Example 1-3, the covering films 21CL1 and 21CL2 each including boric acid are allowed to be greater in adhesion amount in the n-th layer positioned closest to the separator 23 than in the other layers. This makes it possible to suppress degradation of the positive electrode active material. Accordingly, the positive electrode 21 of Example 1-3 makes it possible to suppress degradation from a reaction resistance after charging and discharging cycles in the region of the n-th layer, of the positive electrode active material layer 21B, that is positioned closest to the separator 23, and also suppress an increase in reaction resistance in the region of the first layer, of the positive electrode active material layer 21B, that is positioned closest to the positive electrode current collector 21A.

FIG. 9C is a schematic sectional diagram illustrating, in an enlarged manner, positive electrode active material particles 21B-1 and 21B-2 included in the positive electrode active material layer 21B of Example 1-4 applicable to, for example, a battery such as a lithium-ion secondary battery. As illustrated in FIG. 9C, in the positive electrode active material layer 21B of Example 1-4, the positive electrode active material particles 21B-1 each covered with a binder 21BD and the positive electrode active material particles 21B-2 not covered with the binder 21BD are mixed with each other.

It is expectable that the positive electrode active material layer 21B of Example 1-4 contributes to higher output. For example, a state where the binder 21BD is present is kept at a contact between the positive electrode active material particle 21B-1 and the positive electrode active material particle 21B-2. That is, mechanical strength of the positive electrode active material layer 21B is retained. At the same time, the presence of the positive electrode active material particle 21B-2 not covered with the binder 21BD allows for favorable insertion and extraction of lithium ions.

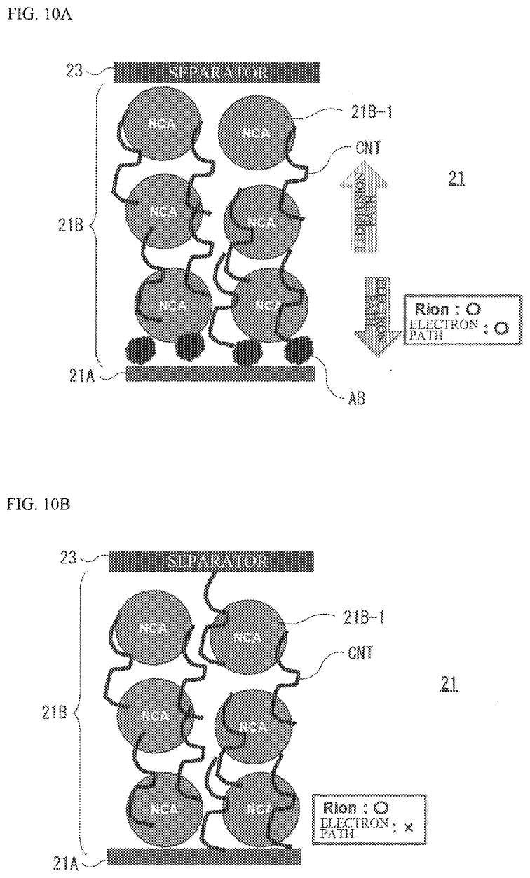

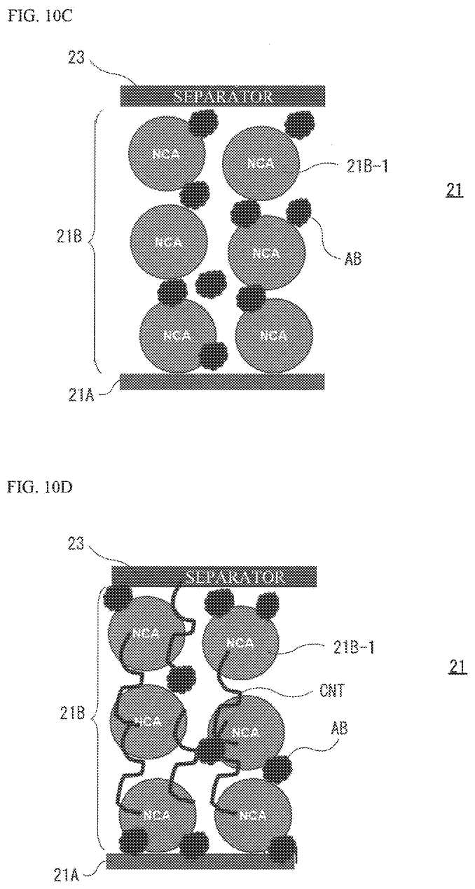

FIG. 10A is a schematic sectional diagram illustrating a configuration of a part of the positive electrode 21 of Example 2-1-1 applicable to, for example, a battery such as a lithium-ion secondary battery. As illustrated in FIG. 10A, in the positive electrode 21 of Example 2-1-1, the positive electrode active material layer 21B includes positive electrode active material particles 21B-1, carbon nanotubes CNT, and acetylene black AB. The positive electrode active material particles 21B-1 include a material such as lithium nickel cobalt aluminum oxide (NCA). The acetylene black AB is present at and in the vicinity of an interface between the positive electrode current collector 21A and the positive electrode active material layer 21B.

FIG. 10B is a schematic sectional diagram illustrating a configuration of a part of the positive electrode 21 of Example 2-1-2 applicable to, for example, a battery such as a lithium-ion secondary battery. The positive electrode 21 of Example 2-1-2 is substantially the same in configuration as the positive electrode 21 of Example 2-1-1, except that no acetylene black AB is included.

FIG. 10C is a schematic sectional diagram illustrating a configuration of a part of the positive electrode 21 of Example 2-1-3 applicable to, for example, a battery such as a lithium-ion secondary battery. The positive electrode 21 of Example 2-1-3 is substantially the same in configuration as the positive electrode 21 of Example 2-1-1, except that no carbon nanotubes CNT are included and that acetylene black AB is present in a dispersed manner in the positive electrode active material layer 21B, not only at and in the vicinity of the interface between the positive electrode current collector 21A and the positive electrode active material layer 21B but also in other regions.

FIG. 10D is a schematic sectional diagram illustrating a configuration of a part of the positive electrode 21 of Example 2-1-4 applicable to, for example, a battery such as a lithium-ion secondary battery. The positive electrode 21 of Example 2-1-4 is substantially the same in configuration as the positive electrode 21 of Example 2-1-1, except that acetylene black AB is present in a dispersed manner in the positive electrode active material layer 21B, not only at and in the vicinity of the interface between the positive electrode current collector 21A and the positive electrode active material layer 21B but also in other regions.

The positive electrode active material layer 21B of Example 2-1-1 makes it possible to achieve both a reduction in mixture resistance (i.e., a resistance at an inner part of the positive electrode active material layer 21B) and a reduction in interface resistance (i.e., a resistance at the interface between the positive electrode current collector 21A and the positive electrode active material layer 21B), and also makes it possible to achieve a superior load characteristic, as compared with the positive electrode active material layer 21B of each of Examples 2-1-2 to 2-1-4. A reason for this is considered to be that dispersing the carbon nanotubes CNT over the entire positive electrode active material layer 21B allows for securing of a diffusion path of Li ions, and providing the acetylene black AB at and in the vicinity of the interface between the positive electrode current collector 21A and the positive electrode active material layer 21B allows for formation of a favorable electron path.

FIG. 11A is a schematic sectional diagram illustrating a configuration of a part of the positive electrode 21 of Example 2-2-1 applicable to, for example, a battery such as a lithium-ion secondary battery. As illustrated in FIG. 11A, in the positive electrode 21 of Example 2-2-1, the positive electrode active material layer 21B includes positive electrode active material particles 21B-1 and 21B-2, carbon nanotubes CNT each having a length of about 150 μm, and acetylene black AB. The positive electrode active material particles 21B-1 and 21B-2 each include a material such as lithium nickel cobalt aluminum oxide (NCA). The acetylene black AB is present between multiple ones of the positive electrode active material particles 21B-1 and 21B-2, for example. In the positive electrode 21 of Example 2-2-1, the positive electrode active material layer 21B includes the multiple particles 21B-1 each having a relatively large diameter, and the multiple particles 21B-2 each having a relatively small diameter.

FIG. 11B is a schematic sectional diagram illustrating a configuration of a part of the positive electrode 21 of Example 2-2-2 applicable to, for example, a battery such as a lithium-ion secondary battery. The positive electrode 21 of Example 2-2-2 is substantially the same in configuration as the positive electrode 21 of Example 2-2-1, except that the carbon nanotubes CNT each have a length of 50 μor less.

In the positive electrode 21 of Example 2-2-1, the positive electrode active material layer 21B includes the carbon nanotubes CNT that are large in length, as compared with the positive electrode 21 of Example 2-2-2. This reduces variations in electron resistance in the positive electrode active material layer 21B and allows for preventing isolation of the electron path of the positive electrode active material particles having a relatively small particle size, in particular. Accordingly, it is possible to mitigate degradation caused by repeated charging and discharging.

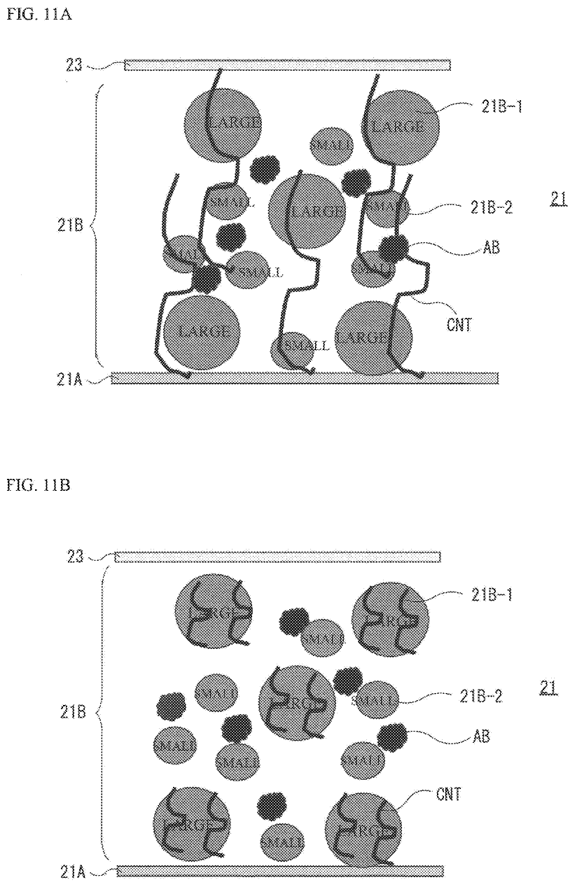

FIG. 12A is a schematic sectional diagram illustrating a configuration of a part of the positive electrode active material layer 21B of Example 2-3-1 applicable to, for example, a battery such as a lithium-ion secondary battery. As illustrated in FIG. 12A, the positive electrode active material layer 21B of Example 2-3-1 includes the multiple positive electrode active material particles 21B-1, acetylene black AB serving as a spherical conductive additive, and carbon nanotubes CNT serving as a linear conductive additive. It is preferable that the carbon nanotubes CNT be uniformly distributed over the entire positive electrode active material layer 21B by mixing, in a process of fabricating the positive electrode active material layer 21B, a CNT dispersion liquid including uniformly dispersed carbon nanotubes CNT with a positive electrode mixture slurry and applying the resultant mixture on the positive electrode current collector 21A. The carbon nanotubes CNT each preferably have a length of 100 μm or more, for example. Detection of the carbon nanotubes CNT is possible by subjecting the positive electrode active material layer 21B to dilution with N-methyl-2-pyrrolidone (NMP) followed by drying, and observing the resultant by SEM.

FIG. 12B is a schematic sectional diagram illustrating a configuration of a part of the positive electrode active material layer 21B of Example 2-3-2 applicable to, for example, a battery such as a lithium-ion secondary battery. The positive electrode 21 of Example 2-3-2 is substantially the same in configuration as the positive electrode active material layer 21B of Example 2-3-1, except that no carbon nanotubes CNT are included.

As compared with the positive electrode active material layer 21B of Example 2-3-2, the positive electrode active material layer 21B of Example 2-3-1 includes both the carbon nanotubes CNT and the acetylene black AB, which makes it possible to prevent isolation of the electron path of the positive electrode active material in the positive electrode active material layer 21B, and to reduce variations in resistance at the inner part of the positive electrode active material layer 21B. Furthermore, owing to the inclusion of the carbon nanotubes CNT in addition to the acetylene black AB, it is possible to reduce a total amount of the acetylene black AB included in the positive electrode active material layer 21B. This allows for easy movement of Li ions.

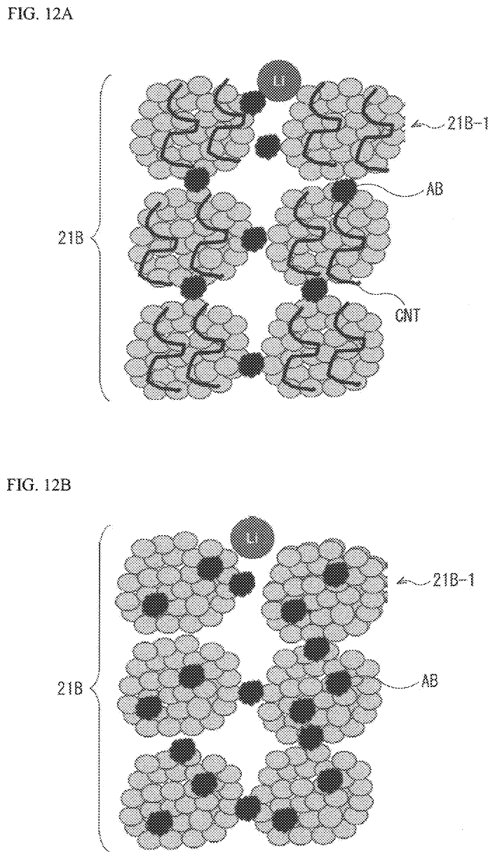

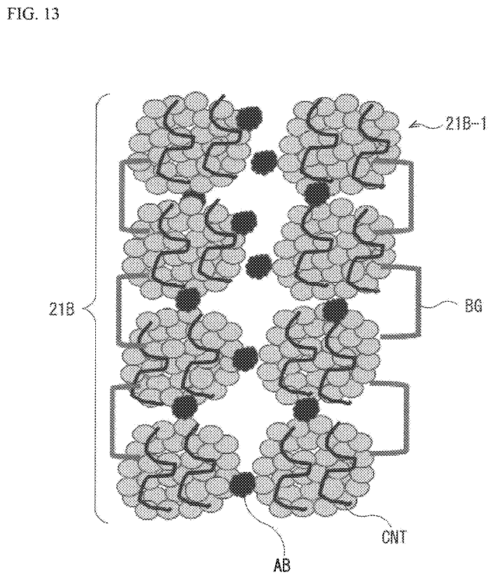

FIG. 13 is a schematic sectional diagram illustrating a configuration of a part of the positive electrode active material layer 21B of Example 2-4 applicable to, for example, a battery such as a lithium-ion secondary battery. As illustrated in FIG. 13, the positive electrode active material layer 21B of Example 2-4 includes the multiple positive electrode active material particles 21B-1, the acetylene black AB serving as a spherical conductive additive, the carbon nanotubes CNT serving as a linear conductive additive, and bridges BG having an electrically conductive property. The bridges BG each couple adjacent ones of the positive electrode active material particles 21B-1. Examples of the bridges BG include aluminum (Al) powder, pieces of Al, and aluminum fibers. Alternatively, the bridges BG may be aluminum (Al) powder having a surface covered with a covering film including a fluorine compound, pieces of Al each having a surface covered with a covering film including a fluorine compound, or aluminum fibers each having a surface covered with a covering film including a fluorine compound. As a constituent material of the bridges BG, a metal that does not decompose even at a high potential is preferably used as well as Al.

In the positive electrode active material layer 21B of Example 2-4, the bridges BG each couple multiple ones of the positive electrode active material particles 21B-1 to each other. Accordingly, as compared with the positive electrode active material layer 21B of another example without the bridges BG, binding between the positive electrode active material particles 21B-1 is enhanced, which makes it possible to enhance mechanical strength of the positive electrode active material layer 21B. In addition, it is possible to reduce isolation of the positive electrode active material, and to suppress degradation in load characteristic even if the positive electrode active material layer 21B is increased in thickness.

The positive electrode current collector 21A of the positive electrode 21 of Example 2-5 applicable to a battery such as a lithium-ion secondary battery includes an Al material in which a total purity by mass percent of silicon (Si) and iron (Fe) is 0.05% or less, a purity by mass percent of copper (Cu) is 0.1% or less, a purity by mass percent of magnesium (Mg) is 0.1% or less, and a total purity by mass percent of elements other than the above-listed elements is 0.05% or less. Further, the Al material included in the positive electrode current collector 21A of Example 2-5 has a thermal conductivity of 238 W/m·C or more, and a modulus of longitudinal elasticity of 70 kN/mm² or more.

As the positive electrode current collector 21A of Example 2-5, an aluminum foil having a high thermal conductivity, that is, containing low impurities, is employed. This makes it possible to improve heat dissipation performance of the electrode wound body 20. In other words, heat generated inside the battery is efficiently dissipated to the outside. A temperature increase of an electrode material or the electrolytic solution is thereby suppressed. Furthermore, it is possible to suppress an increase in internal resistance, which allows for improvements in terms of energy supply from the battery and charge and discharge rates, leading to higher output. Further, the improved heat dissipation performance suppresses a temperature increase, and thus reduces an excessive temperature increase of the electrode wound body 20 and thermal stress on the electrode wound body 20, thereby making it possible to maintain a stable operation state of the electrode wound body 20.

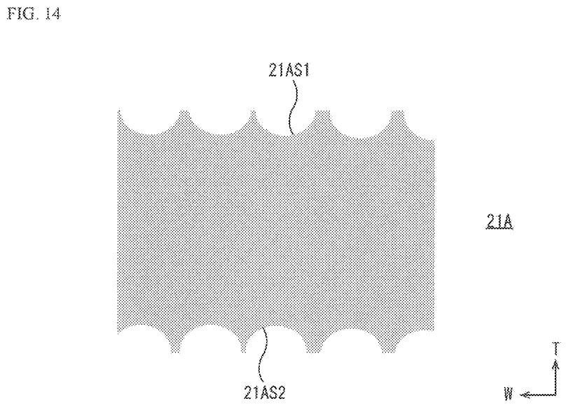

FIG. 14 is a schematic sectional diagram illustrating a configuration of the positive electrode current collector 21A of Example 2-6 applicable to, for example, a battery such as a lithium-ion secondary battery. As illustrated in FIG. 14, the positive electrode current collector 21A of Example 2-6 has a front surface 21AS1 and a back surface 21AS2 that are each shaped to have projections and depressions. The shape of each of the front surface 21AS1 and the back surface 21AS2 illustrated in FIG. 14 is an example, and the present disclosure is not limited thereto. Further, when the positive electrode active material layer 21B is to be provided only on the front surface 21AS1, the back surface 21AS2 does not have to be shaped to have the projections and depressions. The shape of each of the front surface 21AS1 and the back surface 21AS2 with the projections and depressions is formed by edging, for example.

In the positive electrode current collector 21A of Example 2-6, the front surface 21AS1 and the back surface 21AS2 are each shaped to have the projections and depressions. This makes it possible to increase a surface area of each of the front surface 21AS1 and the back surface 21AS2. Accordingly, it is possible to increase an area of contact between the positive electrode current collector 21A and the positive electrode active material layer 21B at the interface therebetween, and to reduce the resistance at the interface between the positive electrode current collector 21A and the positive electrode active material layer 21B. Further, the shape with the projections and depressions provides an anchor effect of holding the positive electrode active material layer 21B, which makes it possible to suppress detachment or peeling of the positive electrode active material layer 21B from the positive electrode current collector 21A.

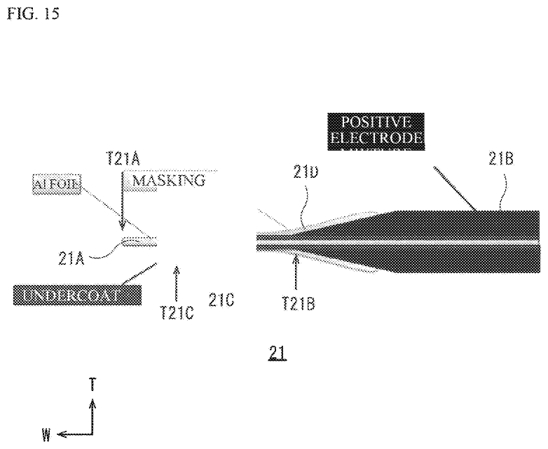

FIG. 15 is an enlarged sectional diagram illustrating a configuration of a part of the positive electrode 21 of Example 3-1 applicable to, for example, a battery such as a lithium-ion secondary battery. As illustrated in FIG. 15, the positive electrode 21 of Example 3-1 includes the positive electrode current collector 21A, the positive electrode active material layer 21B, an undercoat layer 21C, and a masking layer 21D.

The positive electrode current collector 21A includes, for example, an electrically conductive material such as aluminum. For example, the positive electrode current collector 21A is a metal foil including aluminum or an aluminum alloy. In the positive electrode current collector 21A, an end part in the W direction, i.e., the width direction, is in an exposed state, being covered with none of the positive electrode active material layer 21B, the undercoat layer 21C, and the masking layer 21D.

The undercoat layer 21C includes, for example, carbon black or carbon nanotubes (CNT). The undercoat layer 21C covers each of the two opposite surfaces of the positive electrode current collector 21A. However, the undercoat layer 21C does not reach a leading end T21A of the positive electrode current collector 21A. In other words, in the W direction, a leading end T21C of the undercoat layer 21C is positioned to be inwardly retracted relative to a position of the leading end T21A of the positive electrode current collector 21A.

The positive electrode active material layer 21B is provided on the undercoat layer 21C. However, the positive electrode active material layer 21B does not reach the leading end T21C of the undercoat layer 21C. In other words, in the W direction, a leading end T21B of the positive electrode active material layer 21B is at a position inwardly retracted relative to the position of the leading end T21C of the undercoat layer 21C. The leading end T21C of the undercoat layer 21C and the vicinity of the leading end T21C are thus not covered with the positive electrode active material layer 21B. In the positive electrode 21 of Example 3-1, a border between the undercoat layer 21C and the positive electrode active material layer 21B and the vicinity of the border are covered with the masking layer 21D. Note that the undercoat layer 21C and the positive electrode active material layer 21B each include a part not covered with the masking layer 21D. The masking layer 21D may include an insulating material such as a resin including modified polyvinylidene difluoride (PVDF) or copolymer PVDF, for example.

The positive electrode 21 of Example 3-1 is provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, owing to the undercoat layer 21C being partly covered with the masking layer 21D, detachment of the positive electrode active material layer 21B from the positive electrode current collector 21A due to a factor such as a difference between a hardness of the positive electrode active material layer 21B and a hardness of the masking layer 21D is suppressed even when the positive electrode active material layer 21B is made large in thickness.

In the positive electrode 21 of Example 3-2 applicable to a battery such as a lithium-ion secondary battery, the undercoat layer 21C includes, for example: an organic compound such as non-fibrous electrically conductive carbon, fibrous carbon, or particulate carbon; a silicic acid compound; or an inorganic compound such as aluminum hydrous oxide. For example, when the undercoat layer 21C applied on the surface of the positive electrode current collector 21A such as an aluminum foil, or the undercoat layer fired after being applied on the surface of the positive electrode current collector 21A is subjected to image capturing with a CCD imaging device under irradiation with an LED light source of 1400000 [lx] and the captured image is binarized, a luminance value of the undercoat layer 21C is 230 or less. Note that the undercoat layer 21C may have any color; however, when the color is expressed in RGB (i, i, i), i is preferably within a range from 0 to 230 both inclusive.

The positive electrode 21 of Example 3-2 makes it possible to more accurately detect a position of a border between, for example, a region where the undercoat layer 21C is applied and a region where the masking layer 21D is applied as an upper layer on the undercoat layer 21C.

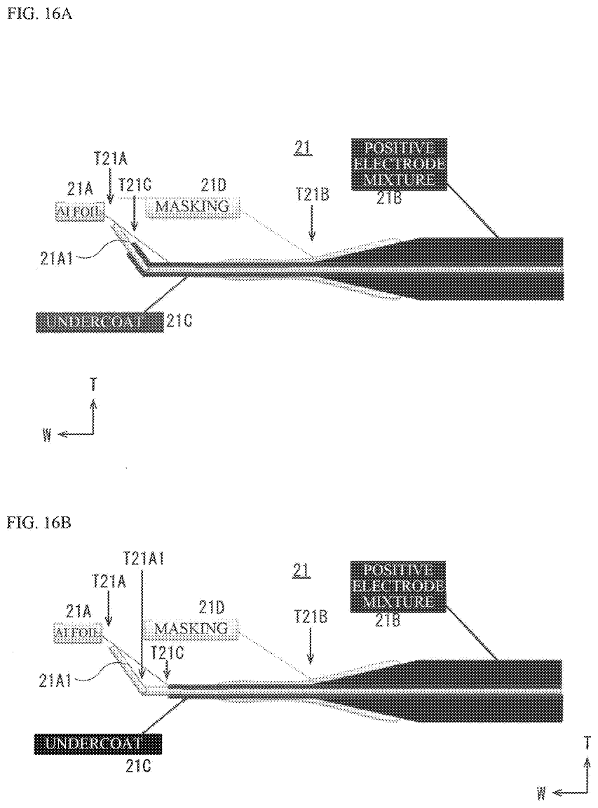

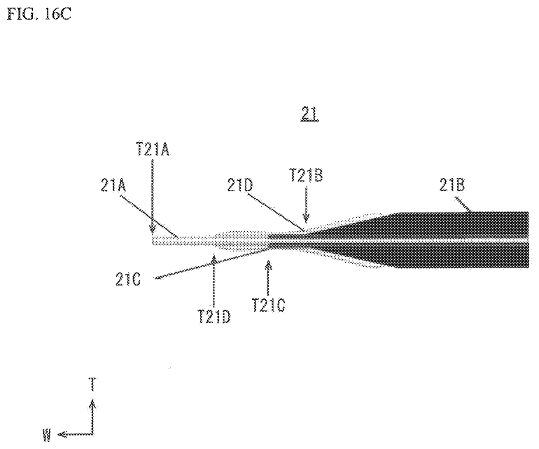

FIG. 16A is an enlarged sectional diagram illustrating a configuration of a part of the positive electrode 21 of Example 4-1 applicable to, for example, a battery such as a lithium-ion secondary battery. As illustrated in FIG. 16A, the positive electrode 21 of Example 4-1 includes the positive electrode current collector 21A, the positive electrode active material layer 21B, the undercoat layer 21C, and the masking layer 21D.

The positive electrode current collector 21A includes, for example, an electrically conductive material such as aluminum. For example, the positive electrode current collector 21A is a metal foil including aluminum or an aluminum alloy. In the positive electrode current collector 21A, a first end part 21A1 in the W direction, i.e., the width direction, is bent.

The undercoat layer 21C includes, for example, carbon black or carbon nanotubes (CNT). The undercoat layer 21C covers each of the two opposite surfaces of the positive electrode current collector 21A. However, the undercoat layer 21C does not reach the leading end T21A of the first end part 21A1 of the positive electrode current collector 21A. In other words, in the W direction, the leading end T21C of the undercoat layer 21C is positioned to be inwardly retracted relative to the position of the leading end T21A of the positive electrode current collector 21A. Accordingly, the leading end T21A of the first end part 21A1 of the positive electrode current collector 21A and the vicinity of the leading end T21A are in the exposed state, not being covered with the undercoat layer 21C.

The positive electrode active material layer 21B is provided on the undercoat layer 21C. However, the positive electrode active material layer 21B does not reach the leading end T21C of the undercoat layer 21C. In other words, in the W direction, the leading end T21B of the positive electrode active material layer 21B is positioned to be inwardly retracted relative to the position of the leading end T21C of the undercoat layer 21C. The leading end T21C of the undercoat layer 21C and the vicinity of the leading end T21C are thus not covered with the positive electrode active material layer 21B. In the positive electrode 21 of Example 4-1, the border between the undercoat layer 21C and the positive electrode active material layer 21B and the vicinity of the border are covered with the masking layer 21D. Note that the undercoat layer 21C and the positive electrode active material layer 21B each include a part not covered with the masking layer 21D. The masking layer 21D may include an insulating material such as a resin including modified polyvinylidene difluoride (PVDF) or copolymer PVDF, for example.

The positive electrode 21 of Example 4-1 is provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, owing to the undercoat layer 21C covering the positive electrode current collector 21A up to a portion of the first end part 21A1 that is bent, thermal diffusion performance improves at a location where the positive electrode current collector 21A and the positive electrode current collector plate 24 are welded to each other.

FIG. 16B is an enlarged sectional diagram illustrating a configuration of a part of the positive electrode 21 of Example 4-2 applicable to, for example, a battery such as a lithium-ion secondary battery. As illustrated in FIG. 16B, in the positive electrode 21 of Example 4-2, the leading end T21C of the undercoat layer 21C is positioned to be inwardly retracted relative to a bending position T21A1 of the first end part 21A1 of the positive electrode current collector 21A. The positive electrode 21 of Example 4-2 is otherwise substantially the same in configuration as the positive electrode 21 of Example 4-1 illustrated in FIG. 16A.

According to the positive electrode 21 of Example 4-2, the provision of the undercoat layer 21C improves heat dissipation performance and also makes it possible to prevent the undercoat layer 21C from peeling away when the first end part 21A1 of the positive electrode current collector 21A and the positive electrode current collector plate 24 are welded to each other.

FIG. 16C is an enlarged sectional diagram illustrating a configuration of a part of the positive electrode 21 of Example 4-3 applicable to, for example, a battery such as a lithium-ion secondary battery. As illustrated in FIG. 16C, in the positive electrode 21 of Example 4-3, the leading end T21C of the undercoat layer 21C is positioned to be inwardly retracted relative to a leading end T21D of the masking layer 21D. Accordingly, the undercoat layer 21C is covered with the masking layer 21D and the positive electrode active material layer 21B. The positive electrode 21 of Example 4-3 is otherwise substantially the same in configuration as the positive electrode 21 of Example 4-1 illustrated in FIG. 16A.

According to the positive electrode 21 of Example 4-3, heat dissipation performance is improved by the provision of the undercoat layer 21C, and it is also possible for the undercoat layer 21C to be protected by the masking layer 21D and the positive electrode active material layer 21B. Further, the undercoat layer 21C is present also below the masking layer 21D in a T direction, i.e., a thickness direction. This makes it possible to suppress peeling that occurs due to a difference between the hardness of the positive electrode active material layer 21B and the hardness of the masking layer 21D when the positive electrode active material layer 21B is applied thickly. Furthermore, the masking layer 21D is also in contact with the positive electrode current collector 21A, which makes it possible to effectively suppress the occurrence of peeling.

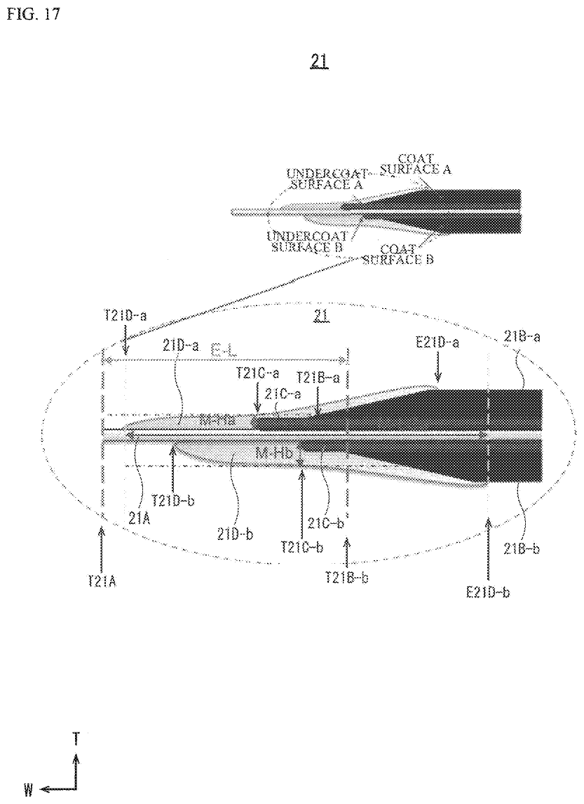

FIG. 17 is an enlarged sectional diagram illustrating a configuration of a part of the positive electrode 21 of Example 4-4-1 applicable to, for example, a battery such as a lithium-ion secondary battery. As illustrated in FIG. 17, in the positive electrode 21 of Example 4-4-1, undercoat layers 21C-a and 21C-b, positive electrode active material layers 21B-a and 21B-b, and masking layers 21D-a and 21D-b are provided on the two respective opposite surfaces (for convenience, hereinafter referred to as a surface A and a surface B) of the positive electrode current collector 21A. In the positive electrode 21 of Example 4-4-1, as with the positive electrode 21 of Example 4-3 illustrated in FIG. 16C, the undercoat layers 21C-a and 21C-b are covered with the masking layers 21D-a and 21D-b, respectively, and with the positive electrode active material layers 21B-a and 21B-b, respectively.

In the positive electrode 21 of Example 4-4-1, in the W direction, a leading end T21D-a of the masking layer 21D-a is positioned to be retracted relative to the position of the leading end T21A of the positive electrode current collector 21A, a leading end T21D-b of the masking layer 21D-b is positioned to be retracted relative to the position of the leading end T21D-a, a leading end T21C-a of the undercoat layer 21C-a is positioned to be retracted relative to the position of the leading end T21D-b, a leading end T21C-b of the undercoat layer 21C-b is positioned to be retracted relative to the position of the leading end T21C-a, a leading end T21B-a of the positive electrode active material layer 21B-a is positioned to be retracted relative to the position of the leading end T21C-b, and a leading end T21B-b of the positive electrode active material layer 21B-b is positioned to be retracted relative to the position of the leading end T21B-a. Further, in the W direction, a trailing end E21D-b of the masking layer 21D-b is positioned to be retracted relative to a position of a trailing end E21D-a of the masking layer 21D-a. Furthermore, in the T direction corresponding to the thickness direction, a distance M-Ha between a surface of the masking layer 21D-a and the surface A of the positive electrode current collector 21A at the position of the leading end T21C-a of the undercoat layer 21C-a is smaller than a distance M-Hb between a surface of the masking layer 21D-b and the surface B of the positive electrode current collector 21A at the position of the leading end T21C-b of the undercoat layer 21C-b, that is, M-Ha<M-Hb.

In the positive electrode 21 of Example 4-4-1, the position of the leading end T21D-a of the masking layer 21D-a is closer to the position of the leading end T21A of the positive electrode current collector 21A than the position of the leading end T21D-b of the masking layer 21D-b in the W direction, and the distance M-Ha is smaller than the distance M-Hb. This makes it easy to bend the first end part of the positive electrode current collector 21A. In other words, the positive electrode current collector 21A is easy to bend, with the position of the leading end T21D-b serving as a fulcrum. This prevents bending stress on the undercoat layers 21C-a and 21C-b formed on the two respective opposite surfaces of the positive electrode current collector 21A from being easily transferred, and thus makes it possible to suppress the occurrence of peeling of the undercoat layers 21C-a and 21D-b, for example.

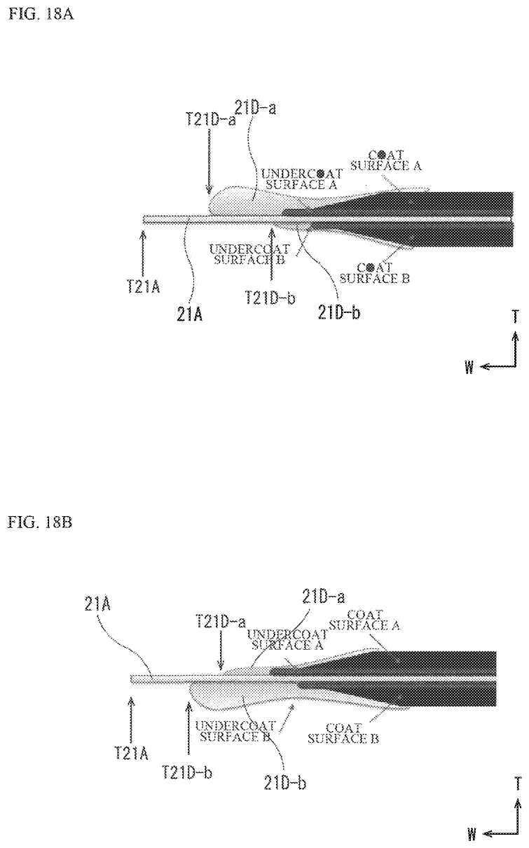

In contrast, when the position of the leading end T21D-a of the masking layer 21D-a is closer to the position of the leading end T21A of the positive electrode current collector 21A than the position of the leading end T21D-b of the masking layer 21D-b in the W direction and a thickness of the masking layer 21D-a is greater than a thickness of the masking layer 21D-b as in Example 4-4-2A illustrated in FIG. 18A, it is difficult to bend the positive electrode current collector 21A at the position of the leading end T21D-b. Similarly, when the position of the leading end T21D-b of the masking layer 21D-b is closer to the position of the leading end T21A of the positive electrode current collector 21A than the position of the leading end T21D-a of the masking layer 21D-a in the W direction and the thickness of the masking layer 21D-b is greater than the thickness of the masking layer 21D-a as in Example 4-4-2B illustrated in FIG. 18B, it is difficult to bend the positive electrode current collector 21A at the position of the leading end T21D-a.

FIG. 19A is an enlarged sectional diagram illustrating a configuration of a part of the positive electrode 21 of Example 4-4-3A applicable to, for example, a battery such as a lithium-ion secondary battery. In the positive electrode 21 of Example 4-4-3A, the leading end T21D-a of the masking layer 21D-a and the leading end T21D-b of the masking layer 21D-b are at substantially the same position in the W direction. Further, the position of the leading end T21C-a of the undercoat layer 21C-a is closer to the leading end T21A of the positive electrode current collector 21A than the position of the leading end T21C-b of the undercoat layer 21C-b. In this case, the masking layer 21D-a preferably has a thickness smaller than the thickness of the masking layer 21D-b.

In the positive electrode 21 of Example 4-4-3A, the leading end T21D-a of the masking layer 21D-a and the leading end T21D-b of the masking layer 21D-b are at substantially the same position in the W direction, and the distance M-Ha is shorter than the distance M-Hb. This makes it easy to bend the first end part of the positive electrode current collector 21A. In other words, the positive electrode current collector 21A is easy to bend, with the position of the leading end T21D-a and the leading end T21D-b serving as a fulcrum. This prevents the bending stress on the undercoat layers 21C-a and 21D-b formed on the two respective opposite surfaces of the positive electrode current collector 21A from being easily transferred, and thus makes it possible to suppress the occurrence of peeling of the undercoat layers 21C-a and 21D-b, for example.

FIG. 19B is an enlarged sectional diagram illustrating a configuration of a part of the positive electrode 21 of Example 4-4-3B applicable to, for example, a battery such as a lithium-ion secondary battery. In the positive electrode 21 of Example 4-4-3B, the position of the leading end T21D-b of the masking layer 21D-b is closer to the leading end T21A of the positive electrode current collector 21A than the position of the leading end T21D-a of the masking layer 21D-a in the W direction. Further, the position of the leading end T21C-a of the undercoat layer 21C-a is closer to the leading end T21A of the positive electrode current collector 21A than the position of the leading end T21C-b of the undercoat layer 21C-b. In this case, the masking layer 21D-b preferably has a thickness smaller than the thickness of the masking layer 21D-a.

In the positive electrode 21 of Example 4-4-3B, a distance between the position of the leading end T21D-b of the masking layer 21D-b and the position of the leading end T21A of the positive electrode current collector 21A is shorter than a distance between the position of the leading end T21D-a of the masking layer 21D-a and the position of the leading end T21A of the positive electrode current collector 21A in the W direction, and the distance M-Hb is shorter than the distance M-Ha. This makes it easy to bend the first end part of the positive electrode current collector 21A. In other words, the positive electrode current collector 21A is easy to bend, with the position of the leading end T21D-a serving as a fulcrum. This prevents the bending stress on the undercoat layers 21C-a and 21D-b formed on the two respective opposite surfaces of the positive electrode current collector 21A from being easily transferred, and thus makes it possible to suppress the occurrence of peeling of the undercoat layers 21C-a and 21D-b, for example.

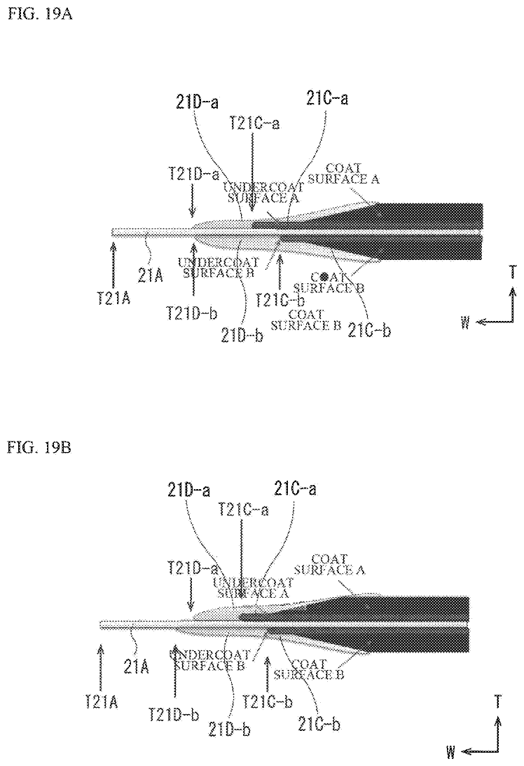

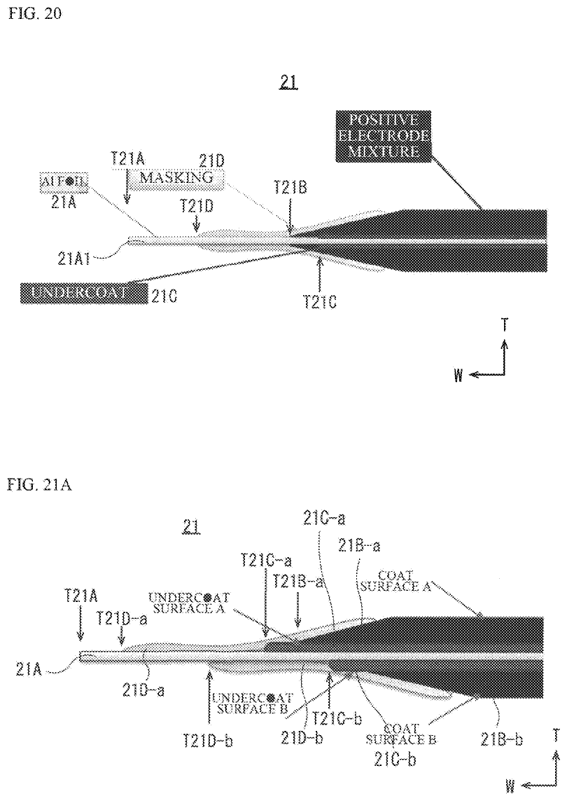

FIG. 20 is an enlarged sectional diagram illustrating a configuration of a part of the positive electrode 21 of Example 4-5 applicable to, for example, a battery such as a lithium-ion secondary battery. As illustrated in FIG. 20, in the positive electrode 21 of Example 4-5, the leading end T21C of the undercoat layer 21C is positioned to be inwardly retracted in the W direction relative to both the position of the leading end T21D of the masking layer 21D and the position of the leading end T21B of the positive electrode active material layer 21B. Accordingly, the undercoat layer 21C is covered with the masking layer 21D and the positive electrode active material layer 21B. The positive electrode 21 of Example 4-5 is otherwise substantially the same in configuration as the positive electrode 21 of Example 4-1 illustrated in FIG. 4-1. Note that in Example 4-5, the position of the leading end T21D of the masking layer 21D is closer to the leading end T21A of the positive electrode current collector 21A in the W direction than the position of the leading end T21B of the positive electrode active material layer 21B.

The positive electrode 21 of Example 4-5 is also provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, in the positive electrode 21 of Example 4-5, the leading end T21C of the undercoat layer 21C is positioned to be retracted relative to the leading end T21B of the positive electrode active material layer 21B. This mitigates a reduction in area density of the end part caused by dripping of the positive electrode active material layer 21B upon application, or mitigates variations in volume density of the positive electrode active material layer 21B resulting from covering with the masking layer 21D. Accordingly, a more uniform battery reaction is expectable.

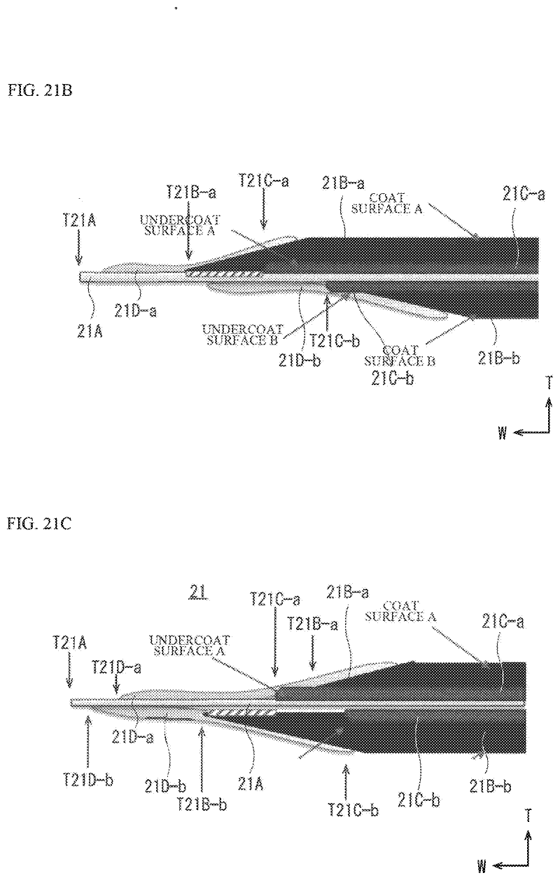

FIG. 21A is an enlarged sectional diagram illustrating a configuration of a part of the positive electrode 21 of Example 4-6A applicable to, for example, a battery such as a lithium-ion secondary battery. As illustrated in FIG. 21A, in the positive electrode 21 of Example 4-6A, positions of formation of the positive electrode active material layers 21B-a and 21B-b are defined in accordance with positions of formation of the undercoat layers 21C-a and 21C-b, respectively. In the W direction, the leading end T21B-a of the positive electrode active material layer 21B-a is set to a position that is more retracted from the leading end T21A of the positive electrode current collector 21A than the position of the leading end T21C-a of the undercoat layer 21C-a formed on a front surface (referred to as the surface A for convenience) of the positive electrode current collector 21A. In the W direction, the leading end T21B-b of the positive electrode active material layer 21B-b is set to a position that is more retracted from the leading end T21A of the positive electrode current collector 21A than the position of the leading end T21C-b of the undercoat layer 21C-b formed on a back surface (referred to as the surface B for convenience) of the positive electrode current collector 21A. Here, as illustrated in FIG. 21A, when the position of the leading end T21C-a is closer to the leading end T21A of the positive electrode current collector 21A than the position of the leading end T21C-b in the W direction, the position of the leading end T21B-a is closer to the leading end T21A of the positive electrode current collector 21A than the position of the leading end T21B-b.

The positive electrode 21 of Example 4-6A is also provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, it is possible to secure stability, in the L direction, of the respective positions of the leading end T21B-a of the positive electrode active material layer 21B-a and the leading end T21B-b of the positive electrode active material layer 21B-b in the W direction, that is, stability, in the L direction, of linearity and area densities of the leading end T21B-a and the leading end T21B-b. Further, it is possible to secure peelability of the undercoat layer 21C.

It is difficult to expect the above-described effect when the position of the leading end T21B-a of the positive electrode active material layer 21B-a is closer to the leading end T21A of the positive electrode current collector 21A than the position of the leading end T21C-a of the undercoat layer 21C-a as illustrated in, for example, FIG. 21B or when the position of the leading end T21B-b of the positive electrode active material layer 21B-b is closer to the leading end T21A of the positive electrode current collector 21A than both the position of the leading end T21C-a of the undercoat layer 21C-a and the position of the leading end T21C-b of the undercoat layer 21C-b as illustrated in, for example, FIG. 21C.

FIG. 22A is a schematic plan diagram illustrating a configuration of a part of the positive electrode 21 of Example 4-7A applicable to, for example, a battery such as a lithium-ion secondary battery. As illustrated in FIG. 22A, in the positive electrode 21 of Example 4-7A, the leading end T21B of the positive electrode active material layer 21B in the W direction extends substantially linearly along the L direction, i.e., the longitudinal direction of the positive electrode 21. In an embodiment, the position of the leading end T21B in the W direction preferably falls within a range of ±50 μm with respect to a reference position.

When the leading end T21B of the positive electrode active material layer 21B in the W direction has high flatness in the L direction as in the positive electrode 21 of Example 4-7A, as compared with when the leading end T21B has irregularities in the L direction as in the positive electrode 21 of Example 4-7B as a reference example illustrated in, for example, FIG. 22B, stress to be exerted on the positive electrode current collector 21A at and in the vicinity of the leading end T21B is prevented from easily concentrating in bending the exposed part, of the positive electrode current collector 21A, that is not covered with the positive electrode active material layer 21B. Accordingly, it is possible to avoid damage to the positive electrode current collector 21A.

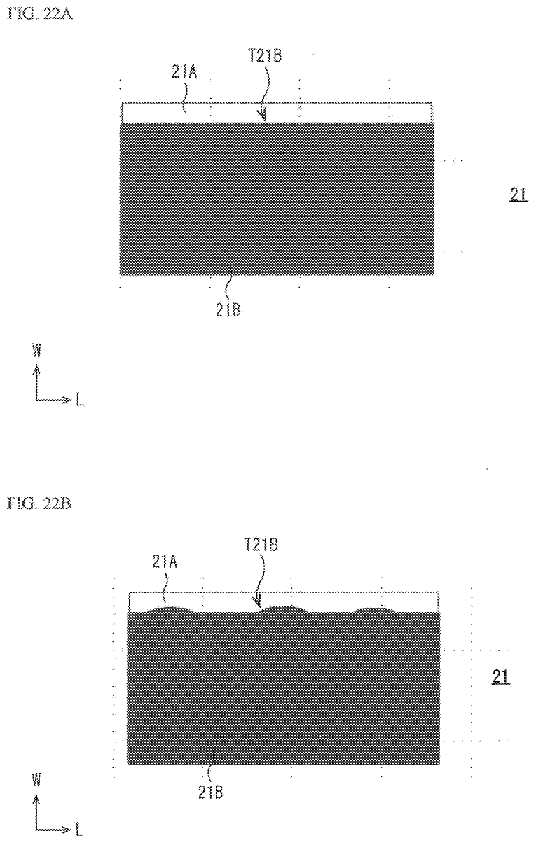

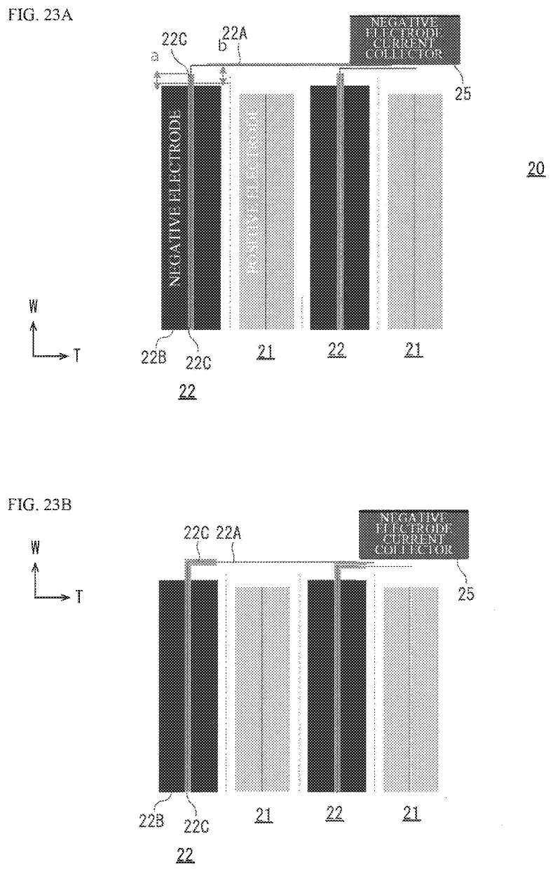

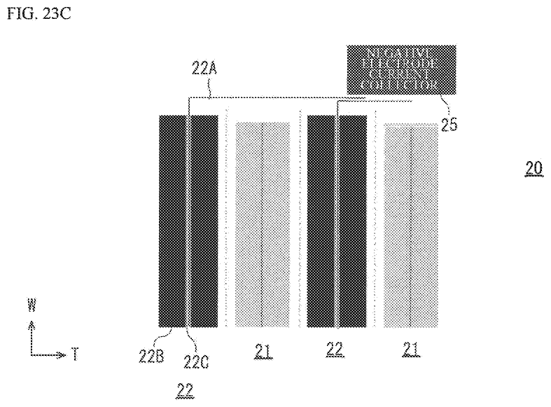

FIG. 23A is a schematic sectional diagram illustrating a configuration of a part of the electrode wound body 20 of Example 4-8A applicable to, for example, a battery such as a lithium-ion secondary battery. As illustrated in FIG. 23A, in the electrode wound body 20 of Example 4-8A, a part of the negative electrode current collector 22A exposed at the end face facing the negative electrode current collector plate 25 is covered with an undercoat layer 22C. In other words, in the end face of the electrode wound body 20 facing the negative electrode current collector plate 25, an edge of the undercoat layer 22C extends toward the negative electrode current collector plate 25 more than an edge of the negative electrode active material layer 22B.

FIG. 23B is a schematic sectional diagram illustrating a configuration of a part of the electrode wound body 20 of Example 4-8B applicable to, for example, a battery such as a lithium-ion secondary battery. As illustrated in FIG. 23B, in the electrode wound body 20 of Example 4-8B also, as with the electrode wound body 20 of Example 4-8A, a part of the negative electrode current collector 22A exposed at the end face facing the negative electrode current collector plate 25 is covered with the undercoat layer 22C. In other words, in the end face of the electrode wound body 20 facing the negative electrode current collector plate 25, the edge of the undercoat layer 22C extends toward the negative electrode current collector plate 25 more than the edge of the negative electrode active material layer 22B. In Example 4-8B, in particular, the undercoat layer 22C extends to a position closer to the negative electrode current collector 25 relative to a position at which the negative electrode current collector 22A is bent.

FIG. 23C is a schematic sectional diagram illustrating a configuration of a part of the electrode wound body 20 of Example 4-8C as a reference example. As illustrated in FIG. 23C, in the electrode wound body 20 of Example 4-8C, the edge of the negative electrode active material layer 22B and the edge of the undercoat layer 22C are coincident with each other in the end face of the electrode wound body 20 facing the negative electrode current collector plate 25.

In the electrode wound body 20 of Example 4-8C, when the negative electrode current collector 22A is welded to the negative electrode current collector plate 25, the negative electrode current collector 22A is stretched due to expansion of the electrode wound body 20. This can cause the negative electrode current collector 22A to suffer damage such as cracking. In the electrode wound body 20 of each of Examples 4-8A and 4-8B, the undercoat layer 22C reinforces the negative electrode current collector 22A, which makes it possible to avoid damage to the negative electrode current collector 22A. The electrode wound body 20 of Example 4-8B is particularly preferable because the negative electrode current collector 22A is further reinforced.

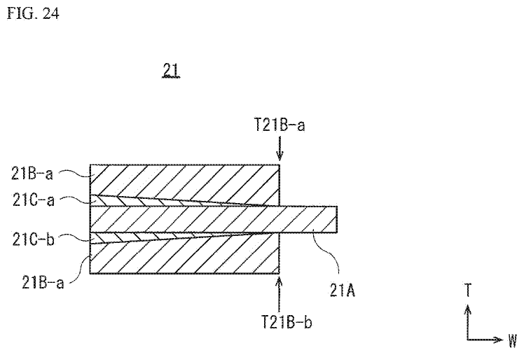

FIG. 24 is an enlarged sectional diagram illustrating a configuration of a part of the positive electrode 21 of Example 4-9 applicable to, for example, a battery such as a lithium-ion secondary battery. As illustrated in FIG. 24, in the positive electrode 21 of Example 4-9, the undercoat layers 21C-a and 21C-b each have a thickness that increases with increasing distance from corresponding one of the positions of the leading ends T21B-a and T21B-b of the positive electrode active material layers 21B in the W direction.

The positive electrode 21 of Example 4-9 is also provided with the undercoat layers 21C-a and 21C-b. This reduces an electrical resistance and thus suppresses heat generation at the time of high-load charging and discharging. Further, the provision of the undercoat layers 21C-a and 21C-b improves heat dissipation performance and thus suppresses heat generation at the time of high-load charging and discharging. Furthermore, in the positive electrode 21 of Example 4-9, the thickness of each of the undercoat layers 21C-a and 21C-b increases with increasing distance from the corresponding one of the positions of the leading ends T21B-a and T21B-b of the positive electrode active material layers 21B, whereas the thickness of each of the positive electrode active material layers 21B-a and 21B-b decreases with increasing distance from corresponding one of the positions of the leading ends T21B-a and T21B-b. This makes it possible to reduce a resistance at a position away from the exposed part of the positive electrode current collector 21A to be welded to the positive electrode current collector plate 24, and thus makes it possible to generate a battery reaction that is more uniform in the W direction.

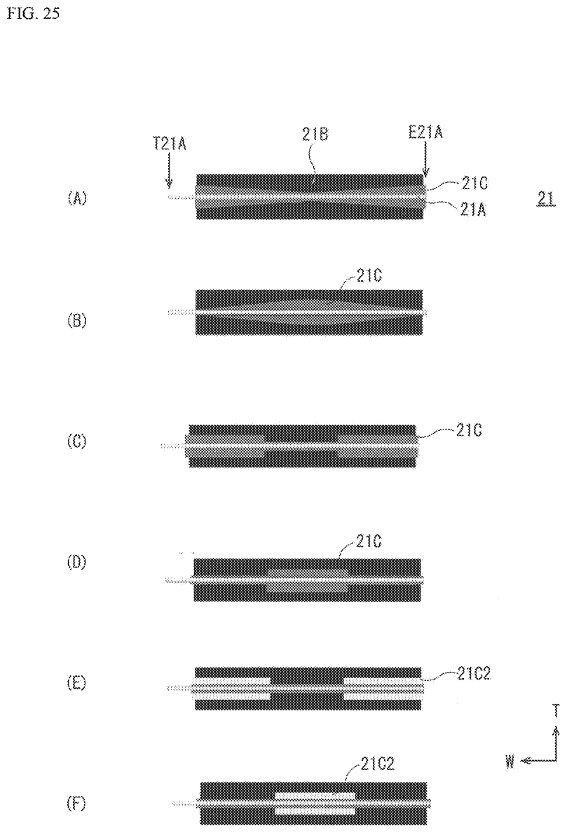

FIG. 25 is an enlarged sectional diagram illustrating a configuration of a part of the positive electrode 21 of each of six Examples 4-10(A) to 4-10(F) applicable to, for example, a battery such as a lithium-ion secondary battery. The positive electrode 21 of each of Examples 4-10(A) to 4-10(F) has a structure in which the undercoat layer 21C and the positive electrode active material layer 21B are stacked in order on each of the two opposite surfaces of the positive electrode current collector 21A. In the positive electrode 21 of each of Examples 4-10(A) to 4-10(F), the positive electrode current collector 21A includes a first edge T21A and a second edge E21A in the W direction, and includes a region that is positioned in the vicinity of the first edge T21A and covered with neither of the undercoat layer 21C and the positive electrode active material layer 21B.

As illustrated in part (A) of FIG. 25, in the positive electrode 21 of Example 4-10(A), the undercoat layer 21C has a thickness that decreases with increasing distance from both the first edge T21A of the positive electrode current collector 21A and the second edge E21A of the positive electrode current collector 21A in the W direction, and that becomes smallest at about a midpoint position between the first edge T21A and the second edge E21A in the W direction.

As illustrated in part (B) of FIG. 25, in the positive electrode 21 of Example 4-10(B), the undercoat layer 21C has a thickness that increases with increasing distance from both the first edge T21A of the positive electrode current collector 21A and the second edge E21A of the positive electrode current collector 21A in the W direction, and that becomes largest at about the midpoint position between the first edge T21A and the second edge E21A.

As illustrated in part (C) of FIG. 25, in the positive electrode 21 of Example 4-10(C), in the W direction, the undercoat layer 21C includes relatively thick parts that are each positioned in the vicinity of corresponding one of the first edge T21A of the positive electrode current collector 21A and the second edge E21A of the positive electrode current collector 21A, and includes a relatively thin part that is positioned at about the midpoint position between the first edge T21A and the second edge E21A.

As illustrated in part (D) of FIG. 25, in the positive electrode 21 of Example 4-10(D), in the W direction, the undercoat layer 21C includes relatively thin parts that are each positioned in the vicinity of corresponding one of the first edge T21A of the positive electrode current collector 21A and the second edge E21A of the positive electrode current collector 21A, and includes a relatively thick part that is positioned at about the midpoint position between the first edge T21A and the second edge E21A.

As illustrated in part (E) of FIG. 25, in the positive electrode 21 of Example 4-10(E), the undercoat layer 21C has a thickness that is substantially constant in the W direction, and another undercoat layer 21C2 is selectively provided on the undercoat layer 21C in each of a region in the vicinity of the first edge T21A of the positive electrode current collector 21A and a region in the vicinity of the second edge E21A of the positive electrode current collector 21A. The undercoat layers 21C and 21C2 have respective compositions different from each other. For example, in the undercoat layer 21C, a proportion of a binder to the entire undercoat layer 21C is 1%, whereas in the undercoat layer 21C2, a proportion of the binder to the entire undercoat layer 21C2 is 0.5%. For the undercoat layer 21C in contact with the positive electrode current collector 21A, the proportion of the binder is preferably set to a value sufficient for achieving adhesion of the positive electrode current collector 21A, whereas for the undercoat layer 21C2, the proportion of the binder is made lower than in the undercoat layer 21C in order to reduce a resistance in the thickness direction. The undercoat layer 21C, which is in contact with the positive electrode current collector 21A, preferably includes an electrically conductive material having a powdery shape, such as acetylene black, in order to reduce a resistance in a plane direction. The undercoat layer 21C2 preferably includes an electrically conductive material having a fibrous shape, such as carbon nanotubes, in order to form an electrically conductive path in the thickness direction.

As illustrated in part (F) of FIG. 25, in the positive electrode 21 of Example 4-10(F), the undercoat layer 21C has a thickness that is substantially constant in the W direction, and the other undercoat layer 21C2 is selectively provided on the undercoat layer 21C in a middle region in the W direction.

In a battery including the electrode wound body 20 to which the positive electrode 21 of any of Examples 4-10(A) to 4-10(F) described above is applied, current collector parts are disposed at two respective opposite end parts in the W direction. In the electrode wound body 20, current collection efficiency is high at locations near the current collector parts, and the current collection efficiency decreases with increasing distance from each of the current collector parts. Accordingly, when the undercoat layer 21C has a larger thickness in each of the two opposite end regions near the current collector parts than in the middle region away from each of the current collector parts, as in the positive electrode 21 of Example 4-10(A) and the positive electrode 21 of Example 4-10(C), it is possible to reduce variations in current collection efficiency in the W direction, as compared with when the undercoat layer 21C has a larger thickness in the middle region away from each of the current collector parts than in each of the two opposite end regions near the current collector parts, as in the positive electrode 21 of Example 4-10(B) and the positive electrode 21 of Example 4-10(D). As a result, it is possible to suppress a decrease in capacity during charging and discharging cycles, and to achieve uniformity of heat generation during use under a high load. This makes it possible to suppress degradation of the battery. In the positive electrode 21 of Example 4-10(A), the undercoat layer 21C including a part with a sloped thickness is formable by changing an application amount gradually in the W direction, for example. The undercoat layer 21C having a relatively large thickness in each of the two opposite end regions as compared with the thickness in the middle region in the W direction, as in the positive electrode 21 of Example 4-10(C), is formable by applying the undercoat layer of a constant thickness over the entire region and thereafter applying an additional undercoat layer selectively on each of the two opposite end regions only, for example.

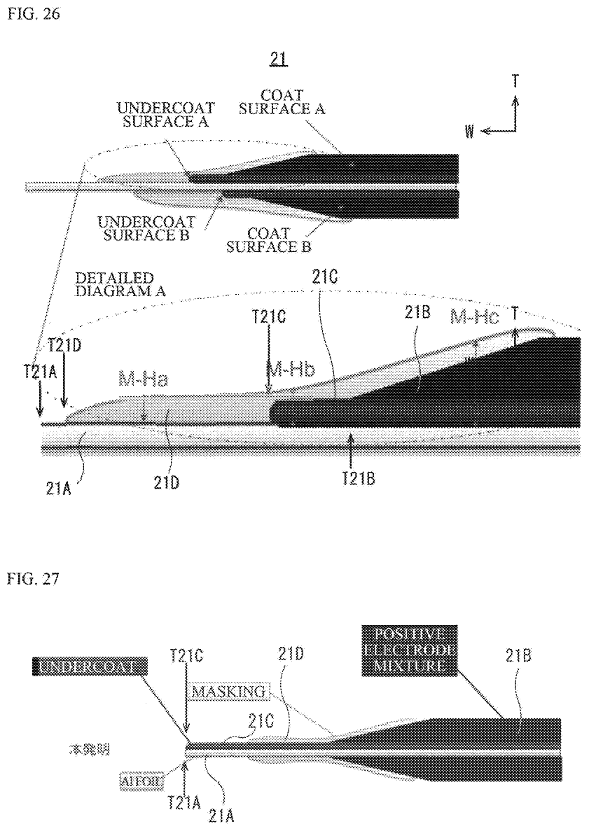

FIG. 26 is an enlarged sectional diagram illustrating a configuration of a part of the positive electrode 21 of Example 4-11 applicable to, for example, a battery such as a lithium-ion secondary battery. As illustrated in FIG. 26, in the positive electrode 21 of Example 4-11, the leading end T21D of the masking layer 21D is positioned between the position of the leading end T21A of the positive electrode current collector 21A and the position of the leading end T21C of the undercoat layer 21C in the W direction. Further, in the W direction, the leading end T21C of the undercoat layer 21C is positioned between the position of the leading end T21D of the masking layer 21D and the position of the leading end T21B of the positive electrode active material layer 21B. Here, a thickness M-Ha of a part, of the masking layer 21D, that directly covers the positive electrode current collector 21A is smaller than a total thickness M-Hb of a part, of the masking layer 21D, covering the undercoat layer 21C and the undercoat layer 21C. Further, the thickness M-Hb is smaller than a total thickness M-Hc of a part, of the masking layer 21D, covering both the undercoat layer 21C and the positive electrode active material layer 21B, the undercoat layer 21C, and the positive electrode active material layer 21B.

The positive electrode 21 of the Example 4-11 is provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, it is possible to protect the undercoat layer 21C with the masking layer 21D. Further, owing to the masking layer 21D covering the leading end T21B of the positive electrode active material layer 21B and the vicinity of the leading end T21B, it is possible to prevent detachment of the positive electrode active material layer 21B. Further, owing to a portion of the exposed part of the positive electrode current collector 21A being directly covered with the masking layer 21D, it is possible to prevent winding displacement of the electrode wound body 20.

In the positive electrode 21 of each of Examples 4-1 to 4-11 described above, a surface density (or thickness) of the undercoat layer 21C-a to be formed on the surface A of the positive electrode current collector 21A and a surface density (or thickness) of the undercoat layer 21C-b to be formed on the surface B of the positive electrode current collector 21A may be different from each other. For example, in a part, of the electrode wound body 20, that is positioned at a winding center part and that is bent at a high curvature, the positive electrode active material layer 21B provided on the surface of the positive electrode current collector 21A on the winding center side becomes large in thickness. Accordingly, the surface density (or thickness) of the undercoat layer 21C may be increased in such a part. This reduces a resistance, adjusts a potential distribution, and allows for uniform distribution of heat generation. As a result, a longer life is expectable.

FIG. 27 is an enlarged sectional diagram illustrating a configuration of a part of the positive electrode 21 of Example 4-13 applicable to, for example, a battery such as a lithium-ion secondary battery. As illustrated in FIG. 27, in the positive electrode 21 of Example 4-13, the undercoat layer 21C is provided only on one of the two opposite surfaces (e.g., the surface on the winding center side of the electrode wound body 20) of the positive electrode current collector 21A. Another of the two opposite surfaces, of the positive electrode current collector 21A, on which no undercoat layer 21C is provided is welded to the positive electrode current collector plate 24. In the W direction, the position of the leading end T21C of the undercoat layer 21C may be substantially coincident with the position of the leading end T21A of the positive electrode current collector 21A, for example. Further, in the W direction, the leading end T21D of the masking layer 21D is positioned to be retracted relative to the position of the leading end T21A of the positive electrode current collector 21A and the position of the leading end T21C of the undercoat layer 21C. Further, in the W direction, the leading end T21D of the masking layer 21D is positioned between the positions of the leading end T21C of the undercoat layer 21C and the leading end T21B of the positive electrode active material layer 21B, for example. The undercoat layer 21C includes small-particle carbon, for example.

If any damage is present on the surface, of the positive electrode current collector 21A, on the winding center side of the electrode wound body 20, the positive electrode current collector 21A is easily cracked during fabrication of the electrode wound body 20 or during charging and discharging cycles after completion of the electrode wound body 20. To address this, the undercoat layer 21C including a material such as small-particle carbon may be provided. This reduces concentration of stress caused by large particles of the active material included in the positive electrode active material layer 21B upon pressing, and thereby prevents the positive electrode current collector 21A from being easily cracked or broken. Note that in the positive electrode 21 of Example 4-13, the undercoat layer 21C may be applied over an entire region of one of the two opposite surface of the positive electrode current collector 21A, that is, the undercoat layer 21C does not necessarily have to be patterned.

FIG. 28A is an enlarged sectional diagram illustrating a configuration of a part of the positive electrode 21 of Example 4-14 applicable to, for example, a battery such as a lithium-ion secondary battery. Specifically, FIG. 28A is an image obtained by observing, at a 2000-fold magnification with an electron microscope, a 3 mm×3 mm section of the positive electrode 21 of Example 4-14 produced by cutting the positive electrode 21 with a razor blade or an ion milling apparatus. The section includes interfaces between the positive electrode current collector 21A, the undercoat layer 21C, and the positive electrode active material layer 21B. Note that the positive electrode 21 illustrated in FIG. 28A has a volume density of 3.0 g/cm³ or more. Here, when observation is made at three locations with a field of view of 60 μm×40 μm on the image presented in FIG. 28A, a ratio of a length CL of a location where the positive electrode active material layer 21B is in direct contact with the positive electrode current collector 21A to a length FL of the positive electrode current collector 21A, i.e., FL/CL, is preferably 20% or less.

Techniques to suppress the interface resistance between the positive electrode current collector 21A and the positive electrode active material layer 21B include a technique in which the undercoat layer 21C is used that is formed by applying a carbon material. FIG. 28B is a characteristic diagram illustrating a relation between the presence or absence of the undercoat layer 21C and the interface resistance between the positive electrode current collector 21A and the positive electrode active material layer 21B. As indicated in FIG. 28B, the presence of the undercoat layer 21C results in a decreased interface resistance and a decreased mixture resistance. It is therefore desirable that the undercoat layer 21C be interposed between the positive electrode current collector 21A and the positive electrode active material layer 21B, rather than the positive electrode current collector 21A and the positive electrode active material layer 21B being in direct contact with each other. However, in some cases, depending on a compression condition at the time of pressing when fabricating the positive electrode 21, the positive electrode active material layer 21B can penetrate the undercoat layer 21C and come into contact with the positive electrode current collector 21A. In such a case, the interface resistance and the mixture resistance increase. It is therefore desirable that FL/CL indicating a rate at which the positive electrode active material layer 21B penetrates the undercoat layer 21C and comes into contact with the positive electrode current collector 21A be 20% or less. If FL/CL is 20% or less, an effect of reducing the interface resistance and an effect of reducing the mixture resistance are sufficiently expectable.

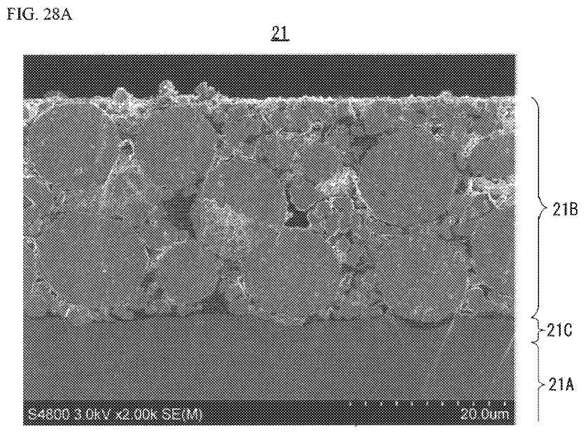

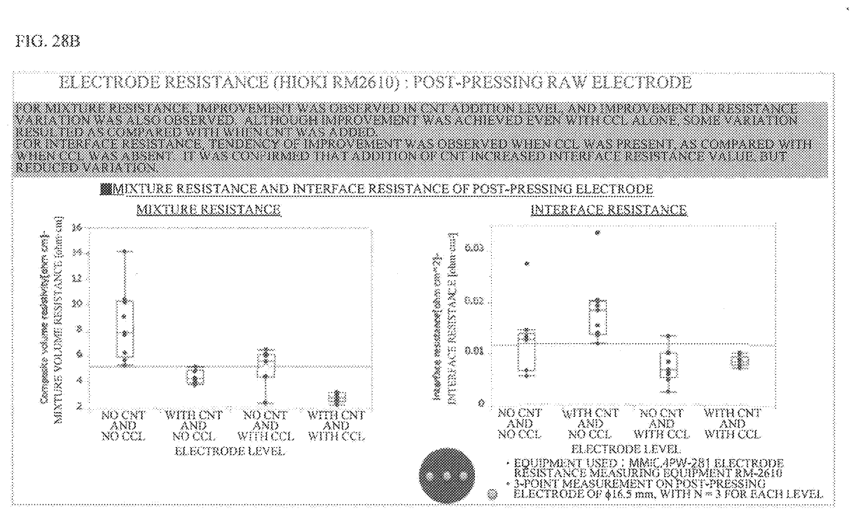

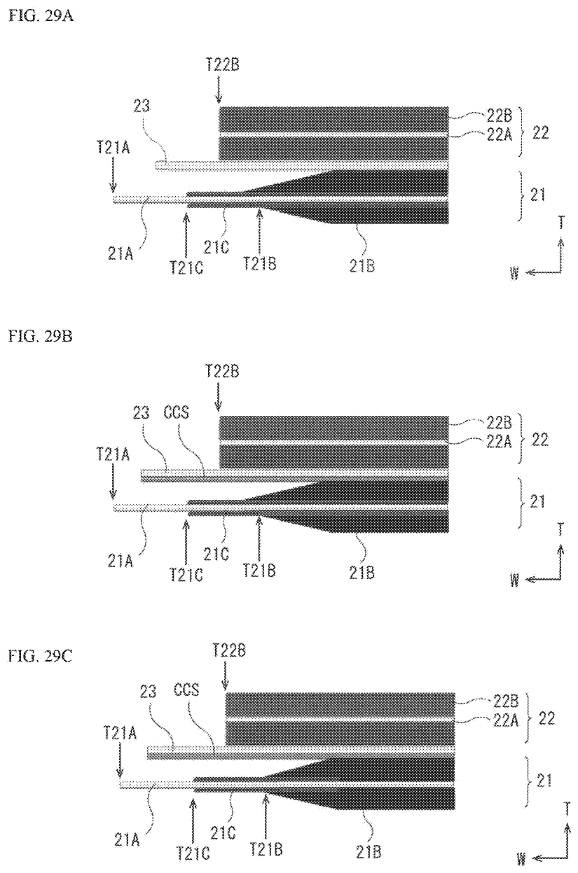

FIG. 29A is an enlarged sectional diagram illustrating a configuration of a part of the electrode wound body 20 of Example 4-15-1 applicable to, for example, a battery such as a lithium-ion secondary battery. As illustrated in FIG. 29A, in the electrode wound body 20 of Example 4-15-1, the positive electrode 21 includes the positive electrode current collector 21A, the undercoat layer 21C provided on each of the two opposite surfaces of the positive electrode current collector 21A, and the positive electrode active material layer 21B provided on the undercoat layer 21C, and includes no masking layer. A part of the positive electrode current collector 21A is covered with neither of the undercoat layer 21C and the positive electrode active material layer 21B, and is thus in an exposed state. In other words, in the W direction, the leading end T21C of the undercoat layer 21C is at a position retracted relative to the position of the leading end T21A of the positive electrode current collector 21A. Further, in the W direction, the leading end T21B of the positive electrode active material layer 21B is at a position retracted relative to the position of the leading end T21C. Further, the negative electrode 22 is provided on an opposite side to the positive electrode 21 with the separator 23 interposed therebetween in the T direction. In the negative electrode 22, the negative electrode active material layer 22B is provided on each of the two opposite surfaces of the negative electrode current collector 22A. In the W direction, a leading end T22B of the negative electrode active material layer 22B is at a position between the position of the leading end T21C and the position of the leading end T21B.

FIG. 29B is an enlarged sectional diagram illustrating a configuration of a part of the electrode wound body 20 of Example 4-15-2 applicable to, for example, a battery such as a lithium-ion secondary battery. In the electrode wound body 20 of Example 4-15-2 illustrated in FIG. 29B, a ceramic coat layer CCS is provided on a surface, of the separator 23, that is opposed to the positive electrode 21. The electrode wound body 20 of Example 4-15-2 is otherwise substantially the same in configuration as the electrode wound body 20 of Example 4-15-1.

FIG. 29C is an enlarged sectional diagram illustrating a configuration of a part of the electrode wound body 20 of Example 4-15-3 applicable to, for example, a battery such as a lithium-ion secondary battery. In the electrode wound body 20 of Example 4-15-3 illustrated in FIG. 29C, the undercoat layer 21C is provided only in a region including the leading end T21B of the positive electrode active material layer 21B and the vicinity of the leading end T21B. The electrode wound body 20 of Example 4-15-3 is otherwise substantially the same in configuration as the electrode wound body 20 of Example 4-15-2.

The positive electrode 21 of each of Examples 4-15-1 to 4-15-3 is provided with the undercoat layer 21C. This reduces an electrical resistance and thus suppresses heat generation at the time of high-load charging and discharging. Further, the provision of the undercoat layer 21C improves heat dissipation performance and thus suppresses heat generation at the time of high-load charging and discharging. Furthermore, owing to no masking layer being provided to cover the undercoat layer 21C or the positive electrode active material layer 21B, this configuration is suitable for improving energy density and also simplifies the manufacturing process, as compared with a case with the masking layer.

Part (A) of FIG. 30 is an enlarged sectional diagram illustrating a configuration of the positive electrode 21 of Example 4-16 applicable to, for example, a battery such as a lithium-ion secondary battery. Part (B) of FIG. 30 is a schematic plan diagram illustrating the configuration of the positive electrode 21 of Example 4-16. In the positive electrode 21 of Example 4-16, a laser absorption rate of the undercoat layer 21C is higher than a laser absorption rate of the positive electrode current collector 21A. In a region, of the positive electrode current collector 21A, that is covered with the undercoat layer 21C and not covered with the positive electrode active material layer 21B, multiple locations indicated by arrows are cut by laser irradiation.

By covering the positive electrode current collector 21A with the undercoat layer 21C having a high laser absorption rate before subjecting the positive electrode current collector 21A to processing, it is possible to suppress deterioration and deformation of the positive electrode current collector 21A caused by heat generated upon a laser cutting process. As a result, it is possible to efficiently carry out the laser cutting process.

FIG. 31 is a schematic diagram illustrating positive electrode active material particles 21BP and polyvinylidene difluoride (PVdF) included in the positive electrode active material layer 21B of Example 5-1 applicable to, for example, a battery such as a lithium-ion secondary battery. PVdF has been caused to be porous by means of phase separation upon drying. This is achieved by adding N-methyl-2-pyrrolidone (NMP) and triethylene glycol (TEG) to PVdF, for example. Triethylene glycol (TEG) serves as a poor solvent.

The positive electrode active material layer 21B of Example 5-1 achieves improved flexibility by causing PVdF to be porous. This allows for an increase in thickness of the positive electrode active material layer 21B. In other words, the positive electrode active material layer 21B has high flexibility even if the thickness of the positive electrode active material layer 21B is increased, and this allows for a smooth winding operation when fabricating the electrode wound body 20. Further, causing the PVdF to be porous secures pathways for lithium ions in the positive electrode active material layer 21B. Accordingly, it is possible to reduce an ionic resistance of the electrode wound body 20, and a further higher output is thus expectable.

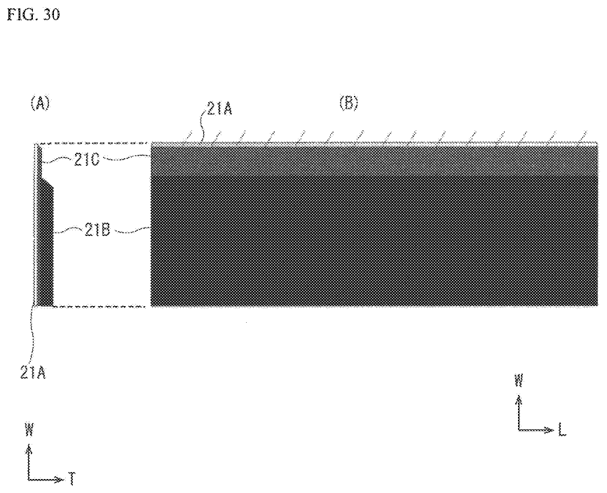

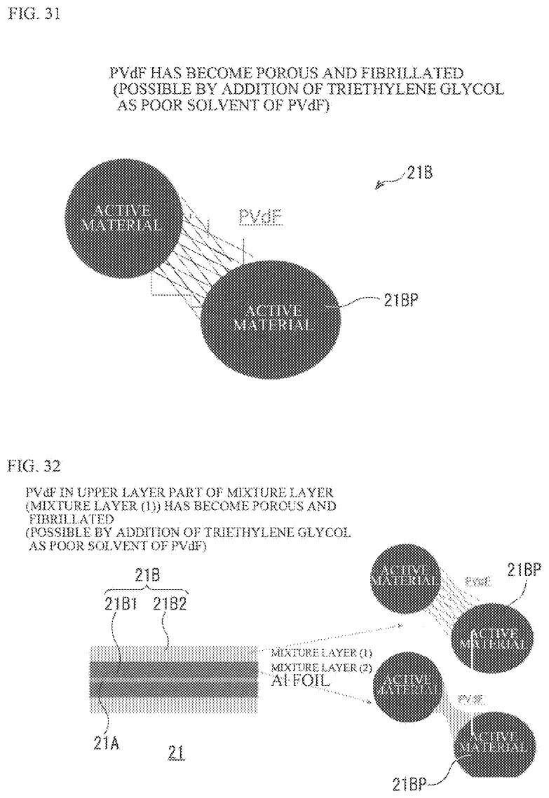

FIG. 32 is a schematic diagram illustrating the positive electrode 21 of Example 5-2 applicable to, for example, a battery such as a lithium-ion secondary battery, and illustrating the positive electrode active material particles 21BP and polyvinylidene difluoride (PVdF) included in the positive electrode active material layer 21B. As illustrated in FIG. 32, the positive electrode 21 of Example 5-2 includes the positive electrode current collector 21A, and the positive electrode active material layer 21B provided on each of the two opposite surfaces of the positive electrode current collector 21A. The positive electrode active material layer 21B includes a first region 21B1 and a second region 21B2 positioned in order from a side of the positive electrode current collector 21A.

The first region 21B1 includes multiple positive electrode active material particles 21BP coupled to each other via PVdF in gel form. The second region 21B2 includes multiple positive electrode active material particles 21BP coupled to each other via PVdF that has become porous.

In the positive electrode active material layer 21B of Example 5-2, the second region 21B2 includes porous PVdF, which allows the positive electrode active material layer 21B to have high flexibility. This allows for an increase in thickness of the positive electrode active material layer 21B. In other words, the positive electrode active material layer 21B has high flexibility even if the thickness of the positive electrode active material layer 21B is increased, and this allows for a smooth winding operation when fabricating the electrode wound body 20. Further, causing the PVdF to be porous secures pathways for lithium ions in the second region 21B2. Accordingly, it is possible to reduce an ionic resistance of the electrode wound body 20, and a further higher output is thus expectable. In addition, the first region 21B1 includes PVdF that is in gel form and not porous. This makes it possible to achieve high strength of binding between the first region 21B1 and the positive electrode current collector 21A, and thus makes it possible to avoid peeling or detachment of the positive electrode active material layer 21B from the positive electrode current collector 21A.

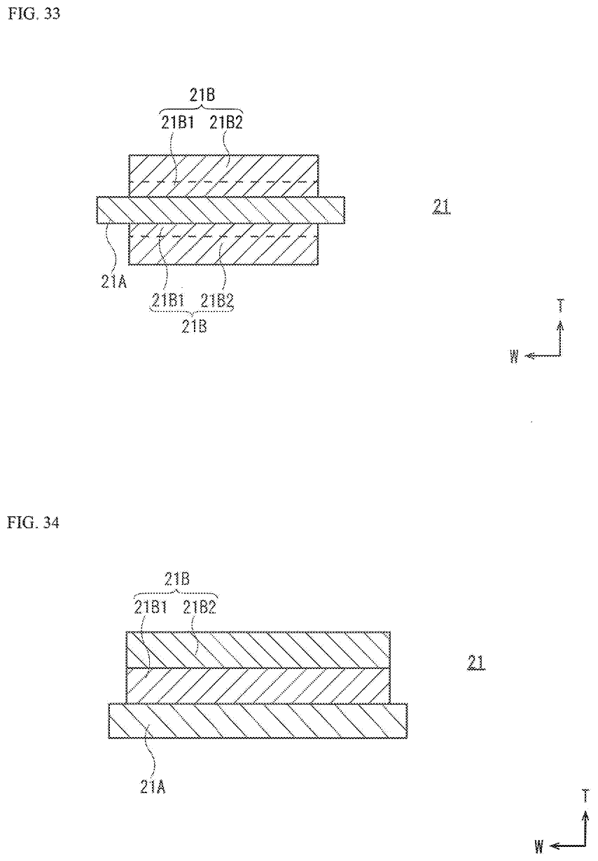

FIG. 33 is a schematic sectional diagram illustrating the positive electrode 21 of Example 5-3 applicable to, for example, a battery such as a lithium-ion secondary battery. As illustrated in FIG. 33, the positive electrode 21 of Example 5-3 includes the positive electrode current collector 21A, and the positive electrode active material layer 21B provided on each of the two opposite surfaces of the positive electrode current collector 21A. The positive electrode active material layer 21B includes the first region 21B1 and the second region 21B2 positioned in order from the side of the positive electrode current collector 21A.

Here, a proportion of the binder, such as PVdF, included in the second region 21B2 is higher than a proportion of the binder, such as PVdF, included in the first region 21B1.

In the positive electrode active material layer 21B of Example 5-3, the second region 21B2 positioned at the surface of the positive electrode 21 is made higher in content rate of the binder relative to the positive electrode active material. The surface of the positive electrode 21 is a location where stress tends to concentrate when winding is performed to fabricate the electrode wound body 20, for example. Increasing the proportion of the binder at and in the vicinity of the surface of the positive electrode 21 allows for effective prevention of an occurrence of cracking in the positive electrode active material layer 21B. Further, this makes it possible to reduce the binder content as compared with when a large amount of binder is uniformly dispersed over the entire positive electrode active material layer 21B.

FIG. 34 is a schematic sectional diagram illustrating the positive electrode 21 of Example 5-4 applicable to, for example, a battery such as a lithium-ion secondary battery. As illustrated in FIG. 34, the positive electrode 21 of Example 5-4 includes the positive electrode current collector 21A, and the positive electrode active material layer 21B provided on the surface of the positive electrode current collector 21A. The positive electrode active material layer 21B includes the first region 21B1 and the second region 21B2 positioned in order from the side of the positive electrode current collector 21A.

Here, the proportion of the binder, such as PVdF, included in the first region 21B1 is higher than the proportion of the binder, such as PVdF, included in the second region 21B2.

In the positive electrode active material layer 21B of Example 5-4, the proportion of the binder in the first region 21B1 adjacent to the positive electrode current collector 21A is set to be higher than the proportion of the binder in the second region 21B2. This makes it possible to enhance adhesion between the positive electrode current collector 21A and the positive electrode active material layer 21B, and to thereby prevent the positive electrode active material layer 21B from easily peeling away from the positive electrode current collector 21A. In other words, it is possible to enhance resistance-to-peel strength of the positive electrode active material layer 21B. As a result, an improvement in load characteristic is expectable. Further, it is possible to reduce the binder content as compared with when a large amount of binder is uniformly dispersed over the entire positive electrode active material layer 21B.

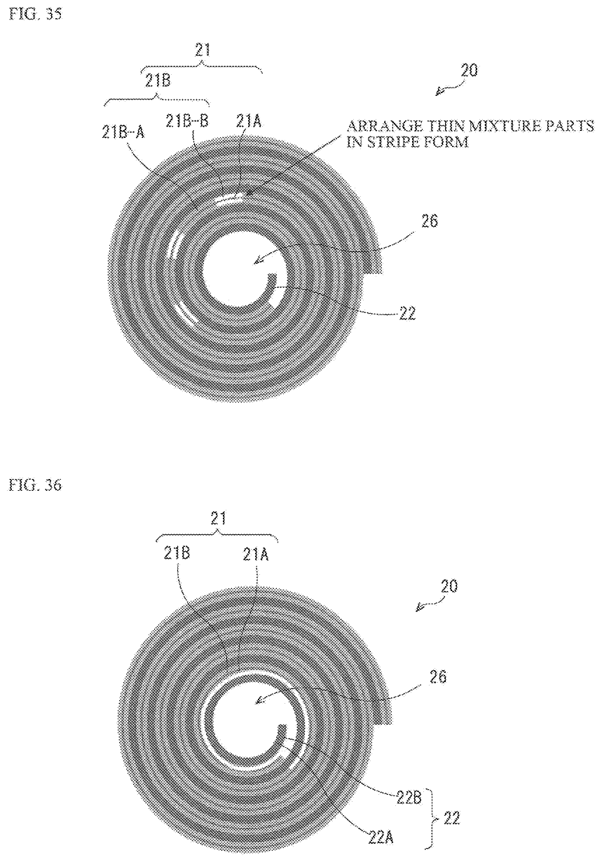

FIG. 35 is a schematic sectional diagram illustrating the electrode wound body 20 of Example 5-5 applicable to, for example, a battery such as a lithium-ion secondary battery. As illustrated in FIG. 35, the electrode wound body 20 of Example 5-5 corresponds to a stacked structure that is wound. In the stacked structure, the positive electrode 21 and the negative electrode 22 are stacked with the separator interposed therebetween. The negative electrode 22 is present in an innermost wind of the electrode wound body 20. The positive electrode 21 includes the positive electrode current collector 21A, and the positive electrode active material layer 21B provided on each of the two opposite surfaces of the positive electrode current collector 21A. Here, the positive electrode active material layer 21B has a location where a thick part 21B-A having a relatively large thickness and a thin part 21B-B having a relatively small thickness are alternately arranged in the winding direction. The thin part 21B-B is positioned in a part of the electrode wound body 20 other than an outermost wind, and extends in the width direction orthogonal to the winding direction, for example.

The positive electrode active material layer 21B of Example 5-5 is provided with the thin part 21B-B. This makes it possible to reduce expansion of the electrode wound body 20 resulting from expansion of the negative electrode 22 at the time of charging. As a result, it is possible to avoid buckling of a part of the positive electrode 21 toward the through hole 26 positioned at a center of the electrode wound body 20.

FIG. 36 is a schematic sectional diagram illustrating the electrode wound body 20 of Example 5-6 applicable to, for example, a battery such as a lithium-ion secondary battery. As illustrated in FIG. 36, the electrode wound body 20 of Example 5-6 corresponds to a stacked structure that is wound. In the stacked structure, the positive electrode 21 and the negative electrode 22 are stacked with the separator interposed therebetween. The negative electrode 22 is present in the innermost wind of the electrode wound body 20. Here, no positive electrode active material layer 21B is provided in an innermost wind part of the positive electrode 21 opposed to the negative electrode active material layer 22B in an innermost wind part of the negative electrode 22. In other words, the negative electrode active material layer 22B in the innermost wind part of the negative electrode 22 is opposed to the positive electrode current collector 21A of the positive electrode 21 positioned on an outer side thereof.

According to the positive electrode active material layer 21B of Example 5-6, the positive electrode active material layer 21B is not provided in the innermost wind part of the positive electrode 21 opposed to the negative electrode active material layer 22B in the innermost wind part of the negative electrode 22. This makes it possible to suppress expansion of the innermost wind part of the negative electrode 22 during charging. As a result, it is possible to avoid buckling of a part of the positive electrode 21 toward the through hole 26 positioned at the center of the electrode wound body 20.

FIG. 37A is a schematic sectional diagram illustrating the positive electrode 21 of Example 5-7-1 applicable to, for example, a battery such as a lithium-ion secondary battery. As illustrated in FIG. 37A, the positive electrode 21 of Example 5-7-1 includes the positive electrode current collector 21A, the positive electrode active material layer 21B provided on the surface of the positive electrode current collector 21A, and an insulating layer 21Z. In the L direction, the positive electrode current collector 21A and the positive electrode active material layer 21B each extend from the winding center side edge 21E1 of the positive electrode 21 to the winding outer periphery side edge 21E2 of the positive electrode 21. In other words, in the L direction, a position of an end T21B1 of the positive electrode active material layer 21B coincides with a position of an end T21A1 of the positive electrode current collector 21A, and a position of an end T21B2 of the positive electrode active material layer 21B coincides with a position of an end T21A2 of the positive electrode current collector 21A. The insulating layer 21Z covers a region of the positive electrode active material layer 21B from the end T21B1 to a point in the vicinity of the end T21B1 and a region of the positive electrode active material layer 21B from the end T21B2 to a point in the vicinity of the end T21B2. Note that, as in the positive electrode 21 of Example 5-7-2 illustrated in FIG. 37B, the insulating layer 21Z may be provided to protrude relative to the winding center side edge 21E1 in the L direction or may be provided to protrude relative to the winding outer periphery side edge 21E2 in the L direction. Further, a part of the insulating layer 21Z may penetrate into the positive electrode active material layer 21B.

The positive electrodes 21 of Examples 5-7-1 and 5-7-2 are each provided with the insulating layer 21Z. This makes it possible to protect the region of the positive electrode active material layer 21B from the end T21B1 to the point in the vicinity of the end T21B1 and the region of the positive electrode active material layer 21B from the end T21B2 to the point in the vicinity of the end T21B2. Providing the insulating layer 21Z makes it possible to suppress coming-off of the positive electrode active material in the region of the positive electrode active material layer 21B from the end T21B1 to the point in the vicinity of the end T21B1 and the region of the positive electrode active material layer 21B from the end T21B2 to the point in the vicinity of the end T21B2, which in turn makes it possible to suppress generation of dust derived from the positive electrode 21. As a result, a reduction in open circuit voltage (OCV) defect rate and suppression of an occurrence of a short circuit during storage are expectable.

Further, the insulating layer 21Z serves as a cushioning material and thus reduces stress on the separator 23 caused by expansion and contraction of the electrode wound body 20 associated with charging and discharging cycles. Furthermore, the insulating layer 21Z serving as a cushioning material makes it is possible to reduce friction between the positive electrode 21 and the separator 23 caused by the expansion and contraction of the electrode wound body 20 associated with charging and discharging cycles, to prevent coming-off of the positive electrode active material from the positive electrode active material layer 21B, and to thereby avoid an unintended exposure of the positive electrode current collector 21A. As a result, the insulating layer 21Z serves as a cushioning material and an insulating material, which makes it possible to effectively suppress the occurrence of a short circuit during charging and discharging cycles.

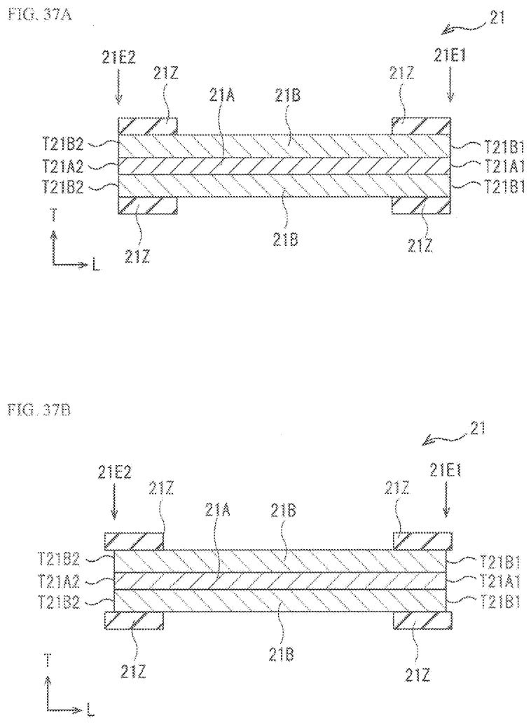

FIG. 38A is a schematic sectional diagram illustrating the electrode wound body 20 of Example 5-8 applicable to, for example, a battery such as a lithium-ion secondary battery. The electrode wound body 20 of Example 5-8 corresponds to a stacked structure that is wound. In the stacked structure, the positive electrode 21 and the negative electrode 22 are stacked with the separator interposed therebetween. As illustrated in FIG. 38A, in the innermost wind part of the positive electrode 21 of the electrode wound body 20 of Example 5-8, the positive electrode current collector 21A in a state of not being covered with the positive electrode active material layer 21B is wound into at least one or more winds. FIG. 38B is a plan view of the positive electrode 21 of the electrode wound body 20 of Example 5-8 in an unwound state. As illustrated in FIG. 38B, the positive electrode 21 includes, in a region including an upper edge in the W direction and the vicinity thereof, an exposed part in which a part of the positive electrode current collector 21A is exposed without being covered with the positive electrode active material layer 21B. In the positive electrode 21, an insulating layer 21D is provided to straddle a border K-W in the W direction between the exposed part of the positive electrode current collector 21A and a covered part in which the positive electrode active material layer 21B covers a positive electrode exposed part. Further, the positive electrode 21 includes, in a region including the winding center side edge 21E1 in the L direction and the vicinity thereof, an exposed part in which a part of the positive electrode current collector 21A is exposed without being covered with the positive electrode active material layer 21B. In the positive electrode 21, an insulating layer 21F is provided to straddle a border K-L in the L direction between the exposed part of the positive electrode current collector 21A and a covered part covered with the positive electrode active material layer 21B. Here, in the W direction, a leading end T21F of the insulating layer 21F is positioned between the position of the leading end T21A of the positive electrode current collector 21A and the position of the leading end T21B of the positive electrode active material layer 21B. Further, in the W direction, the insulating layer 21D is provided at an inwardly retracted position relative to the position of the leading end T21A of the positive electrode current collector 21A. In other words, the insulating layer 21F and the insulating layer 21D are each provided at a position away from the position of the leading end T21A of the positive electrode current collector 21A in the W direction. A region, of the positive electrode 21, including the winding outer periphery side edge 21E2 and the vicinity thereof in the L direction may also have a structure the same as the above-described structure of the region, of the positive electrode 21, including the winding center side edge 21E1 and the vicinity thereof in the L direction. The insulating layer 21F and the insulating layer 21D may be, for example, tapes each including an insulating material and attached to the positive electrode current collector 21A and the positive electrode active material layer 21B, or may be coating layers formed by applying an insulating material to cover the border K-W and the vicinity thereof and the border K-L and the vicinity thereof.

In the positive electrode 21 of Example 5-8, only the positive electrode current collector 21A, of the positive electrode 21, is wound into one or more winds in an innermost wind part of the electrode wound body 20. Accordingly, an inner diameter of the electrode wound body 20 increases at a location where the positive electrode active material layer 21B is provided. This reduces stress applied to the positive electrode active material layer 21B due to expansion of the negative electrode 22 during charging and discharging cycles, for example. As a result, damage to the positive electrode active material layer 21B, such as cracking, is avoided. Further, it is possible to suppress an occurrence of buckling in the innermost wind part of the positive electrode 21, which makes it possible to avoid an internal short circuit. Furthermore, the insulating layer 21F and the insulating layer 21D are each provided at a position away from the position of the leading end T21A of the positive electrode current collector 21A in the W direction. Accordingly, the positive electrode current collector 21A and the positive electrode current collector plate are favorably so joined to each other as to be electrically continuous with each other.

FIG. 39 is a schematic sectional diagram illustrating the electrode wound body 20 of Example 5-9 applicable to, for example, a battery such as a lithium-ion secondary battery. In the electrode wound body 20 of Example 5-9, in the innermost wind part of the positive electrode 21, an outer surface of the positive electrode current collector 21A is covered with the insulating layer 21D in a region from a winding start end to a distance of 3.6 mm. The insulating layer 21F and the insulating layer 21D may be, for example, tapes each including an insulating material and attached to the positive electrode current collector 21A and the positive electrode active material layer 21B, or may be coating layers formed by applying an insulating material to cover the border K-W and the vicinity thereof and the border K-L and the vicinity thereof.

According to the positive electrode 21 of Example 5-9, when, for example, the electrode wound body 20 is fabricated by winding the stacked structure including the positive electrode 21 and the negative electrode 22, the insulating layer 21D makes it possible to suppress detachment of the positive electrode active material layer 21B even if the positive electrode active material layer 21B suffers cracking or other damage. As a result, it is possible to achieve the positive electrode active material layer 21B having a high in-plane density.

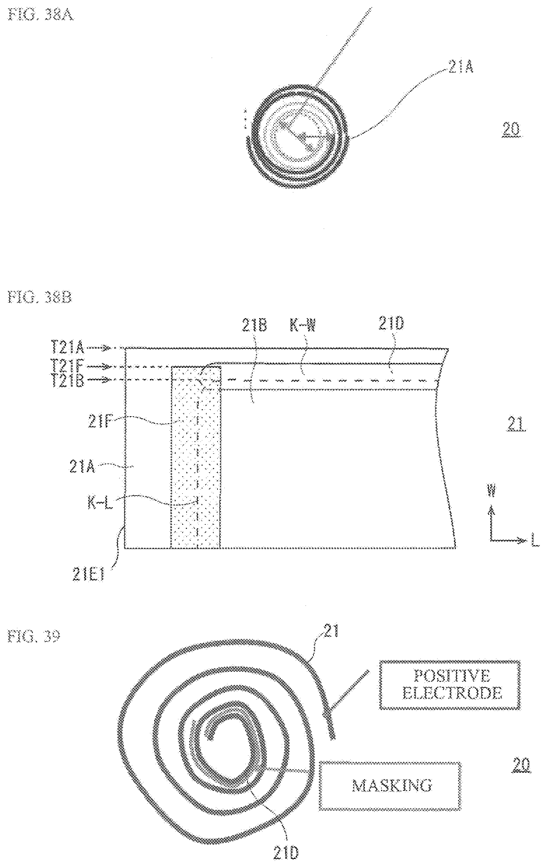

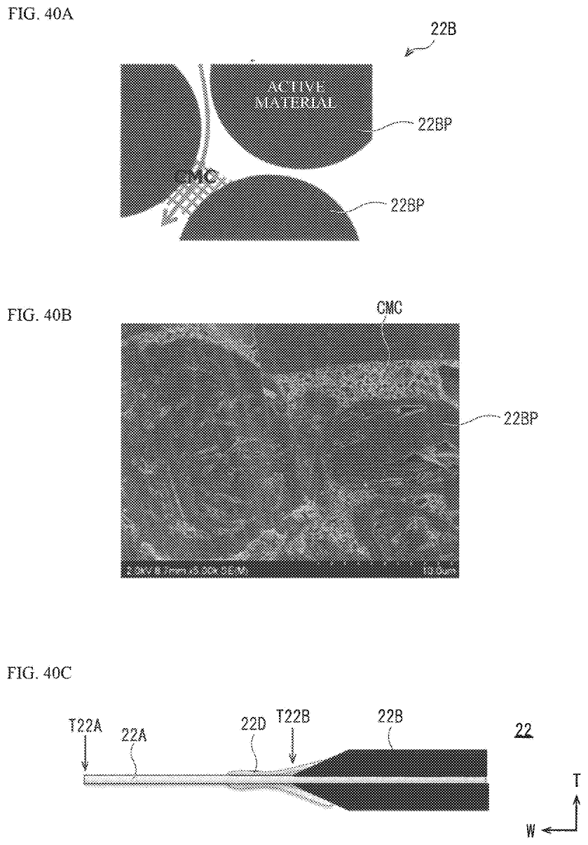

FIG. 40A is a schematic diagram illustrating negative electrode active material particles 22BP and porous carboxymethylcellulose (CMC) included in the negative electrode active material layer 22B of Example 6-1 applicable to, for example, a battery such as a lithium-ion secondary battery. The porous CMC is a binder present in gaps between the multiple negative electrode active material particles 22BP. The porous CMC is a resultant of causing CMC to foam by addition of, for example, N-methyl-2-pyrrolidone (NMP) as a poor solvent, and thereby causing CMC to become porous.

In the negative electrode active material layer 22B of Example 6-1, pathways for lithium ions are provided by causing CMC to be porous. This allows lithium ions to easily pass through the CMC. Accordingly, it is possible to reduce an ionic resistance of the electrode wound body 20 even if the negative electrode active material layer 22B is increased in thickness, and a further higher output is thus expectable.

FIG. 40B is a photomicrograph providing an enlarged view of the negative electrode active material particle 22BP and porous carboxymethylcellulose (CMC) included in the negative electrode active material layer 22B of Example 6-2 applicable to, for example, a battery such as a lithium-ion secondary battery. The porous CMC is a binder covering all or a part of a surface of the negative electrode active material particle 22BP. The porous CMC is a resultant of causing CMC to foam by addition of, for example, N-methyl-2-pyrrolidone (NMP) as a poor solvent, and thereby causing CMC to become porous.

In the negative electrode active material layer 22B of Example 6-2, the surface of the negative electrode active material particle 22BP is covered with CMC that has been caused to become porous. This allows lithium ions to easily pass through CMC and reach the negative electrode active material particle 22BP, as compared with when the surface of the negative electrode active material particle 22BP is covered with CMC that is in a solid state and not porous. Accordingly, it is possible to reduce ionic resistance of the electrode wound body 20 even if the negative electrode active material layer 22B is increased in thickness, and a further higher output is thus expectable.

FIG. 40C is a schematic sectional diagram illustrating the negative electrode 22 of Example 6-3 applicable to, for example, a battery such as a lithium-ion secondary battery. As illustrated in FIG. 40C, the negative electrode 22 of Example 6-3 includes the negative electrode current collector 22A, the negative electrode active material layer 22B provided on the surface of the negative electrode current collector 22A, and a masking layer 22D. In the W direction, the leading end T22B of the negative electrode active material layer 22B is positioned to be inwardly retracted relative to the position of a leading end T22A of the negative electrode current collector 22A. A part of the negative electrode current collector 22A is thus exposed without being covered with the negative electrode active material layer 22B. The masking layer 22D covers the exposed part of the negative electrode current collector 22A and a region including the leading end T22B of the negative electrode active material layer 22B and the vicinity of the leading end T22B.

The negative electrode 22 of Example 6-3 is provided with the masking layer 22D. This makes it possible to protect the region including the leading end T22B of the negative electrode active material layer 22B and the vicinity of the leading end T22B. Providing the masking layer 22D makes it possible to suppress coming-off of the negative electrode active material in the region including the leading end T22B of the negative electrode active material layer 22B and the vicinity of the leading end T22B, and to thereby suppress generation of dust derived from the negative electrode 22. As a result, a reduction in open circuit voltage (OCV) defect rate and suppression of the occurrence of a short circuit during storage are expectable.

Further, the masking layer 22D serves as a cushioning material and thus reduces stress on the separator 23 caused by expansion and contraction of the electrode wound body 20 associated with charging and discharging cycles. Furthermore, the masking layer 22D serving as a cushioning material makes it is possible to reduce friction between the negative electrode 22 and the separator 23 caused by the expansion and contraction of the electrode wound body 20 associated with charging and discharging cycles, to prevent coming-off of the negative electrode active material from the negative electrode active material layer 22B, and to thereby avoid an unintended exposure of the negative electrode current collector 22A. As a result, the masking layer 22D serves as a cushioning material and an insulating material, which makes it possible to effectively suppress the occurrence of a short circuit during charging and discharging cycles.

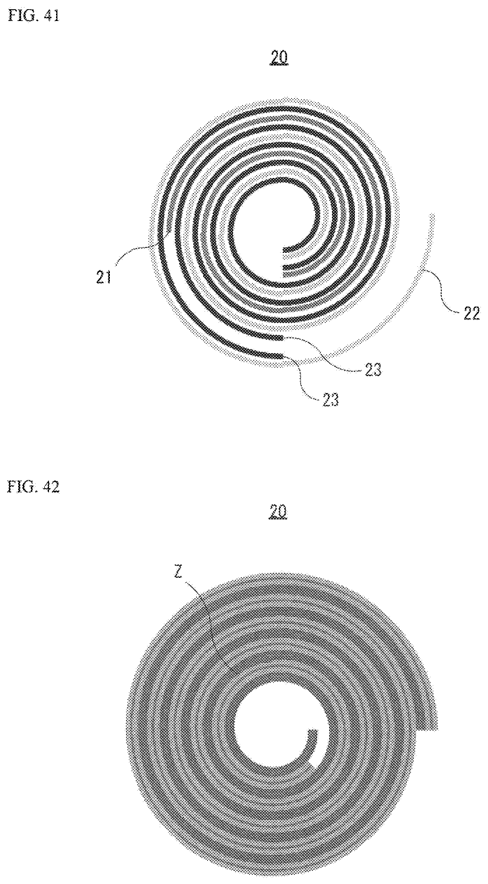

FIG. 41 is a schematic sectional diagram illustrating the electrode wound body 20 of Example 7-1 applicable to, for example, a battery such as a lithium-ion secondary battery. As illustrated in FIG. 41, the electrode wound body 20 of Example 7-1 corresponds to a stacked body that is wound. In the stacked body, the positive electrode 21, the negative electrode 22, and the separator 23 are stacked in order. In the electrode wound body 20 of Example 7-1, the negative electrode 22 is present in an outermost wind part, instead of the separator 23. More specifically, an outermost wind surface of the electrode wound body 20 of Example 7-1 is an outer winding side surface of the negative electrode current collector 22A such as a copper foil.

In the electrode wound body 20 of Example 7-1, the negative electrode current collector 22A is exposed in the outermost wind surface of the electrode wound body 20. This improves heat dissipation performance, thus allowing heat generated due to a battery reaction to be efficiently released to the outside. Further, this allows for a reduction in length of the separator 23 in the electrode wound body 20, which makes it possible to increase a capacity of a battery including the electrode wound body 20.

The electrode wound body of Example 7-2 applicable to, for example, a battery such as a lithium-ion secondary battery corresponds to a stacked body that is wound. In the stacked body, the positive electrode, a separator, the negative electrode, and a separator are stacked in order. In the electrode wound body of Example 7-2, the negative electrode is present in the outermost wind part, instead of the separator. More specifically, the outermost wind surface of the electrode wound body of Example 7-2 is the outer winding side surface of the negative electrode current collector such as a copper foil. In the electrode wound body of Example 7-2, the negative electrode is present also in the innermost wind part, instead of the separator.

In the electrode wound body of Example 7-2, the negative electrode current collector is exposed in the outermost wind surface and an innermost wind surface of the electrode wound body. This improves heat dissipation performance, thus allowing heat generated due to a battery reaction to be efficiently released to the outside. Further, this allows for a reduction in length of the separator in the electrode wound body, which makes it possible to increase a capacity of a battery including the electrode wound body.

The electrode wound body of Example 7-3 applicable to, for example, a battery such as a lithium-ion secondary battery includes a stacked body that is wound. In the stacked body, the positive electrode, the separator, the negative electrode, and the separator are stacked in order. Note that in the electrode wound body of Example 7-3, among the positive electrode, the separators, and the negative electrode, only the separator(s) is/are present in a winding center part. In the winding center part, only the separator(s), among the positive electrode, the separators, and the negative electrode, is/are wound multiple times.

In the electrode wound body of Example 7-3, among the positive electrode, the separators, and the negative electrode, only the one of the separators is wound multiple times in the winding center part. Accordingly, even when the positive electrode active material layer is subjected to stress caused by expansion of the negative electrode upon charging, it is possible for the positive electrode active material layer to resist the stress. This makes it possible to prevent the occurrence of cracking or buckling in the positive electrode active material layer.

FIG. 42 is a schematic sectional diagram illustrating the electrode wound body 20 of Example 7-4 applicable to, for example, a battery such as a lithium-ion secondary battery. As illustrated in FIG. 42, the electrode wound body 20 of Example 7-4 corresponds to a stacked body that is wound. In the stacked body, the positive electrode, the separator, the negative electrode, and the separator are stacked in order. In the electrode wound body 20 of Example 7-4, an insulating member Z having a sheet shape is provided on at least one of a part of the surface of the positive electrode or a part of the surface of the negative electrode. The insulating member Z has a predetermined length in the winding direction. The insulating member Z may be provided at each of multiple locations in the winding direction.

The electrode wound body 20 of Example 7-4 is provided with the insulating member Z, which results in generation of a level difference corresponding to a thickness of the insulating member Z in at least one of the surface of the positive electrode or the surface of the negative electrode. Accordingly, even when expansion of the negative electrode occurs upon charging, stress is allowed to concentrate on multiple locations inside the electrode wound body 20, which makes it possible to eliminate any location where great stress concentrates locally. This makes it possible to avoid the occurrence of cracking or detachment of the positive electrode active material layer, or the occurrence of cracks or breakage of the separator, and thus allows for improved safety.

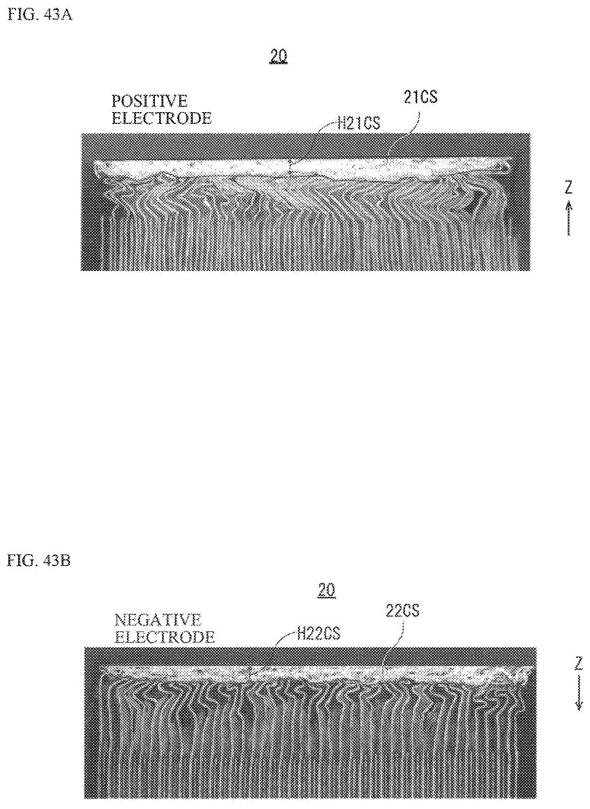

FIG. 43A is an enlarged sectional view of an upper end part, in the height direction Z, of the electrode wound body 20 of Example 7-6 applicable to, for example, a battery such as a lithium-ion secondary battery. FIG. 43B is an enlarged sectional view of a lower end part of the electrode wound body 20 of Example 7-6 in the height direction Z. As illustrated in FIG. 43A, the upper end part of the electrode wound body 20 includes a positive electrode current collector compressed part 21CS. The positive electrode current collector compressed part 21CS refers to a part in which multiple portions, of an upper edge of the positive electrode current collector (e.g., an aluminum foil) included in the electrode wound body 20, that are adjacent to each other in the radial direction of the electrode wound body (a lateral direction in the sheet plane of FIG. 43A) are so pressed down as to overlap each other in the height direction Z without the separator interposed therebetween. An upper surface of the positive electrode current collector compressed part 21CS is joined to the positive electrode current collector plate, for example. In contrast, as illustrated in FIG. 43B, the lower end part of the electrode wound body 20 includes a negative electrode current collector compressed part 22CS. The negative electrode current collector compressed part 22CS refers to a part in which multiple portions, of a lower edge of the negative electrode current collector (e.g., a copper foil) included in the electrode wound body 20, that are adjacent to each other in the radial direction of the electrode wound body (the lateral direction in the sheet plane of FIG. 43B) are so pressed down as to overlap each other in the height direction Z without the separator interposed therebetween. A lower surface of the negative electrode current collector compressed part 22CS is joined to the negative electrode current collector plate, for example. Here, a maximum value of a thickness (a dimension in the height direction Z) H21CS of the positive electrode current collector compressed part 21CS is larger than a maximum value of a thickness (a dimension in the height direction Z) H22CS of the negative electrode current collector compressed part 22CS.

In the electrode wound body 20 of Example 7-6, the maximum value of the thickness H21CS of the positive electrode current collector compressed part 21CS is set to be larger than the maximum value of the thickness H22CS of the negative electrode current collector compressed part 22CS. This makes it possible to reduce a coupling resistance between the positive electrode current collector compressed part 21CS and the positive electrode current collector plate and a coupling resistance between the negative electrode current collector compressed part 22CS and the negative electrode current collector plate in a balanced fashion.

The negative electrode current collector of Example 8-1 includes a copper foil of high purity. Specifically, the copper foil has a purity of 99.99% or more. With such a copper foil, a volume resistivity of 0.1677 [μΩ·m] or less and a thermal conductivity of 400 [W/(m·K)] or more are achievable. Using such a copper foil as the negative electrode current collector suppresses heat generation at the time of high input and output and suppresses a temperature rise of the secondary battery, thereby allowing for a favorable cyclability characteristic. Further, for example, thermal conduction performance between the negative electrode current collector and the negative electrode current collector plate improves, which allows heat generated in the electrode wound body to be efficiently released to the outside via the negative electrode current collector plate and the outer package can. As a result, it is possible to achieve a favorable cyclability characteristic. Further, the copper foil having high purity is superior in ductility and thus also makes it possible to suppress the occurrence of a crack in the negative electrode current collector associated with expansion and contraction upon charging and discharging.

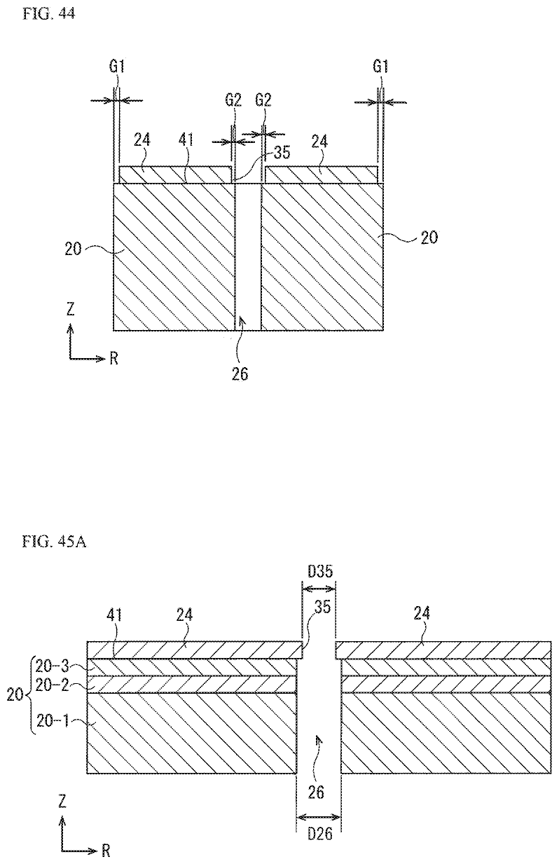

FIG. 44 is a schematic sectional diagram illustrating a part, of the secondary battery of Example 8-2, positioned in a region including the upper end face 41 of the electrode wound body 20 and the vicinity of the upper end face 41. The upper edge of the positive electrode current collector forming the upper end face 41 of the electrode wound body 20 is welded to the positive electrode current collector plate 24. Here, a gap G1, i.e., an amount of discrepancy between an outer edge of the electrode wound body 20 and an outer edge of the positive electrode current collector plate 24 in the radial direction of the electrode wound body 20, is less than 1 mm. Further, a gap G2, i.e., an amount of discrepancy between an inner edge of the through hole 26 of the electrode wound body 20 and an inner edge of the opening 35 of the positive electrode current collector plate 24 in the radial direction of the electrode wound body 20, is less than 0.5 mm. In other words, almost all region of the upper end face 41 of the electrode wound body 20 is joined to the positive electrode current collector plate 24. Similarly, in the secondary battery of Example 8-2, almost all region of the lower end face 42 of the electrode wound body 20 is preferably joined to the negative electrode current collector plate 25.

With the secondary battery of Example 8-2, an improved high-load discharge characteristic, an effect of suppressing the occurrence of a short circuit during charging and discharging cycles, and an effect of suppressing the occurrence of a short circuit during storage at a high temperature are expectable.

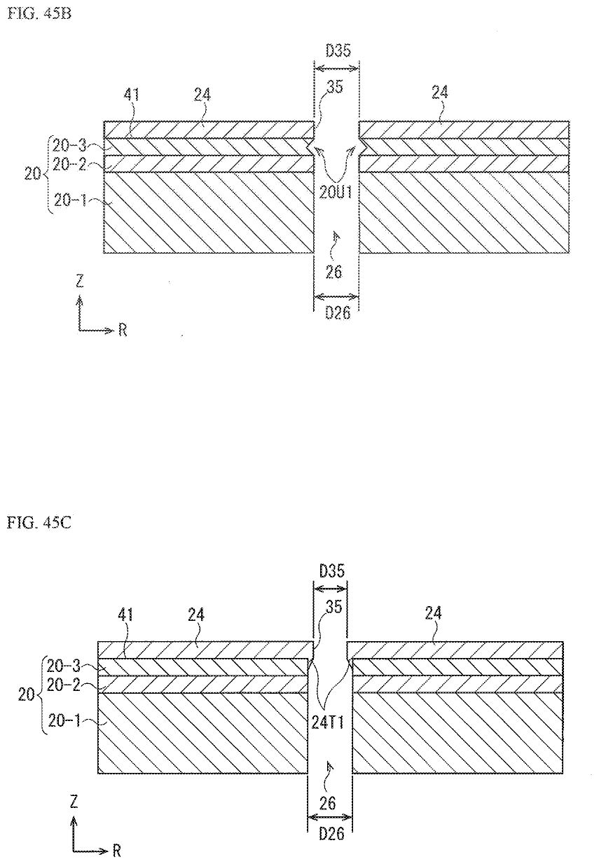

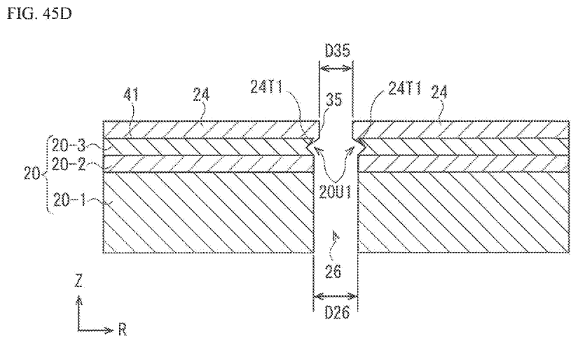

FIG. 45A is a schematic sectional diagram illustrating a part, of the secondary battery of Example 8-3-1, positioned in the region including the upper end face 41 of the electrode wound body 20 and the vicinity of the upper end face 41. In the secondary battery of Example 8-3-1, the electrode wound body 20 includes a first region 20-1, a second region 20-2, and a third region 20-3 in order in the height direction Z of the secondary battery. The first region 20-1 is a region in which the positive electrode and the negative electrode are stacked with the separator interposed therebetween and are wound. The second region 20-2 is a region, of the positive electrode that is wound, in which multiple portions of an upper end part of the positive electrode current collector that are not covered with the positive electrode active material layer are spaced from and adjacent to each other in the radial direction R of the secondary battery, without overlapping each other. The third region 20-3 is a region, of the positive electrode that is wound, in which a compression part is present. In the compression part, the multiple portions of the upper end part of the positive electrode current collector that are not covered with the positive electrode active material layer are compressed and are so pressed down as to overlap each other. An upper surface of the third region 20-3 forms the upper end face 41 of the electrode wound body 20, and the upper end face 41 is joined to the positive electrode current collector plate 24 by a method such as welding. In the secondary battery of Example 8-3-1, an inner diameter D35 of the opening 35 of the positive electrode current collector plate 24 is smaller than an inner diameter D26 of the through hole 26 of the electrode wound body 20. Accordingly, a part of the positive electrode current collector plate 24 extends to protrude into the through hole 26. Note that in the secondary battery of Example 8-3-1, an outer diameter of the electrode wound body 20 and an outer diameter of the positive electrode current collector plate 24 are substantially equal.

In the secondary battery of Example 8-3-1, the inner diameter D35 of the opening 35 of the positive electrode current collector 24 is smaller than the inner diameter D26 of the through hole 26 of the electrode wound body 20, and almost all region of the upper end face 41 of the electrode wound body 20 is joined to the positive electrode current collector plate 24. Accordingly, an improved high-load discharge characteristic, the effect of suppressing the occurrence of a short circuit during charging and discharging cycles, and the effect of suppressing the occurrence of a short circuit during storage at a high temperature are expectable. Note that in the secondary battery of Example 8-3-1, almost all region of the lower end face 42 of the electrode wound body 20 is preferably joined to the negative electrode current collector plate 25 by making an inner diameter of the opening 36 of the negative electrode current collector plate 25 smaller than the inner diameter D26 of the through hole 26 of the electrode wound body 20.

FIG. 45B is a schematic sectional diagram illustrating a part, of the secondary battery of Example 8-3-2, positioned in the region including the upper end face 41 of the electrode wound body 20 and the vicinity of the upper end face 41. In the secondary battery of Example 8-3-2, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-3-2, the third region 20-3 includes a depression part 20U1 at an inner winding side edge thereof. The depression part 20U1 is provided in the inner winding side edge of the compressed part of the positive electrode current collector present in the third region 20-3, that is, a part of the positive electrode current collector in which the multiple portions, of the positive electrode current collector, that are not covered with the positive electrode active material layer overlap each other. The depression part 20U1 is a part in which a bend toward the outer winding side is created in the inner winding side edge of the compressed part of the positive electrode current collector present in the third region 20-3. Note that the inner diameter D26 of the through hole 26 of the electrode wound body 20 except a location where the depression part 20U1 is provided and the inner diameter D35 of the opening 35 of the positive electrode current collector plate 24 are substantially equal. Alternatively, the inner diameter D35 may be smaller than the inner diameter D26. Further, in the secondary battery of Example 8-3-2, the outer diameter of the electrode wound body 20 and the outer diameter of the positive electrode current collector plate 24 are substantially equal.

In the secondary battery of Example 8-3-2, almost all region of the upper end face 41 of the electrode wound body 20 is joined to the positive electrode current collector plate 24. Furthermore, the third region 20-3 includes the depression part 20U1. This suppresses the occurrence of buckling in the innermost wind part of the electrode wound body 20 when expansion of the negative electrode occurs upon charging, for example. Accordingly, an improved high-load discharge characteristic, the effect of suppressing the occurrence of a short circuit during charging and discharging cycles, and the effect of suppressing the occurrence of a short circuit during storage at a high temperature are expectable. In the secondary battery of Example 8-3-2, it is preferable that the negative electrode current collector also include a part in which a bend toward the outer winding side is created in an inner winding side edge of a compressed part of the negative electrode current collector.

FIG. 45C is a schematic sectional diagram illustrating a part, of the secondary battery of Example 8-3-3, positioned in the region including the upper end face 41 of the electrode wound body 20 and the vicinity of the upper end face 41. In the secondary battery of Example 8-3-3, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-3-3, the inner diameter D35 of the opening 35 of the positive electrode current collector plate 24 is smaller than the inner diameter D26 of the through hole 26 of the electrode wound body 20. Accordingly, a part of the positive electrode current collector plate 24 extends to protrude into the through hole 26. Furthermore, a bent part 24T1 bent toward an inside of the through hole 26 is provided at a peripheral edge part of the opening 35 of the positive electrode current collector plate 24. The bent part 24T1 covers all or a part of the inner winding side edge of the third region 20-3. Note that in the secondary battery of Example 8-3-3, the outer diameter of the electrode wound body 20 and the outer diameter of the positive electrode current collector plate 24 are substantially equal.

In the secondary battery of Example 8-3-3, almost all region of the upper end face 41 of the electrode wound body 20 is joined to the positive electrode current collector plate 24. Furthermore, the inner winding side edge of the third region 20-3 is covered with the bent part 24T1 of the positive electrode current collector plate 24. This suppresses the occurrence of buckling in the innermost wind part of the electrode wound body 20 when expansion of the negative electrode occurs upon charging, for example. Accordingly, an improved high-load discharge characteristic, the effect of suppressing the occurrence of a short circuit during charging and discharging cycles, and the effect of suppressing the occurrence of a short circuit during storage at a high temperature are expectable. In the secondary battery of Example 8-3-3, it is preferable that a bent part be provided also at a peripheral edge part of the opening 36 of the negative electrode current collector plate 25 and that the bent part of the negative electrode current collector plate 25 cover all or a part of the inner winding side edge of the electrode wound body 20 in the vicinity of the lower end face 42.

FIG. 45D is a schematic sectional diagram illustrating a part, of the secondary battery of Example 8-3-4, positioned in the region including the upper end face 41 of the electrode wound body 20 and the vicinity of the upper end face 41. In the secondary battery of Example 8-3-4, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-3-4, the inner diameter D35 of the opening 35 of the positive electrode current collector plate 24 is smaller than the inner diameter D26 of the through hole 26 of the electrode wound body 20. Accordingly, a part of the positive electrode current collector plate 24 extends to protrude into the through hole 26. Further, in the secondary battery of Example 8-3-4, the third region 20-3 includes the depression part 20U1 at the inner winding side edge thereof. The depression part 20U1 is a part in which a bend toward the outer winding side is created in the inner winding side edge of the compressed part of the positive electrode current collector present in the third region 20-3. Furthermore, the bent part 24T1 is provided at the peripheral edge part of the opening 35 of the positive electrode current collector plate 24. The bent part 24T1 covers all or a part of the depression part 20U1 of the third region 20-3. Note that in the secondary battery of Example 8-3-4, the outer diameter of the electrode wound body 20 and the outer diameter of the positive electrode current collector plate 24 are substantially equal.

In the secondary battery of Example 8-3-4, almost all region of the upper end face 41 of the electrode wound body 20 is joined to the positive electrode current collector plate 24. Furthermore, all or a part of the depression part 20U1 provided at the inner winding side edge of the third region 20-3 is covered with the bent part 24T1 of the positive electrode current collector plate 24. This suppresses the occurrence of buckling in the innermost wind part of the electrode wound body 20 when expansion of the negative electrode occurs upon charging, for example. Accordingly, an improved high-load discharge characteristic, the effect of suppressing the occurrence of a short circuit during charging and discharging cycles, and the effect of suppressing the occurrence of a short circuit during storage at a high temperature are expectable. In the secondary battery of Example 8-3-4, a bent part is preferably provided also at the peripheral edge part of the opening 36 of the negative electrode current collector plate 25, a depression part is preferably provided at the inner winding side edge of the electrode wound body 20 in the vicinity of the lower end face 42, and the bent part of the negative electrode current collector plate 25 preferably covers the depression part of the electrode wound body 20.

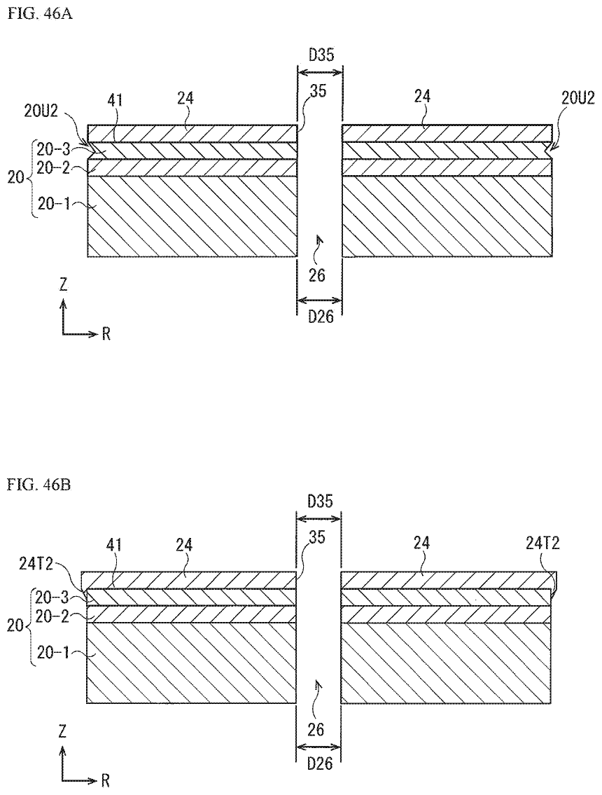

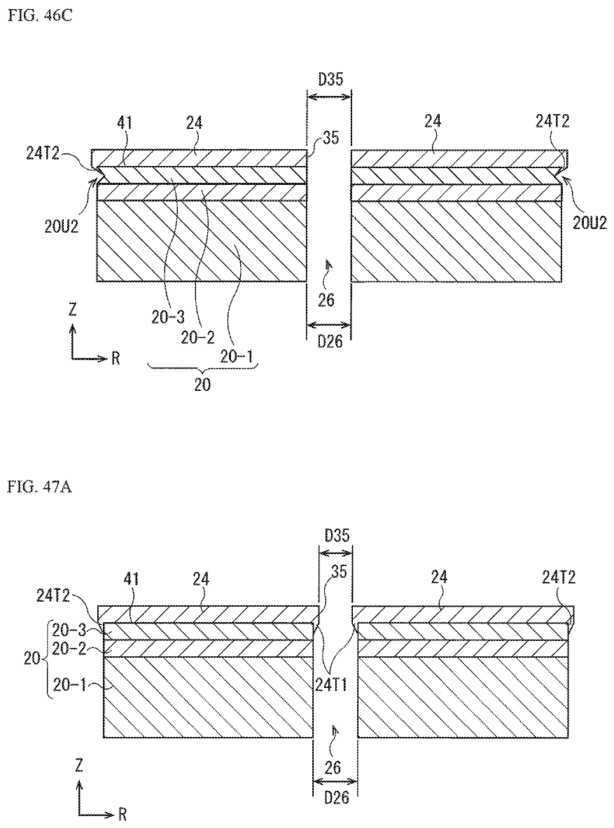

FIG. 46A is a schematic sectional diagram illustrating a part, of the secondary battery of Example 8-4-1, positioned in the region including the upper end face 41 of the electrode wound body 20 and the vicinity of the upper end face 41. In the secondary battery of Example 8-4-1, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-4-1, the third region 20-3 includes a depression part 20U2 at an outer winding side edge thereof. The depression part 20U2 is a part in which a bend toward the inner winding side is created in the outer winding side edge of the compressed part of the positive electrode current collector present in the third region 20-3. Note that the inner diameter D26 of the through hole 26 of the electrode wound body 20 and the inner diameter D35 of the opening 35 of the positive electrode current collector plate 24 are substantially equal. Alternatively, the inner diameter D35 may be smaller than the inner diameter D26.

In the secondary battery of Example 8-4-1, almost all region of the upper end face 41 of the electrode wound body 20 is joined to the positive electrode current collector plate 24. Furthermore, the third region 20-3 includes the depression part 20U2. Accordingly, a position of the outermost wind part of the electrode wound body 20 and a position of an outermost peripheral part of the positive electrode current collector plate 24 are prevented from easily becoming misaligned with each other even when expansion of the negative electrode occurs upon charging, for example. This improves efficiency of current collection. Further, an improved high-load discharge characteristic, the effect of suppressing the occurrence of a short circuit during charging and discharging cycles, and the effect of suppressing the occurrence of a short circuit during storage at a high temperature are expectable. Note that in the secondary battery of Example 8-4-1, it is preferable that the negative electrode current collector also include a part in which a bend toward the outer winding side is created in an outer winding side edge of the compressed part of the negative electrode current collector.

FIG. 46B is a schematic sectional diagram illustrating a part, of the secondary battery of Example 8-4-2, positioned in the region including the upper end face 41 of the electrode wound body 20 and the vicinity of the upper end face 41. In the secondary battery of Example 8-4-2, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-4-2, the outer diameter of the positive electrode current collector plate 24 is greater than the outer diameter of the electrode wound body 20. Accordingly, a part of the positive electrode current collector plate 24 extends to protrude outward relative to the third region 20-3 of the electrode wound body 20. Furthermore, a bent part 24T2 bent toward the negative electrode current collector plate 25 is provided at an outer peripheral edge part of the positive electrode current collector plate 24. The bent part 24T2 covers all or a part of the outer winding side edge of the third region 20-3. Note that in the secondary battery of Example 8-4-2, the inner diameter D26 of the through hole 26 of the electrode wound body 20 and the inner diameter D35 of the opening 35 of the positive electrode current collector plate 24 are substantially equal.

In the secondary battery of Example 8-4-2, almost all region of the upper end face 41 of the electrode wound body 20 is joined to the positive electrode current collector plate 24. Furthermore, the outer winding side edge of the third region 20-3 is covered with the bent part 24T2 of the positive electrode current collector plate 24. Accordingly, the position of the outermost wind part of the electrode wound body 20 and the position of the outermost peripheral part of the positive electrode current collector plate 24 are prevented from easily becoming misaligned with each other even when expansion of the negative electrode occurs upon charging, for example. This improves efficiency of current collection. Further, an improved high-load discharge characteristic, the effect of suppressing the occurrence of a short circuit during charging and discharging cycles, and the effect of suppressing the occurrence of a short circuit during storage at a high temperature are expectable. Note that in the secondary battery of Example 8-4-2, it is preferable that a bent part be provided also at an outer peripheral edge part of the negative electrode current collector plate 25 and that the bent part of the negative electrode current collector plate 25 cover all or a part of an outer winding side edge of the electrode wound body 20 in the vicinity of the lower end face 42.

FIG. 46C is a schematic sectional diagram illustrating a part, of the secondary battery of Example 8-4-3, positioned in the region including the upper end face 41 of the electrode wound body 20 and the vicinity of the upper end face 41. In the secondary battery of Example 8-4-3, the electrode wound body 20 includes the first region 20-1, the second region 20-2, and the third region 20-3 in order in the height direction Z of the secondary battery. The first region 20-1 is a region where the positive electrode and the negative electrode are stacked with the separator interposed therebetween and are wound. The second region 20-2 is a region of the positive electrode that is wound in which the multiple portions, of the upper end part of the positive electrode current collector, that are not covered with the positive electrode active material layer are spaced from and adjacent to each other in the radial direction R of the secondary battery, without overlapping each other. The third region 20-3 is a region of the positive electrode that is wound in which a compression part is present. In the compression part, the multiple portions, of the upper end part of the positive electrode current collector, that are not covered with the positive electrode active material layer are compressed and are so pressed down as to overlap each other. The upper surface of the third region 20-3 forms the upper end face 41 of the electrode wound body 20, and the upper end face 41 is joined to the positive electrode current collector plate 24 by a method such as welding. In the secondary battery of Example 8-4-2, the outer diameter of the positive electrode current collector plate 24 is greater than the outer diameter of the electrode wound body 20. Accordingly, a part of the positive electrode current collector plate 24 extends to protrude outward relative to the third region 20-3 of the electrode wound body 20. Further, in the secondary battery of Example 8-4-3, the third region 20-3 includes the depression part 20U2 at the outer winding side edge thereof. The depression part 20U2 is a part in which a bend toward the inner winding side is created in the outer winding side edge of the compressed part of the positive electrode current collector present in the third region 20-3. Furthermore, the bent part 24T2 is provided at the outer peripheral edge part of the positive electrode current collector plate 24. The bent part 24T2 covers all or a part of the depression part 20U2 of the third region 20-3. Note that in the secondary battery of Example 8-4-3, the inner diameter D26 of the through hole 26 of the electrode wound body 20 and the inner diameter D35 of the opening 35 of the positive electrode current collector plate 24 are substantially equal.

In the secondary battery of Example 8-4-3, almost all region of the upper end face 41 of the electrode wound body 20 is joined to the positive electrode current collector plate 24. Furthermore, all or a part of the depression part 20U2 provided at the outer winding side edge of the third region 20-3 is covered with the bent part 24T2 of the positive electrode current collector plate 24. Accordingly, the position of the outermost wind part of the electrode wound body 20 and the position of the outermost peripheral part of the positive electrode current collector plate 24 are prevented from easily becoming misaligned with each other even when expansion of the negative electrode occurs upon charging, for example. This improves efficiency of current collection. Further, an improved high-load discharge characteristic, the effect of suppressing the occurrence of a short circuit during charging and discharging cycles, and the effect of suppressing the occurrence of a short circuit during storage at a high temperature are expectable. In the secondary battery of Example 8-4-3, a bent part is preferably provided also at the outer peripheral edge part of the negative electrode current collector plate 25, a depression part is preferably provided at the outer winding side edge of the electrode wound body 20 in the vicinity of the lower end face 42, and the bent part of the negative electrode current collector plate 25 preferably covers the depression part of the electrode wound body 20.

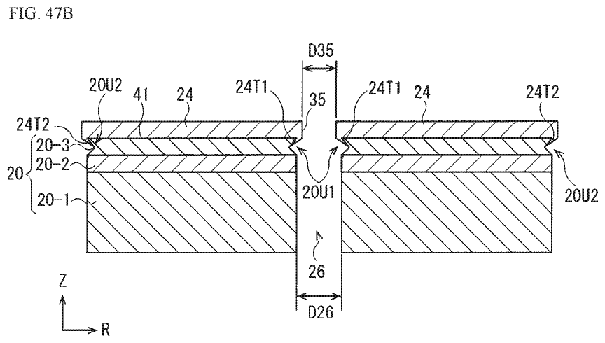

FIG. 47A is a schematic sectional diagram illustrating a part, of the secondary battery of Example 8-5-1, positioned in the region including the upper end face 41 of the electrode wound body 20 and the vicinity of the upper end face 41. In the secondary battery of Example 8-5-1, the outer diameter of the positive electrode current collector plate 24 is greater than the outer diameter of the electrode wound body 20. Accordingly, a part of the positive electrode current collector plate 24 extends to protrude outward relative to the third region 20-3 of the electrode wound body 20. Furthermore, the bent part 24T2 is provided at the outer peripheral edge part of the positive electrode current collector plate 24. The bent part 24T2 covers all or a part of the outer winding side edge of the third region 20-3. Further, in the secondary battery of Example 8-5-1, the inner diameter D35 of the opening 35 of the positive electrode current collector plate 24 is smaller than the inner diameter D26 of the through hole 26 of the electrode wound body 20. Accordingly, a part of the positive electrode current collector plate 24 extends to protrude into the through hole 26. Furthermore, the bent part 24T1 bent toward the inside of the through hole 26 is provided at the peripheral edge part of the opening 35 of the positive electrode current collector plate 24. The bent part 24T1 covers all or a part of the inner winding side edge of the third region 20-3.

In the secondary battery of Example 8-5-1, almost all region of the upper end face 41 of the electrode wound body 20 is joined to the positive electrode current collector plate 24. Furthermore, the outer winding side edge of the third region 20-3 is covered with the bent part 24T2 of the positive electrode current collector plate 24. Accordingly, the position of the outermost wind part of the electrode wound body 20 and the position of the outermost peripheral part of the positive electrode current collector plate 24 are prevented from easily becoming misaligned with each other even when expansion of the negative electrode occurs upon charging, for example. This improves efficiency of current collection. Further, an improved high-load discharge characteristic, the effect of suppressing the occurrence of a short circuit during charging and discharging cycles, and the effect of suppressing the occurrence of a short circuit during storage at a high temperature are expectable. Furthermore, the inner winding side edge of the third region 20-3 is covered with the bent part 24T1 of the positive electrode current collector plate 24. This suppresses the occurrence of buckling in the innermost wind part of the electrode wound body 20 when expansion of the negative electrode occurs upon charging, for example. Accordingly, an improved high-load discharge characteristic, the effect of suppressing the occurrence of a short circuit during charging and discharging cycles, and the effect of suppressing the occurrence of a short circuit during storage at a high temperature are expectable. In the secondary battery of Example 8-5-1, it is preferable that a bent part be provided also at the outer peripheral edge part of the negative electrode current collector plate 25 and that the bent part of the negative electrode current collector plate 25 cover all or a part of the outer winding side edge of the electrode wound body 20 in the vicinity of the lower end face 42. Furthermore, it is preferable that a bent part be provided at the peripheral edge part of the opening 36 and that the bent part of the negative electrode current collector plate 25 cover all or a part of the inner winding side edge of the electrode wound body 20 in the vicinity of the lower end face 42.

FIG. 47B is a schematic sectional diagram illustrating a part, of the secondary battery of Example 8-5-2, positioned in the region including the upper end face 41 of the electrode wound body 20 and the vicinity of the upper end face 41. In the secondary battery of Example 8-5-2, the outer diameter of the positive electrode current collector plate 24 is greater than the outer diameter of the electrode wound body 20. Accordingly, a part of the positive electrode current collector plate 24 extends to protrude outward relative to the third region 20-3 of the electrode wound body 20. Further, in the secondary battery of Example 8-5-2, the third region 20-3 includes the depression part 20U2 at the outer winding side edge thereof. The depression part 20U2 is a part in which a bend toward the inner winding side is created in the outer winding side edge of the compressed part of the positive electrode current collector present in the third region 20-3. Furthermore, the bent part 24T2 is provided at the outer peripheral edge part of the positive electrode current collector plate 24. The bent part 24T2 covers all or a part of the depression part 20U2 of the third region 20-3. Further, in the secondary battery of Example 8-5-2, the inner diameter D35 of the opening 35 of the positive electrode current collector plate 24 is smaller than the inner diameter D26 of the through hole 26 of the electrode wound body 20. Accordingly, a part of the positive electrode current collector plate 24 extends to protrude into the through hole 26. Further, in the secondary battery of Example 8-5-2, the third region 20-3 includes the depression part 20U1 at the inner winding side edge thereof. The depression part 20U1 is a part in which a bend toward the outer winding side is created in the inner winding side edge of the compressed part of the positive electrode current collector present in the third region 20-3. Furthermore, the bent part 24T1 is provided at the peripheral edge part of the opening 35 of the positive electrode current collector plate 24. The bent part 24T1 covers all or a part of the depression part 20U1 of the third region 20-3.

In the secondary battery of Example 8-5-2, almost all region of the upper end face 41 of the electrode wound body 20 is joined to the positive electrode current collector plate 24. Furthermore, all or a part of the depression part 20U2 provided at the outer winding side edge of the third region 20-3 is covered with the bent part 24T2 of the positive electrode current collector plate 24. Accordingly, the position of the outermost wind part of the electrode wound body 20 and the position of the outermost peripheral part of the positive electrode current collector plate 24 are prevented from easily becoming misaligned with each other even when expansion of the negative electrode occurs upon charging, for example. This improves efficiency of current collection. Further, an improved high-load discharge characteristic, the effect of suppressing the occurrence of a short circuit during charging and discharging cycles, and the effect of suppressing the occurrence of a short circuit during storage at a high temperature are expectable. Further, in the secondary battery of Example 8-5-2, all or a part of the depression part 20U1 provided at the inner winding side edge of the third region 20-3 is covered with the bent part 24T1 of the positive electrode current collector plate 24. This suppresses the occurrence of buckling in the innermost wind part of the electrode wound body 20 when expansion of the negative electrode occurs upon charging, for example. Accordingly, an improved high-load discharge characteristic, the effect of suppressing the occurrence of a short circuit during charging and discharging cycles, and the effect of suppressing the occurrence of a short circuit during storage at a high temperature are expectable. Note that in the secondary battery of Example 8-5-2, a bent part is preferably provided also at the outer peripheral edge part of the negative electrode current collector plate 25, a depression part is preferably provided at the outer winding side edge of the electrode wound body 20 in the vicinity of the lower end face 42, and the bent part of the negative electrode current collector plate 25 preferably covers the depression part of the electrode wound body 20. Furthermore, in the secondary battery of Example 8-5-2, a bent part is preferably provided also at the peripheral edge part of the opening 36 of the negative electrode current collector plate 25, a depression part is preferably provided at the inner winding side edge of the electrode wound body 20 in the vicinity of the lower end face 42, and the bent part of the negative electrode current collector plate 25 preferably covers the depression part of the electrode wound body 20.

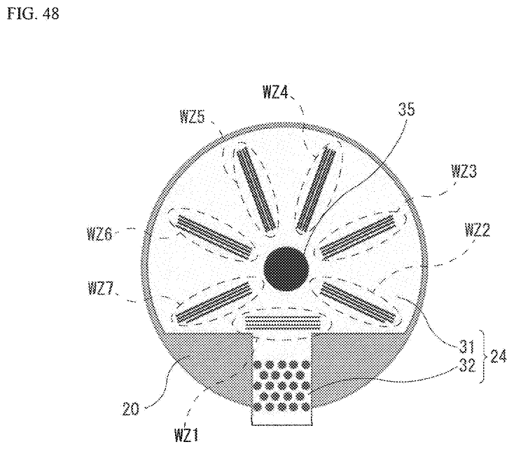

FIG. 48 is a schematic plan diagram illustrating the electrode wound body 20 and the positive electrode current collector plate 24 in the secondary battery of Example 8-6. As illustrated in FIG. 48, in the secondary battery of Example 8-6, the electrode wound body 20 and the fan-shaped part 31 of the positive electrode current collector plate 24 are joined to each other by a method such as welding at multiple joining locations WZ1 to WZ7. The joining locations WZ2 to WZ7 extend radially along radial directions of the secondary battery about the opening 35 positioned in the middle of the fan-shaped part 31. The joining location WZ1 lies at a position in the fan-shaped part 31 in the vicinity of a border between the fan-shaped part 31 and the band-shaped part 32. The band-shaped part 32 is a part to be joined to an external terminal. The joining location WZ1 preferably has a length greater than or equal to a width of the band-shaped part 32, for example.

In the secondary battery of Example 8-6, the electrode wound body 20 and the positive electrode current collector plate 24 are joined to each other not only at the joining locations WZ2 to WZ7 but also at the joining location WZ1. This makes it possible to reduce an electrical resistance between the electrode wound body 20 and the positive electrode current collector plate 24 as compared with when the electrode wound body 20 and the positive electrode current collector plate 24 are joined to each other only at the joining locations WZ2 to WZ7. A reason for this is that a length of a conduction path between the joining location WZ1 and the band-shaped part 32 is shorter than a length of a conduction path between each of the joining locations WZ2 to WZ7 and the band-shaped part 32. Accordingly, the secondary battery of Example 8-6 achieves a decrease in internal resistance, which makes it possible to reduce an amount of heat generation. Furthermore, even if stress is applied to a border part between the fan-shaped part 31 and the band-shaped part 32 when expansion and contraction of the electrode wound body 20 occurs due to charging and discharging, the fan-shaped part 31 does not easily peel away in part from the electrode wound body 20, owing to the fan-shaped part 31 and the electrode wound body 20 being joined to each other at the joining location WZ1. Accordingly, in the secondary battery of Example 8-6, an area of joining between the fan-shaped part 31 and the electrode wound body 20 is retained, which allows the secondary battery to achieve superior operation reliability.

In the secondary battery of Example 9-1, the electrode wound body 20 is impregnated with a nonaqueous electrolytic solution including dimethyl carbonate (DMC) as a primary solvent and LiPF₆ as a solute. A content rate of LiPF₆ in the nonaqueous electrolytic solution is 12 wt % or less of the entire nonaqueous electrolytic solution. Further, a content rate of DMC included in the nonaqueous electrolytic solution is 50% or more in terms of molar ratio of carbonate included in the nonaqueous electrolytic solution.

In the secondary battery of Example 9-1, the electrode wound body 20 is impregnated with the nonaqueous electrolytic solution in which a predetermined amount of LiPF₆ having a thickening effect is contained in a low-viscosity solvent that includes DMC as the primary solvent. This makes it possible to prevent an occurrence of a phenomenon in which a small amount of nonaqueous electrolytic solution is present in isolation inside the secondary battery. Accordingly, it is possible to prevent the metal included in the battery can from being dissolved.

In the secondary battery of Example 9-2, the electrode wound body 20 is impregnated with a nonaqueous electrolytic solution including dimethyl carbonate (DMC) as a primary solvent, a cyclic carbonate as a secondary solvent, and LiPF₆ as a solute. The cyclic carbonate in the nonaqueous electrolytic solution includes ethylene carbonate (EC), propylene carbonate (PC), and fluoroethylene carbonate (FEC). A total content rate of EC, PC, and FEC in the nonaqueous electrolytic solution is 20 wt % or more of the entire nonaqueous electrolytic solution, and a content rate of FEC is 10 wt % or more of the entire nonaqueous electrolytic solution. Further, a content rate of DMC included in the nonaqueous electrolytic solution is 50% or more in terms of molar ratio of carbonate included in the nonaqueous electrolytic solution.

In the secondary battery of Example 9-2, the electrode wound body 20 is impregnated with the nonaqueous electrolytic solution of low viscosity having the above-described composition. This makes it possible to prevent the occurrence of the phenomenon in which a small amount of nonaqueous electrolytic solution is present in isolation inside the secondary battery. Accordingly, it is possible to prevent the metal included in the battery can from being dissolved.

In the secondary battery of Example 9-3, a swellable tape that swells by impregnation with an electrolytic solution is wrapped around the electrode wound body 20. For example, in a process of manufacturing the secondary battery of Example 9-3, after the electrode wound body 20 with the swellable tape wrapped therearound is placed into the outer package can 11, the swellable tape is caused to swell by injecting the electrolytic solution into the outer package can 11. As a result, the electrode wound body 20 and the outer package can 11 are closely attached to each other with the swellable tape interposed therebetween, and are thus brought into a state where an air layer between the electrode wound body 20 and the outer package can 11 is reduced.

In the secondary battery of Example 9-3, the electrode wound body 20 and the outer package can 11 are closely attached to each other, and the air layer serving as a thermal insulation layer is reduced. Accordingly, superior heat dissipation performance is achieved, which allows heat of the electrode wound body 20 to be efficiently transferred to the outer package can 11 when heat generation occurs in the electrode wound body 20 due to charging. As a result, superior heat dissipation performance is achieved and safety improves. Note that the swellable tape wrapped around the electrode wound body 20 is caused to swell after placement of the electrode wound body 20 into the outer package can 11, as described above. This makes it possible to manufacture the secondary battery of Example 9-3 without impairing manufacturability.

The electrode wound body of Example 10-1 applicable to, for example, a battery such as a lithium-ion secondary battery corresponds to a stacked body that is wound. In the stacked body, the positive electrode, the separator, the negative electrode, and the separator are stacked in order. In the electrode wound body of Example 10-1, the negative electrode is present in the innermost wind part, instead of the separator. In the innermost wind part of the electrode wound body of Example 10-1, the negative electrode current collector, such as a copper foil, that is wound multiple times (e.g., three times or more) is present.

In the electrode wound body of Example 10-1, the negative electrode current collector is wound multiple times in the innermost wind part of the electrode wound body. This makes it possible to increase a radius of the innermost wind part of the positive electrode that is to be wound on the outer side of the negative electrode current collector. Accordingly, it is possible to prevent a crack from developing in the positive electrode active material layer in the innermost wind part of the positive electrode. This makes it possible to achieve an increased area density and an increased volume density of the positive electrode.

The electrode wound body of Example 10-2 applicable to, for example, a battery such as a lithium-ion secondary battery corresponds to a stacked body that is wound. In the stacked body, the positive electrode, the separator, the negative electrode, and the separator are stacked in order. In the electrode wound body of Example 10-2, the negative electrode is present in the innermost wind part, instead of the separator. More specifically, in the innermost wind part of the electrode wound body of Example 10-2, the negative electrode current collector, such as a copper foil, that is wound multiple times (e.g., three times or more) is present. Here, where a thickness of the negative electrode current collector is denoted as a [μm] and the number of winds is denoted as b, it is preferable that a×b be 24 μm or more.

In the electrode wound body of Example 10-2, the negative electrode current collector is wound multiple times in the innermost wind part of the electrode wound body. This makes it possible to retain mechanical strength of the electrode wound body without using a center pin including an electrically conductive material such as metal, for example. Owing to having no center pin including an electrically conductive material, the electrode wound body of Example 10-2 makes it possible to avoid an internal short circuit caused by contact of the center pin with, for example, the positive electrode current collector plate or the negative electrode current collector plate.

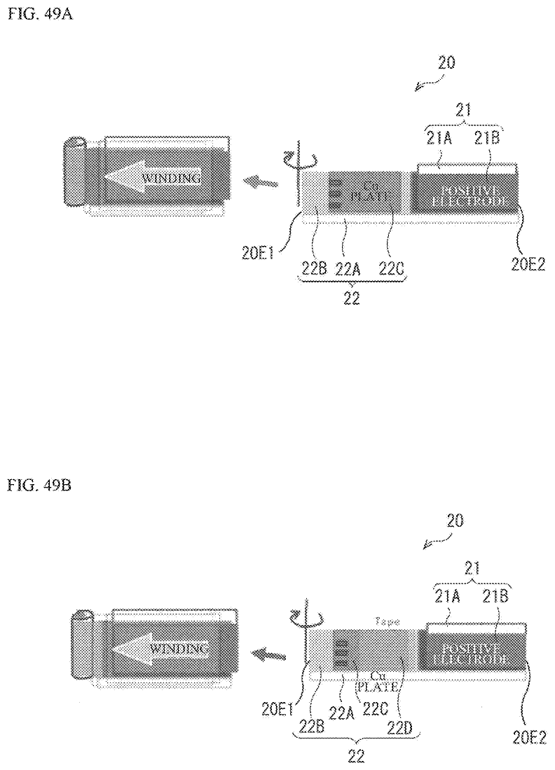

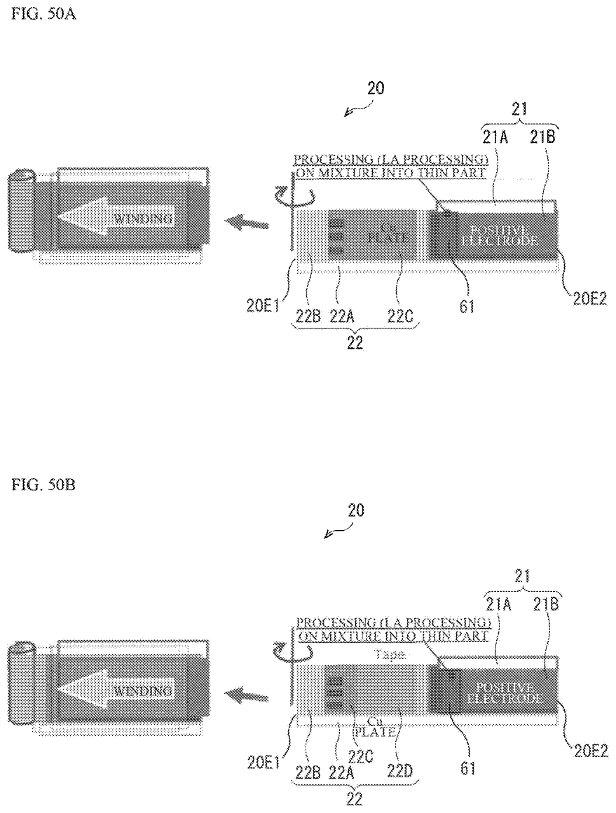

FIG. 49A is a schematic plan diagram illustrating an unwound state of the electrode wound body 20 of Example 10-3-1 applicable to, for example, a battery such as a lithium-ion secondary battery. The electrode wound body of Example 10-3-1 corresponds to a stacked body that is wound. In the stacked body, the positive electrode 21, the separator, the negative electrode 22, and the separator are stacked in order. Note that FIG. 49A omits illustration of the separators. As illustrated in FIG. 49A, the electrode wound body 20 of Example 10-3-1 includes, on a side of a winding start end 20E1, a part in which only the negative electrode 22 is present and the positive electrode 21 is absent. Accordingly, in the winding center part of the electrode wound body 20 of Example 10-3-1, only the negative electrode 22 that is not opposed to the positive electrode 21 is wound multiple times (e.g., three times or more). A thin copper plate 22C is attached to the negative electrode active material layer 22B in a part, of the negative electrode 22, not opposed to the positive electrode 21. The copper plate 22C has a thickness of about 40 μm, for example. All of the copper plate 22C may be joined to the negative electrode active material layer 22B, or only a part of the copper plate 22C may be joined to the negative electrode active material layer 22B. In the innermost wind part of the electrode wound body 20 of Example 10-3-1, a stack of the negative electrode current collector 22A, the negative electrode active material layer 22B, and the copper plate 22C is integrally wound multiple times (e.g., three times or more).

In the electrode wound body of Example 10-3-1, among the positive electrode 21, the separators, and the negative electrode 22, only the negative electrode 22 is wound multiple times in the winding center part. The negative electrode 22 in the winding center part has the copper plate 22C. Accordingly, even when the innermost wind part of the positive electrode 21 of the electrode wound body 20 is subjected to stress due to, for example, expansion of the negative electrode 22 upon charging, it is possible for the innermost wind part of the positive electrode 21 to resist the stress. This makes it possible to prevent the occurrence of buckling in the innermost wind part of the positive electrode 21 or development of a crack in the positive electrode active material layer 21B in the innermost wind part. As a result, it is possible to effectively suppress a short circuit inside the battery.

FIG. 49B is a schematic plan diagram illustrating the unwound state of the electrode wound body 20 of Example 10-3-2 applicable to, for example, a battery such as a lithium-ion secondary battery. The electrode wound body of Example 10-3-2 corresponds to a stacked body that is wound. In the stacked body, the positive electrode 21, the separator, the negative electrode 22, and the separator are stacked in order. Note that FIG. 49B omits illustration of the separators. As illustrated in FIG. 49B, the electrode wound body 20 of Example 10-3-2 includes, on the side of the winding start end 20E1, a part in which only the negative electrode 22 is present and the positive electrode 21 is absent. Accordingly, in the winding center part of the electrode wound body 20 of Example 10-3-2, only the negative electrode 22 that is not opposed to the positive electrode 21 is wound multiple times (e.g., three times or more). The thin copper plate 22C is attached to the negative electrode active material layer 22B in a part, of the negative electrode 22, not opposed to the positive electrode 21. The copper plate 22C has a thickness of about 40 μm, for example. All of the copper plate 22C may be joined to the negative electrode active material layer 22B, or only a part of the copper plate 22C may be joined to the negative electrode active material layer 22B. Furthermore, a resin tape 22D is provided to cover all or a part of the copper plate 22C. In the innermost wind part of the electrode wound body 20 of Example 10-3-2, the stack of the negative electrode current collector 22A, the negative electrode active material layer 22B, the copper plate 22C, and the resin tape 22D is integrally wound multiple times (e.g., three times or more).

In the electrode wound body of Example 10-3-2, among the positive electrode 21, the separators, and the negative electrode 22, only the negative electrode 22 is wound multiple times in the winding center part. The negative electrode 22 in the winding center part has the copper plate 22C. Accordingly, even when the innermost wind part of the positive electrode 21 of the electrode wound body 20 is subjected to stress due to, for example, expansion of the negative electrode 22 upon charging, it is possible for the innermost wind part of the positive electrode 21 to resist the stress. This makes it possible to prevent the occurrence of buckling in the innermost wind part of the positive electrode 21 or development of a crack in the positive electrode active material layer 21B in the innermost wind part. Furthermore, owing to the copper plate 22C being covered with the resin tape 22D, it is possible to reduce a level difference between the copper plate 22C and the negative electrode current collector 22A present at an edge of the copper plate 22C, and it is thus possible to reduce local stress applied to the positive electrode 21. As a result, it is possible to effectively suppress a short circuit inside the battery.

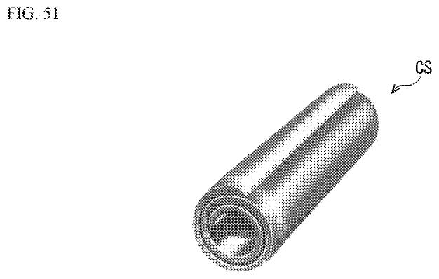

FIG. 50A is a schematic plan diagram illustrating the unwound state of the electrode wound body 20 of Example 10-4-1 applicable to, for example, a battery such as a lithium-ion secondary battery. The electrode wound body of Example 10-4-1 corresponds to a stacked body that is wound. In the stacked body, the positive electrode 21, the separator, the negative electrode 22, and the separator are stacked in order. Note that FIG. 50A omits illustration of the separators. As illustrated in FIG. 50A, the electrode wound body 20 of Example 10-4-1 includes, on the side of the winding start end 20E1, a part in which only the negative electrode 22 is present and the positive electrode 21 is absent. Accordingly, in the winding center part of the electrode wound body 20 of Example 10-4-1, only the negative electrode 22 that is not opposed to the positive electrode 21 is wound multiple times (e.g., three times or more). The thin copper plate 22C is attached to the negative electrode active material layer 22B in a part, of the negative electrode 22, not opposed to the positive electrode 21. The copper plate 22C has a thickness of about 40 μm, for example. All of the copper plate 22C may be joined to the negative electrode active material layer 22B, or only a part of the copper plate 22C may be joined to the negative electrode active material layer 22B. In the innermost wind part of the electrode wound body 20 of Example 10-4-1, the stack of the negative electrode current collector 22A, the negative electrode active material layer 22B, and the copper plate 22C is integrally wound multiple times (e.g., three times or more). Furthermore, in the electrode wound body 20 of Example 10-4-1, the thin part 61 is provided in a part of the positive electrode active material layer 21B at an inner winding side end part of the positive electrode 21. The thin part 61 is a part having a thickness smaller than a thickness of a part of the positive electrode active material layer 21B other than the thin part 61. The thin part 61 is formed by laser ablation, for example.

In the electrode wound body of Example 10-4-1, among the positive electrode 21, the separators, and the negative electrode 22, only the negative electrode 22 is wound multiple times in the winding center part. The negative electrode 22 in the winding center part has the copper plate 22C. Accordingly, even when the innermost wind part of the positive electrode 21 of the electrode wound body 20 is subjected to stress due to, for example, expansion of the negative electrode 22 upon charging, it is possible for the innermost wind part of the positive electrode 21 to resist the stress. This makes it possible to prevent the occurrence of buckling in the innermost wind part of the positive electrode 21 or development of a crack in the positive electrode active material layer 21B in the innermost wind part. Furthermore, owing to the positive electrode active material layer 21B including the thin part 61, it is possible to suppress expansion of the negative electrode 22 around the winding center part at the time of charging. As a result, it is possible to effectively suppress a short circuit inside the battery.

FIG. 50B is a schematic plan diagram illustrating the unwound state of the electrode wound body 20 of Example 10-4-2 applicable to, for example, a battery such as a lithium-ion secondary battery. The electrode wound body of Example 10-4-2 corresponds to a stacked body that is wound. In the stacked body, the positive electrode 21, the separator, the negative electrode 22, and the separator are stacked in order. FIG. 50B omits illustration of the separators. As illustrated in FIG. 50B, the electrode wound body 20 of Example 10-4-2 includes, on the side of the winding start end 20E1, a part in which only the negative electrode 22 is present and the positive electrode 21 is absent. Accordingly, in the winding center part of the electrode wound body 20 of Example 10-4-2, only the negative electrode 22 that is not opposed to the positive electrode 21 is wound multiple times (e.g., three times or more). The thin copper plate 22C is attached to the negative electrode active material layer 22B in a part, of the negative electrode 22, not opposed to the positive electrode 21. The copper plate 22C has a thickness of about 40 μm, for example. All of the copper plate 22C may be joined to the negative electrode active material layer 22B, or only a part of the copper plate 22C may be joined to the negative electrode active material layer 22B. Furthermore, the resin tape 22D is provided to cover all or a part of the copper plate 22C. In the innermost wind part of the electrode wound body 20 of Example 10-4-2, the stack of the negative electrode current collector 22A, the negative electrode active material layer 22B, the copper plate 22C, and the resin tape 22D is integrally wound multiple times (e.g., three times or more). Further, in the electrode wound body 20 of Example 10-4-2, the thin part 61 is provided in a part of the positive electrode active material layer 21B at the inner winding side end part of the positive electrode 21. The thin part 61 is a part having a thickness smaller than the thickness of a part of the positive electrode active material layer 21B other than the thin part 61. The thin part 61 is formed by laser ablation, for example.

In the electrode wound body of Example 10-4-2, among the positive electrode 21, the separators, and the negative electrode 22, only the negative electrode 22 is wound multiple times in the winding center part. The negative electrode 22 in the winding center part has the copper plate 22C. Accordingly, even when the innermost wind part of the positive electrode 21 of the electrode wound body 20 is subjected to stress due to, for example, expansion of the negative electrode 22 upon charging, it is possible for the innermost wind part of the positive electrode 21 to resist the stress. This makes it possible to prevent the occurrence of buckling in the innermost wind part of the positive electrode 21 or development of a crack in the positive electrode active material layer 21B in the innermost wind part. Furthermore, owing to the copper plate 22C being covered with the resin tape 22D, it is possible to reduce the level difference between the copper plate 22C and the negative electrode current collector 22A present at the edge of the copper plate 22C, and it is thus possible to reduce local stress applied to the positive electrode 21. In addition, owing to the positive electrode active material layer 21B including the thin part 61, it is possible to suppress expansion of the negative electrode 22 in the region including the winding center part of the electrode wound body 20 and the vicinity of the winding center part at the time of charging. As a result, it is possible to effectively suppress a short circuit inside the battery.

The electrode wound body of Example 10-5 applicable to, for example, a battery such as a lithium-ion secondary battery has a core material CS in the form of a coil spring illustrated in, for example, FIG. 51, inserted in the through hole at the center of the electrode wound body. In other words, the electrode wound body of Example 10-5 corresponds to a stacked body wound around the core material CS. In the stacked body, the positive electrode, the separator, the negative electrode, and the separator are stacked in order. The core material CS corresponds to a plate-shaped elastic member that is wound. The plate-shaped elastic member includes a material such as stainless steel.

In the electrode wound body of Example 10-5, the core material CS in the form of a coil spring is inserted in the through hole at the center of the electrode wound body. This makes it possible to change an outer diameter of the core material CS in accordance with the inner diameter of the electrode wound body, and thereby makes it possible to bring an inner surface of the electrode wound body and an outer surface of the core material CS into close contact with each other. Accordingly, the core material CS enhances the mechanical strength of the electrode wound body, thereby making it possible to suppress deformation of the electrode wound body upon expansion and contraction. It is thus possible to prevent the occurrence of buckling in the innermost wind part of the positive electrode 21 or development of a crack in the positive electrode active material layer 21B in the innermost wind part. As a result, it is possible to effectively suppress a short circuit inside the battery.

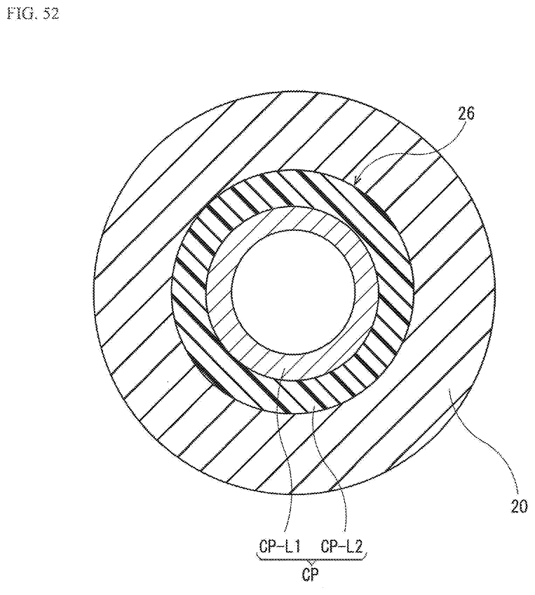

FIG. 52 is a schematic sectional diagram illustrating the electrode wound body 20 and a center pin CP of Example 10-6 applicable to, for example, a battery such as a lithium-ion secondary battery. The center pin CP is disposed in the through hole 26 at the center of the electrode wound body 20 of Example 10-6. The center pin CP includes a core CP-L1 having a cylindrical shape, and a resin layer CP-L2 covering an outer peripheral surface of the core CP-L1. The core CP-L1 includes, for example, a material having high rigidity, such as stainless steel. The resin layer CP-L2 includes a resin material that expands by heating and plastically deforms at a predetermined temperature (e.g., about 130° C.). The resin layer CP-L2 may have a three-layer structure including polyethylene (PE), polyester, and rubber, for example. The resin layer CP-L2 has a surface in close contact with the inner surface of the through hole 26 of the electrode wound body 20. The resin layer CP-L2 is preferably thermal-fusion-bonded to the inner surface of the through hole 26, in particular.

In the electrode wound body 20 of Example 10-6, the center pin CP is disposed in the through hole 26 at the center of the electrode wound body 20, and the surface of the resin layer CP-L2 of the center pin CP is in close contact with the inner surface of the through hole 26. Accordingly, the center pin CP enhances the mechanical strength of the electrode wound body 20, thereby making it possible to suppress deformation of the electrode wound body 20 upon expansion and contraction. It is thus possible to prevent the occurrence of buckling in the innermost wind part of the positive electrode included in the electrode wound body 20, or development of a crack in the positive electrode active material layer in the innermost wind part. As a result, it is possible to effectively suppress a short circuit inside the battery.

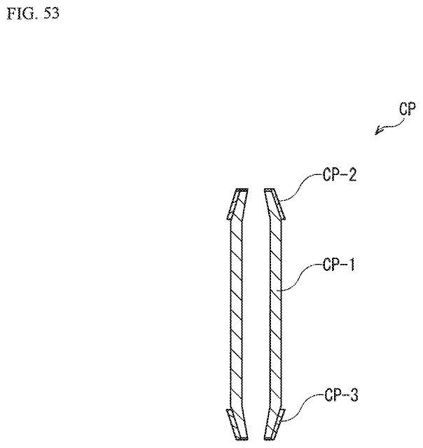

FIG. 53 is a schematic sectional diagram illustrating the center pin CP of Example 10-7 applicable to, for example, a battery such as a lithium-ion secondary battery. The center pin CP of Example 10-7 includes a core CP-1, an insulating film CP-2, and an insulating film CP-3. The core CP-1 is a tube-shaped member. The insulating film CP-2 covers an upper end part of the core CP-1 and the vicinity of the upper end part. The insulating film CP-3 covers a lower end part of the core CP-1 and the vicinity of the lower end part. The core CP-1 includes a material having high rigidity, such as stainless steel. Examples of a constituent material of each of the insulating films CP-2 and CP-3 include polyester, polyamide, polyolefin, polyacrylate, polymethacrylate, polysulfone, polycarbonate, polypropylene, polyethylene, polysulfone, polytetrafluoroethylene, and polyvinylidene difluoride.

In the center pin CP of Example 10-7, the insulating film CP-2 covers the upper end part of the core CP-1 and the vicinity of the upper end part, and the insulating film CP-3 covers the lower end part of the core CP-1 and the vicinity of the lower end part. This makes it possible to prevent an internal short circuit of the battery even when the center pin CP comes into contact with a top surface or a bottom surface of the battery due to vibrations applied to the battery or under abnormal conditions.

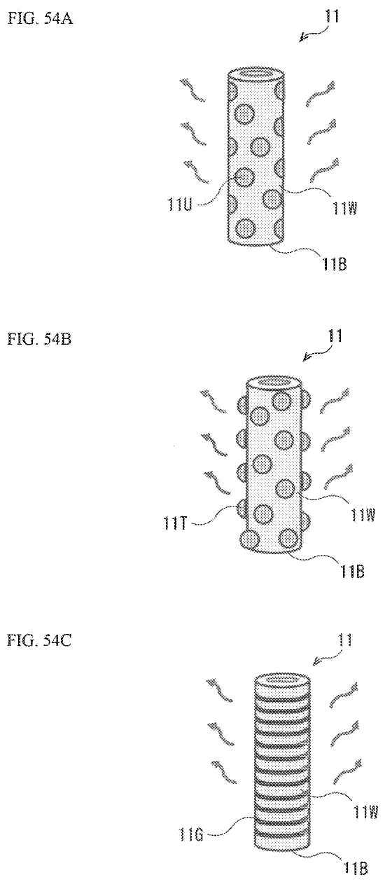

FIG. 54A is a perspective diagram schematically illustrating an outer appearance of the outer package can 11 of Example 13-2 applicable to, for example, a battery such as a lithium-ion secondary battery. The outer package can 11 is a container that contains components including, without limitation, the positive electrode current collector plate, the negative electrode current collector plate, and the electrode wound body. The outer package can 11 desirably includes a material having a high thermal conductivity and high rigidity, more specifically, for example, a metal material such as iron. The outer package can 11 includes the bottom part 11B and the sidewall part 11W. The outer package can 11 of Example 13-2 has one or more depression parts 11U in at least one of an outer surface or an inner surface of the sidewall part 11W. Note that the number, location, size, and shape of the depression parts 11U are not limited to those illustrated in FIG. 54A, and may be chosen as desired.

The outer package can 11 of Example 13-2 is provided with the one or more depression parts 11U in at least one of the outer surface or the inner surface of the sidewall part 11W. This makes it possible to increase a surface area of the sidewall part and to achieve high heat dissipation performance, as compared with an outer package can without the one or more depression parts. Accordingly, it is possible to efficiently release, to the outside, heat resulting from a battery reaction of the electrode wound body contained in the outer package can 11. This makes it possible to suppress a rise in temperature of a battery in which the outer package can 11 of Example 13-2 is used.

FIG. 54B is a perspective diagram schematically illustrating the outer appearance of the outer package can 11 of Example 13-3 applicable to, for example, a battery such as a lithium-ion secondary battery. The outer package can 11 is a container that contains components including, without limitation, the positive electrode current collector plate, the negative electrode current collector plate, and the electrode wound body. The outer package can 11 desirably includes a material having a high thermal conductivity and high rigidity, more specifically, for example, a metal material such as iron. The outer package can 11 includes the bottom part 11B and the sidewall part 11W. The outer package can 11 of Example 13-3 has one or more protruding parts 11T in at least one of the outer surface or the inner surface of the sidewall part 11W. The number, location, size, and shape of the protruding parts 11T are not limited to those illustrated in FIG. 54B, and may be chosen as desired.

The outer package can 11 of Example 13-3 is provided with the one or more protruding parts 11T in at least one of the outer surface or the inner surface of the sidewall part 11W. This makes it possible to increase the surface area of the sidewall part and to achieve high heat dissipation performance, as compared with an outer package can without the one or more projection parts. Accordingly, it is possible to efficiently release, to the outside, heat resulting from a battery reaction of the electrode wound body contained in the outer package can 11. This makes it possible to suppress a rise in temperature of a battery in which the outer package can 11 of Example 13-3 is used.

FIG. 54C is a perspective diagram schematically illustrating the outer appearance of the outer package can 11 of Example 13-4 applicable to, for example, a battery such as a lithium-ion secondary battery. The outer package can 11 is a container that contains components including, without limitation, the positive electrode current collector plate, the negative electrode current collector plate, and the electrode wound body. The outer package can 11 desirably includes a material having a high thermal conductivity and high rigidity, more specifically, for example, a metal material such as iron. The outer package can 11 includes the bottom part 11B and the sidewall part 11W. The outer package can 11 of Example 13-4 has one or more grooves 11G in at least one of the outer surface or the inner surface of the sidewall part 11W. The grooves 11G are provided to extend circumferentially along the outer surface of the sidewall part 11W of the outer package can 11, for example. Note that the number, location, and width of the grooves 11G are not limited to those illustrated in FIG. 54C, and may be chosen as desired.

The outer package can 11 of Example 13-4 is provided with the one or more grooves 11G in at least one of the outer surface or the inner surface of the sidewall part 11W. This makes it possible to increase the surface area of the sidewall part and to achieve high heat dissipation performance, as compared with an outer package can without the grooves 11G. Accordingly, it is possible to efficiently release, to the outside, heat resulting from a battery reaction of the electrode wound body contained in the outer package can 11. This makes it possible to suppress a rise in temperature of a battery in which the outer package can 11 of Example 13-4 is used.

Although the present disclosure has been described herein with reference to an embodiment including modification examples, a configuration of the present disclosure is not limited thereto, and is therefore modifiable in a variety of ways.

For example, the case where the electrode reactant is lithium has been described; however, the electrode reactant is not particularly limited. Accordingly, the electrode reactant may be another alkali metal such as sodium or potassium, or may be an alkaline earth metal such as beryllium, magnesium, or calcium, as described above. In addition, the electrode reactant may be another light metal such as aluminum.

The effects described herein are mere examples, and effects of the present disclosure are therefore not limited to those described herein. Accordingly, the present disclosure may achieve any other effect.
1 . . . lithium-ion secondary battery; 11 . . . outer package can; 11B . . . bottom part; 11N . . . open end part; 11P . . . bent part; 11R . . . crimped structure; 11S . . . narrow part; 11W . . . sidewall part; 11WS . . . side surface; 12, 13 . . . insulating plate; 14 . . . battery cover; 14T . . . protruding part; 15 . . . gasket; 20 . . . electrode wound body; S20 . . . stacked body; 21 . . . positive electrode; 21A . . . positive electrode current collector; 21B . . . positive electrode active material layer; 21BT1 . . . first edge; 211 . . . positive electrode covered region; 212 . . . positive electrode exposed region; 212E . . . positive electrode edge part; 21E1 . . . winding center side edge; 21E2 . . . winding outer periphery side edge; 22 . . . negative electrode; 22A . . . negative electrode current collector; 22B . . . negative electrode active material layer; 221 . . . negative electrode covered region; 222 . . . negative electrode exposed region; 222E . . . negative electrode edge part; 22E1 . . . central axis side edge; 22E2 . . . outer winding side edge; 23 . . . separator; 23A . . . first separator member; 23B . . . second separator member; 24 . . . positive electrode current collector plate; 25 . . . negative electrode current collector plate; 26 . . . through hole; 30 . . . safety valve mechanism; 31, 33 . . . fan-shaped part; 32, 34 . . . band-shaped part; 35, 36 . . . opening; 41 . . . upper end face; 42 . . . lower end face; 46 . . . fixing tape; 50 . . . outer package tube; 53, 54 . . . insulating tape; 55 . . . washer; 55K . . . opening; 101 . . . insulating layer; 300 . . . battery pack; CL . . . central axis; K . . . border

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction; and
a first electrode current collector plate and a second electrode current collector plate that are opposed to each other with the electrode wound body interposed between the first electrode current collector plate and the second electrode current collector plate in the width direction, wherein
the first electrode current collector plate has an opening positioned to overlap the through hole in the width direction, and
a diameter of the opening is smaller than a diameter of the through hole.

2. The secondary battery according to claim 1, wherein a first bent part is provided at a peripheral edge part of the opening of the first electrode current collector plate, and the first bent part being bent toward an inside of the through hole.

3. The secondary battery according to claim 2, wherein a first depression part is provided along the through hole, and the first bent part covers all or a part of the first depression part.

4. The secondary battery according to claim 3, wherein
the first electrode includes a first electrode current collector and a first electrode active material layer, the first electrode active material layer covering a part of the first electrode current collector,
the first electrode includes a first electrode covered region and a first electrode exposed region, the first electrode covered region being a region in which the first electrode current collector is covered with the first electrode active material layer, the first electrode exposed region being a region in which the first electrode current collector is exposed without being covered with the first electrode active material layer, the first electrode exposed region being adjacent to the first electrode covered region in the width direction and being joined to the first electrode current collector plate, and
the first depression part is provided in a compressed part in which multiple portions of the first electrode current collector in the first electrode exposed region overlap each other.

5. The secondary battery according to claim 1, wherein
the first electrode includes a first electrode current collector and a first electrode active material layer, the first electrode active material layer covering a part of the first electrode current collector,
the first electrode includes a first electrode covered region and a first electrode exposed region, the first electrode covered region being a region in which the first electrode current collector is covered with the first electrode active material layer, the first electrode exposed region being a region in which the first electrode current collector is exposed without being covered with the first electrode active material layer, the first electrode exposed region being adjacent to the first electrode covered region in the width direction and being joined to the first electrode current collector plate,
the second electrode includes a second electrode current collector and a second electrode active material layer, the second electrode active material layer covering a part of the second electrode current collector,
the second electrode includes a second electrode covered region and a second electrode exposed region, the second electrode covered region being a region in which the second electrode current collector is covered with the second electrode active material layer, the second electrode exposed region being a region in which the second electrode current collector is exposed without being covered with the second electrode active material layer, the second electrode exposed region being adjacent to the second electrode covered region in the width direction and being joined to the second electrode current collector plate, and
a maximum value of a thickness of a first compressed part in which multiple portions of the first electrode current collector in the first electrode exposed region overlap each other is larger than a maximum value of a thickness of a second compressed part in which multiple portions of the second electrode current collector in the second electrode exposed region overlap each other.

6. The secondary battery according to claim 1, wherein
the electrode wound body including a first end face orthogonal to the width direction and facing the first electrode current collector plate,
the first electrode current collector plate includes a first part and a second part, the first part extending along the first end face, the second part protruding from the first part in a first direction, and
a plurality of joining locations in which the first part and the first end face are joined to each other, one joining location, of the plurality of joining locations, that is closest to the second part has a length in a second direction greater than or equal to a length in the second direction of the second part, the second direction being orthogonal to the first direction.

7.
A secondary battery comprising:
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction; and
a first electrode current collector plate and a second electrode current collector plate that are opposed to each other with the electrode wound body interposed between the first electrode current collector plate and the second electrode current collector plate in the width direction, wherein
a second bent part is provided at an outer peripheral edge part of the first electrode current collector plate, the second bent part being bent toward the second electrode current collector plate.

8. The secondary battery according to claim 7, wherein a depression part is provided in an outer surface of the electrode wound body, and the second bent part covers all or a part of the depression part.

9. The secondary battery according to claim 8, wherein
the first electrode includes a first electrode current collector and a first electrode active material layer, the first electrode active material layer covering a part of the first electrode current collector,
the first electrode includes a first electrode covered region and a first electrode exposed region, the first electrode covered region being a region in which the first electrode current collector is covered with the first electrode active material layer, the first electrode exposed region being a region in which the first electrode current collector is exposed without being covered with the first electrode active material layer, the first electrode exposed region being adjacent to the first electrode covered region in the width direction and being joined to the first electrode current collector plate, and
the depression part is provided in a compressed part in which multiple portions of the first electrode current collector in the first electrode exposed region overlap each other.

10. A secondary battery comprising:
an electrode wound body including a stacked body and having a through hole, the stacked body including a first electrode, a second electrode, and a separator and being wound along a longitudinal direction of the stacked body, the through hole extending through the electrode wound body in a width direction orthogonal to the longitudinal direction; and
a first electrode current collector plate and a second electrode current collector plate that are opposed to each other with the electrode wound body interposed between the first electrode current collector plate and the second electrode current collector plate in the width direction, wherein
the first electrode includes a first electrode current collector, an undercoat layer, and a first electrode active material layer, the undercoat layer covering the first electrode current collector, the first electrode active material layer covering a part of the undercoat layer,
the second electrode includes a second electrode current collector and a second electrode active material layer, the second electrode active material layer covering the second electrode current collector, and
in the width direction, an edge of the first electrode active material layer is at a position retracted relative to a position of an edge of the undercoat layer, and an edge of the second electrode active material layer is at a position between the position of the edge of the undercoat layer and the position of the edge of the first electrode active material layer.
